(19) United States
(12) Patent Application Publication
(10) Pub. No.: US 2016/0091614 A1
(43) Pub. Date: Mar. 31, 2016

(54) RADIOACTIVE WASTE SCREENING SYSTEMS, AND RELATED METHODS

(71) Applicant: Battelle Energy Alliance, LLC, Idaho Falls, ID (US)

(72) Inventors: Douglas William Akers, Idaho Falls, ID (US); Lyle Gene Roybal, Idaho Falls, ID (US)

(21) Appl. No.: 14/500,326

(22) Filed: Sep. 29, 2014

(51) Int. Cl. G01T 1/167; G01T 7/00

(52) U.S. Cl. CPC G01T 1/167; G01T 7/00

(57) ABSTRACT

A radioactive waste screening system comprising at least one subsystem, at least one computer assembly operatively associated with and configured to receive measurement data from the at least one subsystem, and control logic in communication with the at least one computer assembly. The at least one subsystem is selected from the group consisting of a packaged waste screening subsystem, a volume waste screening subsystem, a subsurface waste characterization subsystem, and a surface waste characterization subsystem. The control logic is configured to verify the operability of the at least one subsystem, to control the at least one subsystem, and to assess the radioactivity of at least one material at least partially based on the measurement data received by the at least one computer assembly. A method of assessing a potentially radioactive material, and a method of determining the radioactivity of a material are also described.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

The disclosure, in various embodiments, relates generally to radioactive waste screening systems, and to related methods and apparatuses. More specifically, the disclosure relates to radioactive waste screening systems employing specialized subsystems and control logic to characterize the radioactivity of at least one of a material and a material formation, and to related methods and apparatuses.

### BACKGROUND

Naturally occurring radioactive material (“NORM”) includes isotopes of uranium (U) and thorium (Th), and their decay chain daughters such as radium (Ra). NORM is present in the earth's crust in both immobile forms (e.g., water insoluble forms, such as U²³⁸ and Th²³²) and mobile forms (e.g., water soluble forms, such as Ra²²⁶ and Ra²²⁸). NORM can be released from the earth's crust due to naturally occurring disturbances, and may also be technically enhanced (“TENORM”) and released by human activity such as, for example, hydrocarbon recovery processes. Depending on quantities and concentrations, NORM and TENORM may be hazardous to health and/or the environment. Consequently, the disposal of NORM and TENORM is subject to regulation.

During clean-up operations for NORM and TEFORM, radioactive material may be removed (e.g., mined, excavated, etc.), packaged, characterized, and transported for disposal and secured storage. States agencies typically regulate radioactivity characterization, shipment, disposal, and storage activities. Packaged radioactive material may be rejected for certification at a radioactive waste disposal facility if the packaged radioactive material is found to not meet appropriate criteria for acceptance at the radioactive waste disposal facility or for transportation. Once packaged, alterations to the radioactive material may become more difficult, and thus significantly more costly to ensure acceptance by the radioactive waste disposal facility. For example, a container (e.g., drum) that does not meet the acceptance criteria for the radioactive waste disposal facility (e.g., is too radioactive, is not radioactive enough, etc.) may require further characterization, and either may require treatment (e.g., incineration, compaction, thermal treatment, vitrification, etc.) before the container can be certified for shipment and disposal, may have to be returned to a waste pit, or may need to be sent to a different disposal facility (e.g., Envirocare of Salt Lake City, Utah). Given the significant quantities of NORM and TENORM now being produced in North Dakota, elsewhere in the U.S. and in other parts of the world, such characterization and disposal problems can be quite costly and significant.

It would, therefore, be desirable to have new systems, methods, and apparatuses for the detection, characterization, and segregation of radioactive materials (e.g., NORM, TENORM, etc.) that are easy to employ, cost-effective, fast, and more versatile as compared to conventional systems, methods, and apparatuses for the detection, characterization, and segregation of radioactive materials. Such systems, methods, and apparatuses may, for example, permit only those wastes that exceed environmental disposal standards to be disposed of at an engineered radioactive waste disposal site, and may also permit the monitoring of radioactive waste sites to assure that the radioactive waste is not leaching into groundwater.

### SUMMARY

Embodiments described herein include radioactive waste screening systems, and related methods and apparatuses. For example, in accordance with one embodiment described herein, a radioactive waste screening system comprises at least one subsystem, at least one computer assembly, and control logic in communication with the at least one computer assembly. The at least one subsystem is selected from the group consisting of a packaged waste screening subsystem configured to measure the radioactivity of a packaged material, a volume waste screening subsystem configured to measure the radioactivity of portions of a volume of material conveyed therethrough, a subsurface waste characterization subsystem configured to measure the radioactivity of regions of a subterranean formation adjacent at least one borehole, and a surface waste characterization subsystem is configured to measure the radioactivity of surface regions of an earthen formation. The at least one computer assembly is operatively associated with and configured to receive measurement data from the at least one subsystem. The control logic is configured to verify the operability of the at least one subsystem, to control the at least one subsystem, and to assess the radioactivity of at least one of the packaged material, the portions of the volume of material, the regions of the subterranean formation, and the surface regions of the earthen formation at least partially based on the measurement data received by the at least one computer assembly.

In additional embodiments, a method of assessing a potentially radioactive material comprises characterizing the radioactivity of at least one material using a radioactive waste screening system. The radioactive waste screening system comprises at least one subsystem, at least one computer assembly, and control logic in communication with the at least one computer assembly. The at least one subsystem is selected from the group consisting of a packaged waste screening subsystem configured to measure the radioactivity of a packaged material, a volume waste screening subsystem configured to measure the radioactivity of portions of a volume of material conveyed therethrough, a subsurface waste characterization subsystem configured to measure the radioactivity of regions of a subterranean formation adjacent at least one borehole, and a surface waste characterization subsystem is configured to measure the radioactivity of surface regions of an earthen formation. The at least one computer assembly is operatively associated with and configured to receive measurement data from the at least one subsystem. The control logic is configured to verify the operability of the at least one subsystem, to control the at least one subsystem, and to assess the radioactivity of at least one of the packaged material, the portions of the volume of material, the regions of the subterranean formation, and the surface regions of the earthen formation at least partially based on the measurement data received by the at least one computer assembly.

In further embodiments, a method of determining the radioactivity of a material comprises measuring counts for at least one radionuclide using at least one radiation detector of a radioactive waste screening system comprising at least one of a packaged waste screening subsystem, a volume waste screening subsystem, a subsurface waste characterization subsystem, and a surface waste characterization subsystem. The activity of the at least one radionuclide is calculated using control logic of the radioactive waste screening system, the control logic automatically compensating for mass attenuation and non-equilibrium decay chains through weighted least squares regression analysis and modeling of physical geometry and radioactive decay parameters.

### BRIEF DESCRIPTION OF THE SEVERAL VIEWS OF THE DRAWINGS

FIG. 1 is a simplified flow diagram of a radioactive waste screening system, in accordance with embodiments of the disclosure;

FIG. 2 is a schematic view of a packaged and piping waste screening subsystem of the radioactive waste screening system of FIG. 1, in accordance with embodiments of the disclosure;

FIG. 3 is a schematic view of a volume waste screening subsystem of the radioactive waste screening system of FIG. 1, in accordance with embodiments of the disclosure;

FIG. 4 is a schematic view of a subsurface waste characterization subsystem of the radioactive waste screening system of FIG. 1, in accordance with embodiments of the disclosure;

FIG. 5 is a schematic view of a surface waste characterization subsystem of the radioactive waste screening system of FIG. 1, in accordance with embodiments of the disclosure;

FIG. 6 is a hierarchical view of processes for operating a radioactive waste screening system, including subsystems thereof, in accordance with embodiments of the disclosure;

FIG. 7 is a flowchart representing a background measurement operation for a subsystem of a radioactive waste screening system, in accordance with embodiments of the disclosure;

FIG. 8 is a flowchart representing an initial set-up operation for a subsystem of a radioactive waste screening system, in accordance with embodiments of the disclosure;

FIG. 9 is a flowchart representing a main loop for a subsystem of a radioactive waste screening system, in accordance with embodiments of the disclosure;

FIG. 10 is a flowchart representing a source check operation for a subsystem of a radioactive waste screening system, in accordance with embodiments of the disclosure;

FIG. 11 is a flowchart representing a shielded background check operation for a subsystem of a radioactive waste screening system, in accordance with embodiments of the disclosure;

FIGS. 12A-12C are a series of flowcharts representing a measurement function for a packaged and piping waste screening subsystem of a radioactive waste screening system, in accordance with embodiments of the disclosure;

FIGS. 13A-13C are a series of flowcharts representing a measurement function for a volume waste screening subsystem of a radioactive waste screening system, in accordance with embodiments of the disclosure;

FIGS. 14A-14C are a series of flowcharts representing a measurement function for a subsurface waste characterization subsystem of a radioactive waste screening system, in accordance with embodiments of the disclosure; and

FIGS. 15A-15C are a series of flowcharts representing a measurement function for a surface waste characterization subsystem of a radioactive waste screening system, in accordance with embodiments of the disclosure.

### DETAILED DESCRIPTION

Radioactive waste screening systems are described, as are related methods and apparatuses. In some embodiments, a radioactive waste screening system includes at least one computer assembly operatively associated with and configured to receive measurement data from one or more of (e.g., each of) a packaged waste screening subsystem, a volume waste screening subsystem, a subsurface waste characterization subsystem, and a surface waste characterization subsystem. The radioactive waste screening system also includes control logic in communication with the at least one computer assembly. The control logic may be configured to automatically control and verify the operability of the aforementioned subsystems, as well as to characterize the radioactivity of materials and/or material formations at least partially based on the measurement data received by the at least one computer assembly. The control logic may automatically correct for density effects and for non-equilibrium decay chains during the radioactivity characterization. The systems, methods, and apparatuses of the disclosure provide a simple, cost-effective, fast, and versatile means of characterizing and quantifying the radioactivity of a variety of materials and material formations as compared to conventional systems and methods. The systems, methods, and apparatuses of the disclosure may be used to efficiently segregate materials based on calculated radioactivity levels, reducing costs and risks associated with the transport and disposal of wastes found at various locations (e.g., well sites, waste disposal sites, nuclear reactor sites, nuclear waste processing sites, medical facilities, etc.) where radioactive contamination (e.g., NORM, TENORM, etc.) may be present.

In the following detailed description, reference is made to the accompanying drawings that form a part hereof and, in which is shown by way of illustration, specific embodiments in which the disclosure may be practiced. These embodiments are described in sufficient detail to enable those of ordinary skill in the art to practice that described in this disclosure, and it is to be understood that other embodiments may be utilized, and that structural, logical, and electrical changes may be made within the scope of the disclosure.

In addition, it is noted that the embodiments and portions thereof may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or a combination thereof. When executed as firmware or software, the instructions for performing the methods and processes described herein may be stored on a computer-readable medium. A computer-readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory. Furthermore, some methods disclosed herein may include human operators initiating commands or otherwise perform functions that may affect components of the system, including selecting instructions when prompted by the software.

Referring in general to the following description and accompanying drawings, various embodiments of the disclosure are illustrated to show its structure and method of operation. Common elements of the illustrated embodiments are designated with like reference numerals. It should be understood that the figures presented are not meant to be illustrative of actual views of any particular portion of the actual structure, system, or method, but are merely idealized representations employed to more clearly and fully depict the disclosure defined by the claims below.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature or method act indicates that such is contemplated for use in implementation of embodiments of the disclosure and such term is used in preference to the more restrictive term “is” so as to avoid any implication that other, compatible materials, structures, features and methods usable in combination therewith should, or must be, excluded.

As used herein, the term “configured” refers to a size, shape, material composition, and arrangement of one or more of at least one structure, at least one apparatus, and at least one system facilitating operation of one or more of the structure, the apparatus, and the system in a pre-determined way.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “over,” “top,” “bottom,” “underlying,” etc., are used for clarity and convenience in understanding the disclosure and accompanying drawings and does not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

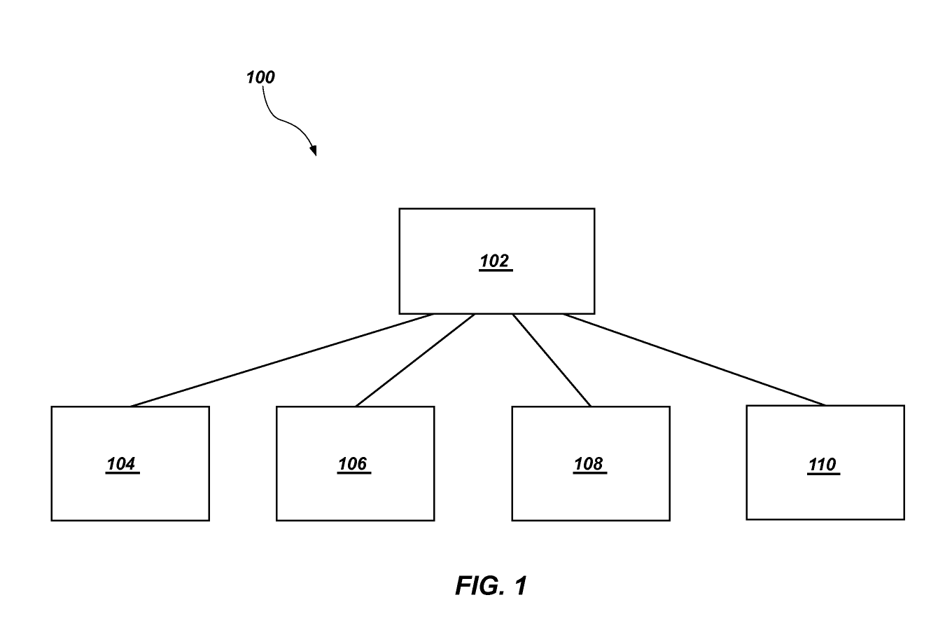

FIG. 1 is a simplified block diagram illustrating a radioactive waste screening system 100 in accordance with embodiments of the disclosure. The radioactive waste screening system 100 may be configured and operated to detect, characterize, and, optionally, segregate radioactive material, such as at least one of NORM and TENORM. As shown in FIG. 1, the radioactive waste screening system 100 may be formed of and include a main computer/electronics assembly 102, a packaged waste screening subsystem 104, a volume waste screening subsystem 106, a subsurface waste characterization subsystem 108, and a surface waste characterization subsystem 110. The radioactive waste screening system 100 may employ one or more of the subsystems (e.g., the packaged waste screening subsystem 104, the volume waste screening subsystem 106, the subsurface waste characterization subsystem 108, and the surface waste characterization subsystem 110) to detect, characterize, and, optionally, segregate radioactive material. The radioactive waste screening system 100, including the main computer/electronics assembly 102 and at least one (e.g., each) of the subsystems may be delivered to a site (e.g., a well site, a waste disposal site, a nuclear reactor site, a nuclear waste processing site, a medical facility, etc.) where radioactive contamination (e.g., NORM, TENORM, etc.) may be present, and the radioactive waste screening system 100 may be used to detect, characterize, and, optionally, segregate radioactive material at the site. If the radioactive waste screening system 100 employs more than one of the subsystems at a site, the subsystems may be utilized substantially simultaneously, substantially sequentially, or a combination thereof. With the description as provided below, it will be readily apparent to one of ordinary skill in the art that the radioactive waste screening system 100 described herein may be used in various applications. In other words, the radioactive waste screening system 100 may be used whenever it is desired to detect, measure, and characterize a radioactive material.

The main computer/electronics assembly 102 may serve as a common interface facilitating the simple and efficient control and analysis of various components (e.g., subsystems, subsystem devices, etc.) of the radioactive waste screening system 100. The main computer/electronics assembly 102 may include devices (e.g., multichannel analyzers, analog-to-digital converters, pulse counters, amplifiers, etc.) for receiving and analyzing data from the different components of the radioactive waste screening system 100. In addition, the main computer/electronics assembly 102 may include input devices (e.g., mouse, keyboard, etc.) through which an operator may input information, operate the main computer/electronics assembly 102, and/or electronically operate other functions of the various components of the radioactive waste screening system 100. Furthermore, the main computer/electronics assembly 102 may include output devices or other peripheral devices (e.g., monitors, printers, speakers, etc.) from which an operator may interpret results of measurements, characterization of the measurements, the operational status of the various components of radioactive waste screening system 100, or other similar information. The main computer/electronics assembly 102 may also include storage media such as hard drives, external hard drives, flash memory, RAM, ROM, DVDs, and other computer-readable media for storing information related to measurements or status of the various components of the radioactive waste screening system 100.

Computer-readable media, such as storage media, may also be used for executing instructions and functions related to performing, analyzing, characterizing measurements, and/or for controlling various components of the radioactive waste screening system 100. In other words, main computer/electronics assembly 102 includes control logic, which may include instructions that permit radioactive waste screening system 100 to function. The main computer/electronics assembly 102 may utilize control logic to automatically monitor and automatically control (e.g., activate, deactivate, move, position, etc.) various components (e.g., radiation detection assemblies, radiation detectors, support assemblies, detector positioning assemblies, segregation assemblies, temperature control assemblies, supplemental computer/electronics assemblies, weighing assemblies, cone penetrometer assemblies, gearmotors, mobile units, position locating devices, etc.) of the radioactive waste screening system 100. The control logic may continuously monitor the operability of the various components, and may automatically change operating parameters of the various components to compensate for the effects of changing environmental conditions (e.g., temperatures, pressures, materials, etc.) and shock. In addition, the main computer/electronics assembly 102 may utilize the control logic automatically analyze and automatically correct (e.g., adjust) measurement data received from the various components of the radioactive waste screening system 100. The control logic may automatically calculate, based on measurement data, the activity and associated uncertainty of one or more radionuclides for a material prior to further action (e.g., separation, packaging, disposal, etc.) with respect to the material. The control logic may also automatically adjust (e.g., compensate) calculated activities and associated uncertainties for errors in mass attenuation and geometry. In addition, the control logic may automatically correct for the effects of non-equilibrium daughter products at any time after the waste is generated, as well as for uncertainties associated with the non-equilibrium daughter products. Such automatic correction is a significant improvement over conventional technology, which generally requires that the waste be stored for at least thirty (30) days prior to radioactivity characterization. The control logic may also include a user interface, which may provide operators with prompts and directions for simplified operation for inexperienced operators. The control logic may further include instructions for other functions such as automated calibration (e.g., energy calibration), temperature compensation, data acquisition, analysis, and data storage. Some of these functions are described in further below.

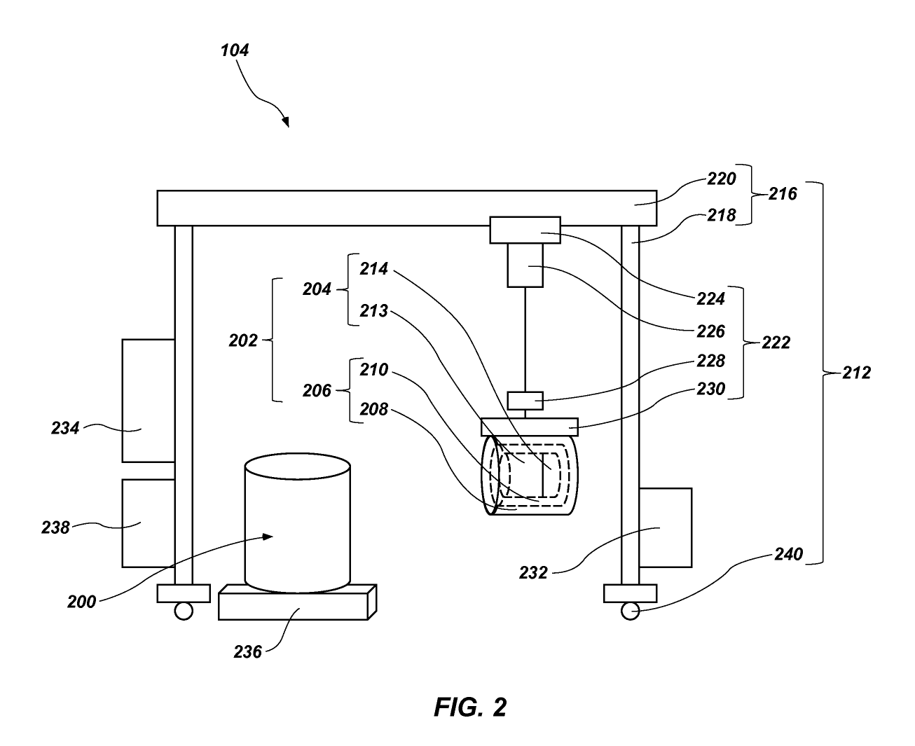

FIG. 2 is a schematic of the packaged waste screening subsystem 104, in accordance with embodiments of the disclosure. The packaged waste screening subsystem 104 may be configured and operated to characterize the radioactivity of material contained (e.g., held, confined, etc.) within at least one containment vessel 200. The containment vessel 200 may comprise any vessel (e.g., drum, bag, pipe, tank, bin, tray, box, bucket, etc.) configured to at least temporarily contain a radioactive material. Radioactive material (e.g., soil, dirt, scale, etc.) may at least partially fill at least one inner region (e.g., chamber, cavity, recess, void space, etc.) of the containment vessel 200. Suitable vessels are commercially available from numerous sources including, but not limited to, Nuclear Lead Co., Inc. (Oak Ridge, Tenn.), Extra Packaging Corp. (Rochester, N.Y.), and Precision Custom Components, LLC (York, Pa.). In some embodiments, the containment vessel 200 comprises a 55-gallon drum. In additional embodiments, the containment vessel 200 comprises a filter bag. In further embodiments, the containment vessel 200 comprises a pipe. In still further embodiments, the containment vessel 200 comprises a settling tank. The containment vessel 200 may be delivered to and/or moved relative to the packaged waste screening subsystem 104 (e.g., where the containment vessel 200 comprises a relatively small, readily moveable structure such as a drum, bag, bin, tray, box, bucket, etc.), and/or the packaged waste screening subsystem 104 may be delivered to and/or moved relative to the containment vessel 200 (e.g., where the containment vessel 200 comprises a relatively larger structure such as a long section of pipe, a high volume tank, etc.).

The packaged waste screening subsystem 104 may include at least one radiation detection assembly 202 and at least one support assembly 212. The radiation detection assembly 202 may be removably retained (e.g., held, secured, etc.) in at least one position and at least one orientation relative to the containment vessel 200 by the support assembly 212, as described in further detail below. Optionally, the packaged waste screening subsystem 104 may also include at least one of a gearmotor 232, a temperature control assembly 234, a weighing assembly 236, and a supplemental computer/electronics assembly 238, as also described in further detail below.

The radiation detection assembly 202 may include a radiation detector 204 and at least one protective enclosure 206. The protective enclosure 206 may at least partially surround (e.g., envelop, encase, etc.) the radiation detector 204. In addition, the radiation detection assembly 202 may, optionally, include at least one collimator configured and positioned to focus a field of view of the radiation detector 204.

The protective enclosure 206 may include an outer housing 208 and at least one protective structure 210 disposed between the outer housing 208 and the radiation detector 204. The outer housing 208 may comprise a substantially rigid, hollow, and elongated structure configured to permit at least some radiation (e.g., gamma rays) to pass therethrough. In some embodiments, the outer housing 208 comprises a hollow tube formed of and including at least one of a metal (e.g., aluminum, magnesium, titanium, cobalt, chrome, molybdenum, steel, nickel), a metal alloy, and a ceramic. The outer housing 208 may include shielding (e.g., bismuth shielding, lead shielding, etc.) configured and positioned to protect the radiation detector 204 from at least one of ambient radiation and other radiation (e.g., radiation from other containment vessels 200) not desired to be measured. The protective structure 210 may be configured and positioned to protect the radiation detector 204 from at least one of physical shock and humidity. For example, the protective structure 210 may comprise at least one shock absorbing structure (e.g., an elastomer structure, a spring, etc.) sized, shaped, and positioned relative to each of the outer housing 208 and the radiation detector 204 to at least partially isolate the radiation detector 204 from vibrational shock experienced during movement of protective enclosure 206 that may otherwise damage and/or impair the radiation detector 204 during the use and operation of the packaged waste screening subsystem 104.

The radiation detector 204 may comprise any radiation detector configured and operable to detect the radioactivity of the material held in the containment vessel 200, and generate measurement data in response thereto. The radiation detector 204 may be configured and operated for the spectral analysis of a variety of different radiation emitters (e.g., radionuclides). The radiation detector 204 may, for example, be configured and operated to detect and measure at least one NORM and/or at least one TENORM, such as at least one of uranium-235 (²³⁵U), uranium-238 (²³⁸U), thorium-232 (²³²Th), radium-226 (²²⁶Ra), radium-228 (²²⁸Ra), potassium-40 (⁴⁰K), and daughter products of such radionuclides. Gamma ray lines generated by daughter products of particular radionuclides (e.g., ²³⁵U, ²³⁸U, ²³²Th, ²²⁶Ra, ²²⁸Ra, ⁴⁰K, etc.) may be utilized to quantify the particular radionuclides. In addition, the gamma ray lines generated by the daughter products may be utilized (e.g., with specialized algorithms) to provide secondary correction methods for density effects, and to correct for non-equilibrium of the daughter products (e.g., to provide radioactive decay corrections for the daughter production) when calculating the activity of the particular radionuclides. Such analysis may permit the characterization of radioactive waste any time after the radioactive waste is generated, rather than having to wait at least 30 days for equilibrium concentrations to be reached.

As a non-limiting example, and as shown in FIG. 2, in some embodiments the radiation detector 204 comprises a scintillation detector including at least one scintillator 213 and at least one sensor 214. The scintillator 213 may be operatively associated with (e.g., optically coupled to) the sensor 214 within the protective enclosure 206. The scintillator 213 may be configured and operated to receive radiation from the material held in the containment vessel 200 and convert the radiation into fluoresced radiation pulses. The scintillator 213 may be formed of and include any suitable scintillator material including, but not limited to, thallium doped sodium iodide crystal (NaI(Tl)), gadolinium oxyorthosilicate (GSO), YAlO₃ (YAP), LuYAP, cerium-doped lanthanum chloride (LaCl₃(Ce)), cerium-doped lanthanum bromide (LaBr₃(Ce)), bismuth germanate (BGO), LuAG, YAG, LuAP, SrI₂, GAGG/GYGaGG, CeBr₃, GdI₂, LuI₂, ceramic scintillators, GPS, LPS, BaBrI, LuAG ceramic, LiCaF, CLYC, CLLB, and CLLC. In some embodiments, the scintillator 213 is formed of and includes NaI(Tl). The sensor 214 may comprise any device configured and operated to receive and quantify the fluoresced radiation pulses output by the scintillator 213. For example, the sensor 214 may comprise a photodetector formed of and including one or more devices (e.g., a photocathode, an electron detector, an amplifier, a pre-amplifier, a discriminator, an analog-to-digital signal convertor, etc.) for receiving the fluoresced radiation pulses from the scintillator 213 and converting the fluoresced radiation pulses into electrical pulses that may be registered as counts for radioactivity analysis. As another example, the radiation detector 204 may comprise a different radiation detection device (i.e., a device other than a scintillation detector), such as a semiconductor detector (e.g., a germanium detector, a cadmium zinc telluride (CZT) detector, a mercuric iodide (HgI) detector, etc.), or a gas proportional counter (e.g., a xenon-proportional counter. For example, in additional embodiments, the radiation detector 204 comprises a germanium detector. The radiation detector 204 may exhibit a concentric configuration with a circumferential detection field, or may exhibit a stacked, or axial, configuration with a detection field at one axial end.

The radiation detector 204 may be configured to exhibit a surface area and volume permitting the radiation detector 204 to detect radionuclides (e.g., ²³⁵U, ²³⁸U, ²³²Th, ²²⁶Ra, ²²⁸Ra, ⁴⁰K, daughter products of such radionuclides, etc.) within the material held in the containment vessel 200. For example, the surface area of the radiation detector 204 may be within a range of from about 4.0 square inches (in²) to about 2.0 square feet (ft²). In some embodiments, the radiation detector 204 is about 1.0 foot (ft) long by about 0.25 inch (in) in diameter. The radiation detector 204 may be configured and operated to scan the material held in the containment vessel 200 and relatively rapidly quantify (e.g., in less than or equal to about 30 seconds) radionuclides present within the material.

In some embodiments, the radiation detection assembly 202 comprises at least one of the radiation detector assemblies described in U.S. Pat. Nos. 8,009,787; 8,031,825; 8,260,566; and 8,274,056, and U.S. Patent Application Publication Nos. 2009/0218489 and 2014/0001365, the disclosure of each of which is hereby incorporated herein in its entirety by this reference.

With continued reference to FIG. 2, the support assembly 212 may be configured and operated to receive, support, position, and orient the radiation detection assembly 202. The support assembly 212 may include a support frame 216 and a detector positioning assembly 222 operatively associated with (e.g., moveably attached to) the support frame 216. Optionally, the support assembly 212 may also include at least one gearmotor 232 operatively associated with at least one of the support frame 216 and the detector positioning assembly 222, as described in further detail below.

The support frame 216 may exhibit any configuration sufficient to carry the detector positioning assembly 222, and facilitating desired positioning of the detector positioning assembly 222 relative to the containment vessel 200 during use and operation of the packaged waste screening subsystem 104. By way of non-limiting example, and as shown in FIG. 2, the support frame 216 may include at least one longitudinally-extending structure 218, and at least one laterally-extending structure 220. The longitudinally-extending structure 218 may be coupled to and at least partially carry the laterally-extending structure 220. As depicted in FIG. 2, in some embodiments, at least two longitudinally-extending structures 218 may be located proximate to opposing ends of the laterally-extending structure 220. In additional embodiments, the one or more longitudinally-extending structures 218 may be located at one or more different locations along the laterally-extending structure 220. In addition, the laterally-extending structure 220 may be configured to hold (e.g., suspend) and at least partially position the detector positioning assembly 222. The laterally-extending structure 220 may be configured such that at least a portion of the detector positioning assembly 222 may be moveably connected thereto. For example, as depicted in FIG. 2, the laterally-extending structure 220 may exhibit at least one surface upon which the detector positioning assembly 222 may be suspended (e.g., hang) and may move (e.g., slide) in one or more directions. Put another way, the laterally-extending structure 220 may serve as a track (e.g., rail, slide rod, etc.) for the detector positioning assembly 222.

The support frame 216 may be stationary, or may be at least partially mobile. For example, in some embodiments, and as shown in FIG. 2, the support assembly 212 may include wheel assemblies 240 connected (e.g., attached, coupled, etc.) to one or more other portions of the support frame 216 to facilitate movement of the support frame 216 in one or more directions. One or more of the wheel assemblies 240 may, optionally, include a locking mechanism configured to at least partially secure the support frame 216 in a desired position during use and operation of the packaged waste screening subsystem 104. In further embodiments, the support frame 216 may employ a different means of movement. For example, the support frame 216 may be connected to a track assembly facilitating movement of the support frame 216 in one or more directions. Movement of the support frame 216 may permit efficient scanning, measurement, and analysis of material held within relatively large containment vessels 200 (e.g., relatively long sections of pipe, relatively large settling tanks, etc.).

The detector positioning assembly 222 may exhibit any configuration sufficient to carry the radiation detection assembly 202, and facilitating desired positioning and orientation of the radiation detection assembly 202 relative to the containment vessel 200 during use and operation of the packaged waste screening subsystem 104. By way of non-limiting example, and as shown in FIG. 2, the detector positioning assembly 222 may include at least one lateral movement control device 224, at least one longitudinal movement control device 226, at least one rotational movement control device 228, and at least one detector retention device 230. The lateral movement control device 224 may be connected to and at least partially underlie the laterally-extending structure 220 of the support frame 216, the longitudinal movement control device 226 may be connected to and at least partially underlie the lateral movement control device 224, the rotational movement control device 228 may be connected to and at least partially underlie the longitudinal movement control device 226, and the detector retention device 230 may be connected to and at least partially underlie the rotational movement control device 228. In additional embodiments, the position of the longitudinal movement control device 226 and the rotational movement control device 228 may be reversed. In further embodiments, the at least one of the longitudinal movement control device 226 and the rotational movement control device 228 may, optionally, be omitted.

The lateral movement control device 224 may comprise any device configured to at least partially control the lateral (e.g., horizontal) movement of the radiation detection assembly 202. The lateral movement control device 224 may be configured to reversibly laterally move (e.g., slide) across the laterally-extending structure 220 of the support frame 216. Accordingly, the lateral movement control device 224 may be controlled (e.g., by way of computer numerical control and/or manual control) to laterally position the radiation detection assembly 202 relative to the containment vessel 200 during use and operation of the packaged waste screening subsystem 104. As a non-limiting example, the lateral movement control device 224 may comprise a cross-slide device configured to moveably connect (e.g., mount) to the laterally-extending structure 220 of the support frame 216. The lateral movement control device 224 may include means of coupling to and suspending one or more other components (e.g., the longitudinal movement control device 226, etc.) of the detector positioning assembly 222.

The longitudinal movement control device 226 may comprise any device configured to at least partially control the longitudinal (e.g., vertical) movement of the radiation detection assembly 202. The longitudinal movement control device 226 may be configured to reversibly longitudinally move the radiation detection assembly 202. Accordingly, the longitudinal movement control device 226 may be controlled (e.g., by way of computer numerical control and/or manual control) to longitudinally position the radiation detection assembly 202 relative to the containment vessel 200 during use and operation of the packaged waste screening subsystem 104. As a non-limiting example, the longitudinal movement control device 226 may comprise a winch device. The longitudinal movement control device 226 may include means of coupling to one or more other components (e.g., the lateral movement control device 224, the rotational movement control device 228, etc.) of the detector positioning assembly 222.

The rotational movement control device 228 may comprise any device configured to at least partially control the rotational (e.g., radial) movement of the radiation detection assembly 202. The rotational movement control device 228 may be configured to reversibly rotate the radiation detection assembly 202. Accordingly, the radiation rotational movement control device 228 may be controlled (e.g., by way of computer numerical control and/or manual control) to radially position and orient the radiation detection assembly 202 relative to the containment vessel 200 during use and operation of the packaged waste screening subsystem 104. The rotational movement control device 228 may include means of coupling to one or more other components (e.g., the longitudinal movement control device 226, the detector retention device 230, etc.) of the detector positioning assembly 222.

The detector retention device 230 may comprise any device configured to removably retain (e.g., hold) the radiation detection assembly 202. For example, as shown in FIG. 2, the detector retention device 230 may include one or more structures that removably couple to one or more portions (e.g., ends, sides, etc.) of the radiation detection assembly 202. The detector retention device 230 may also include means of coupling to one or more other components (e.g., rotational movement control device 228, etc.) of the detector positioning assembly 222.

The configurations of the support assembly 212 and the detector positioning assembly 222, including the configurations of the various components thereof, may permit the radiation detection assembly 202 to be provided in nearly any desired position and any desired orientation relative to the containment vessel 200. In addition, the configurations of the support assembly 212 and the detector positioning assembly 222 may permit the radiation detection assembly 202 to traverse nearly any desired movement path (e.g., including complex, multi-directional movement paths) relative to containment vessel 200. Such positioning, orientation, and movement versatility may facilitate the simple and rapid characterization of material held within containment vessels 200 of various shapes, sizes, and/or material fill levels.

Movement (e.g., motion) of one or more components of the support assembly 212 and the detector positioning assembly 222 may be at least partially automated. For example, as shown in FIG. 2, the packaged waste screening subsystem 104 may, optionally, include at least one gearmotor 232 configured and operated to provide translational movement to the support frame 216 (e.g., through operative association with the wheel assemblies 240, etc.), and/or to provide movement to at least one component of the detector positioning assembly 222 (e.g., through operative association with at least one of the lateral movement control device 224, the longitudinal movement control device 226, and the rotational movement control device 228). If present, the gearmotor 232 may be controlled by way of computer numerical control. For example, the gearmotor 232 (and, hence, the movement of one or more components of the support assembly 212 and the detector positioning assembly 222) may be automatically controlled by at least one of the main computer/electronics assembly 102 (FIG. 1) of the waste screening system 100 (FIG. 1), and a supplemental computer/electronics assembly (described in further detail below) of the packaged waste screening subsystem 104. In additional embodiments, one or more components of the support assembly 212 (e.g., the support frame 216, the detector positioning assembly 222, the wheel assemblies 240, etc.) may be manually moved (e.g., by at least one operator).

With continued reference to FIG. 2, the packaged waste screening subsystem 104 may, optionally, also include at least one temperature control assembly 234. The temperature control assembly 234 may be configured and operated to provide cooling and/or heating to one or more components of the radiation detection assembly 202. For example, the temperature control assembly 234 may be configured and operated to transfer (e.g., through one or more lines) at least one of cooling fluid and heating fluid to and from the radiation detection assembly 202. Various types of radiation detectors (e.g., semiconductor detectors, such as germanium detectors), which may be included in radiation detection assembly 202, may achieve enhanced performance (e.g., better resolution, more accuracy, etc.) during detection operations when sufficiently cooled. In some embodiments, the temperature control assembly 234 includes at least one cooling device (e.g., a compressor) configured and operated to cool fluid to a suitable temperature for efficient operation of the radiation detector 204. In additional embodiments, the temperature control assembly 234 delivers at least one fluid having an already sufficiently chilled temperature (e.g., liquid nitrogen) to and from the radiation detection assembly 202. If present, the temperature control assembly 234 may be controlled by way of computer numerical control. In some embodiments, the temperature control assembly 234 comprises at least one of the temperature control assemblies described in U.S. Pat. No. 8,260,566 and U.S. Patent Application Publication No. 2009/0218489, the disclosure of each of which was previously incorporated herein in its entirety by this reference. The main computer/electronics assembly 102 (FIG. 1) of the waste screening system 100 (FIG. 1) may also utilize control logic functions to automatically change operational parameters of one or more components of the packaged waste screening subsystem 104, such as amplifier gain of the radiation detector 204, to account for changes in temperature (e.g., temperature increases, temperature decreases) and/or other environmental conditions.

The packaged waste screening subsystem 104 may, optionally, also include at least one weighing assembly 236. The weighing assembly 236 may be configured and operated to determine the weight of the material within the containment vessel 200. For example, the weighing assembly 236 may include load cells or other weight measurement devices upon which the containment vessel 200 having the material therein may be provided and weighed. The weight of the material may be used in analysis, such as to calculate density of the material. Optionally, the weighing assembly 236 may also be configured and operated to rotate the containment vessel 200 in one or more directions.

The packaged waste screening subsystem 104 may, optionally, also include at least one supplemental computer/electronics assembly 238. The supplemental computer/electronics assembly 238 may be configured and operated to control one or more other components of the packaged waste screening subsystem 104 (e.g., the radiation detector 204, the gearmotor 232, the temperature control assembly 234, the weighing assembly 236, components of the support assembly 212, components of the detector positioning assembly 222, etc.). If present, the supplemental computer/electronics assembly 238 may also include devices (e.g., multichannel analyzers, analog-to-digital converters, pulse counters, amplifiers, etc.) for receiving and analyzing data from other components of the packaged waste screening subsystem 104 (e.g., the radiation detector 204, the temperature control assembly 234, the weighing assembly 236, etc.). The supplemental computer/electronics assembly 238 may, optionally, utilize control logic similar to that previously described in relation to the main computer/electronics assembly 102 (FIG. 1) of the radioactive waste screening system 100 (FIG. 1) to automatically monitor and automatically control various components of the packaged waste screening subsystem 104, and/or to automatically analyze and automatically correct measurement data received from the various components of the packaged waste screening subsystem 104. In addition, the supplemental computer/electronics assembly 238 may be configured and operated to communicate with the main computer/electronics assembly 102 (FIG. 1) of the radioactive waste screening system 100 (FIG. 1). For example, the supplemental computer/electronics assembly 238 may include one or more input devices configured to receive information (e.g., operational commands) from the main computer/electronics assembly 102, and one or more output devices configured to transmit other information (e.g., measurement data) to the main computer/electronics assembly 102. The supplemental computer/electronics assembly 238 may further include storage media (e.g., hard drives, external hard drives, flash memory, RAM, ROM, DVDs, etc.) for storing information related to measurements (e.g., radiation measurements, weight measurements, etc.) and/or the status of components of the packaged waste screening subsystem 104. If present, the supplemental computer/electronics assembly 238 may be operatively associated with other components of the packaged waste screening subsystem 104 and the main computer/electronics assembly 102 (FIG. 1) through at least one of wired means (e.g., data cables), and wireless means (e.g., WiFi, Bluetooth, zigbee, etc.). In additional embodiments, the supplemental computer/electronics assembly 238 may be omitted, and the main computer/electronics assembly 102 may, itself, be utilized to perform one or more of the above described operations of the supplemental computer/electronics assembly 238.

It is noted that in FIG. 2, the various components of the packaged waste screening subsystem 104 (e.g., the radiation detection assembly 202, the support assembly 212, the gearmotor 232, the temperature control assembly 234, the weighing assembly 236, the supplemental computer/electronics assembly 240, etc.) are shown as being provided at particular locations relative to one another. However, the various components of the packaged waste screening subsystem 104 are shown in FIG. 2 at such particular locations for simplicity and not as a physical limitation. Thus, one or more of the various components of the packaged waste screening subsystem 104 may be provided at different locations relative to one another than those depicted in FIG. 2.

During operation of the packaged waste screening subsystem 104, at least one containment vessel 200 may be positioned proximate at least the support assembly 212. The containment vessel 200 may be delivered to the location of the packaged waste screening subsystem 104, and/or the packaged waste screening subsystem 104 may be delivered to the location of the containment vessel 200. Thereafter, the detector positioning assembly 222 may move, position, and orient the radiation detection assembly 202 proximate the containment vessel 200 to detect radiation in situ. The packaged waste screening subsystem 104 may provide radioactivity counts and may estimate radionuclide activity (or activities) for the material held within the containment vessel 200. The estimated radionuclide activity may be the basis for classifying the packaged material as non-radioactive waste (e.g., material exhibiting less than 5 picoCurie per gram (pCi/g) of activity), intermediate level radioactive waste (e.g., material exhibiting between 5 pCi/g and 30 pCi/g of activity), or high level radioactive waste (e.g., material exhibiting greater than 30 pCi/g of activity). The estimated radionuclide activity may include uncertainty data (e.g., random and systematic). The main computer/electronics assembly 102 (FIG. 1) of the waste screening system 100 (FIG. 1) may automatically monitor the activity associated with the containment vessel 200 during radioactivity counting such that the packaged waste screening subsystem 104 only counts long enough to determine if the material within the containment vessel 200 exhibits a minimum detectable amount (MDA) of activity below a lower level detection limit (e.g., 5 pci/g), or only counts long enough to determine that the material exhibits activity above the lower level detection limit with sufficiently low uncertainties (e.g., less than 50 percent uncertainty). If the packaged waste screening subsystem 104 indicates that the material within the containment vessel 200 is intermediate level radioactive waste, the material may be disposed of at a facility (e.g., a commercial TENORM waste disposal facility) that accepts radioactive waste exhibiting such radiation levels. If the packaged waste screening subsystem 104 indicates that the material within the containment vessel 200 is high level radioactive waste, the material may be remediated or may be disposed of in an appropriate manner. If the packaged waste screening subsystem 104 indicates that the material within the containment vessel 200 is non-radioactive waste, the material may still have a radiation level that may require disposal at some other facility (e.g., Envirocare) that accepts radioactive waste with such radiation levels, or the material may be “free released” for other uses (e.g., road bed aggregate, cemented waste containers, etc.). In some situations, it may be possible to alter (i.e., raise or lower) the radiation levels of the material to fall within the desired radiation levels. Acts used to alter the radiation levels may include remediation of the material or blending the material with another material prior to final packaging and certification. If the exhibited radiation level of the material is sufficiently low enough, the material may not require remediation, disposal, further storage, or any combination thereof. In such situations, the material may, for example, be returned to the waste pit. Details as to the processes used for the above radioactivity analysis of the material within the containment vessel 200 are described in further detail below.

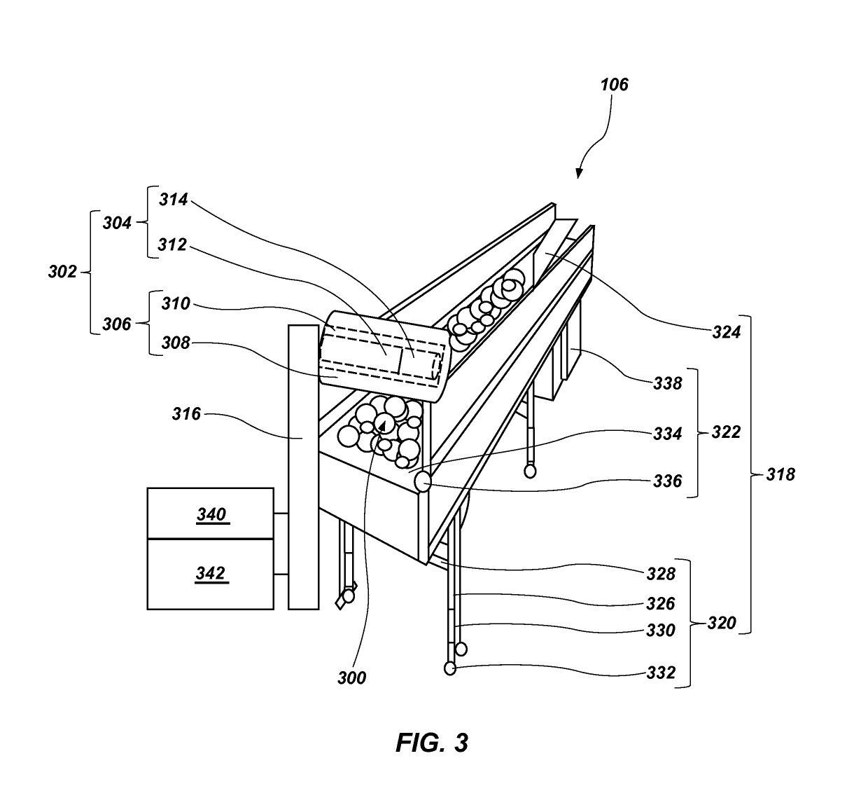

FIG. 3 is a schematic of the volume waste screening subsystem 106 in accordance with embodiments of the disclosure. The volume waste screening subsystem 106 may be configured and operated to characterize the radioactivity of a volume of material 300 delivered thereto, and segregate the volume of material 300 based on such radioactivity characterization. Large volumes (e.g., a truck load sized volumes) of material 300 may delivered to the volume waste screening subsystem 106. The volume of material 300 may be delivered to the volume waste screening subsystem 106 without being held within one or more containment vessels, or may be delivered to the volume waste screening subsystem 106 while held within one or more containment vessels (e.g., large volume trays, large volume bags, large volume bins, large volume boxes, etc.). The main computer/electronics assembly 102 (FIG. 1) of the waste screening system 100 (FIG. 1) may monitor and control various components of the volume waste screening subsystem 106 to determine and adjust processing rates to permit lower radiation detection limits (e.g., 5 pCi/g) to be achieved during processing of the volume of material 300.

The volume waste screening subsystem 106 may include at least one radiation detection assembly 302, at least one detector support assembly 316, and at least one segregation assembly 318. The volume of material 300 may be provided to the segregation assembly 318, and the radiation detection assembly 302 may be removably retained (e.g., held, secured, etc.) in at least one position and at least one orientation relative to each of the segregation assembly 318 and the volume of material 300 by the detector support assembly 316, as described in further detail below. Optionally, the volume waste screening subsystem 106 may also include at least one of a temperature control assembly 424, and a supplemental computer/electronics assembly 342, as also described in further detail below.

The radiation detection assembly 302 may include at least one radiation detector 304 and at least one protective enclosure 306. The protective enclosure 306 may at least partially surround (e.g., envelop, encase, etc.) the radiation detector 304. In addition, the radiation detection assembly 302 may, optionally, include at least one collimator configured and positioned to focus a field of view of the radiation detector 304.

The protective enclosure 306 may include an outer housing 308 and at least one protective structure 310 disposed between the outer housing 308 and the radiation detector 304. The outer housing 308 may comprise a substantially rigid, hollow, and elongated structure configured to permit at least some radiation (e.g., gamma rays) to pass therethrough. In some embodiments, the outer housing 308 comprises a hollow tube formed of and including at least one of a metal (e.g., aluminum, magnesium, titanium, cobalt, chrome, molybdenum, bismuth, lead, steel, nickel), a metal alloy, and a ceramic. The outer housing 308 may include shielding (e.g., bismuth shielding, lead shielding, etc.) configured and positioned to protect the radiation detector 204 from at least one of ambient radiation and other radiation not desired to be measured. The protective structure 310 may be configured and positioned to protect the radiation detector 304 from at least one of physical shock and humidity. For example, the protective structure 310 may comprise at least one shock absorbing structure (e.g., an elastomer structure, a spring, etc.) sized, shaped, and positioned relative to each of the outer housing 308 and the radiation detector 304 to at least substantially isolate the radiation detector 304 from vibrational shock that may otherwise damage and/or impair the radiation detector 304 during the use and operation of the volume waste screening subsystem 106.

The radiation detector 304 may comprise any radiation detector configured and operated to detect the radioactivity of different portions (e.g., different increments) of the volume of material 300 at the rate (or rates) at which the different portions of the volume of material 300 are conveyed (e.g., moved) past the radiation detection assembly 302, and generate measurement data in response thereto. The radiation detector 304 may, for example, be configured and operated to detect the radioactivity of different portions of the volume of material 300 at a rate greater than or equal to about 0.1 cubic meter per second (m³/s), such as greater than or equal to about 0.2 m³/s, greater than or equal to about 0.5 m³/s, or greater than or equal to about 1.0 m³/s. In some embodiments, the radiation detector 304 is configured and operable to detect the radioactivity of different portions of the volume of material 300 at a rate within a range of from about 0.2 m³/s to about 1.0 m³/s. The radiation detector 304 may be configured and operated for the spectral analysis of a variety of different radiation emitters (e.g., radionuclides). The radiation detector 304 may, for example, be configured and operated to detect and measure at least one NORM and/or at least one TENORM, such as at least one of ²³⁵U, ²³⁸U, ²³²Th, ²²⁶Ra, ²²⁸Ra, ⁴⁰K, and daughter products of such radionuclides.

As a non-limiting example, and as shown in FIG. 3, in some embodiments the radiation detector 304 comprises a scintillation detector including at least one scintillator 312 and at least one sensor 314. The scintillator 312 may be operatively associated with (e.g., optically coupled to) the sensor 314 within the protective enclosure 306. The scintillator 312 may be configured and operated to receive radiation from the volume of material 300 and convert the radiation into fluoresced radiation pulses. The scintillator 312 may be formed of and include any suitable scintillator material including, but not limited to, NaI(Tl), GSO, YAlO₃ (YAP), LuYAP, LaCl₃(Ce), LaBr₃(Ce), BGO, LuAG, YAG, LuAP, SrI₂, GAGG/GYGaGG, CeBr₃, GdI₂, LuI₂, ceramic scintillators, GPS, LPS, BaBrI, LuAG ceramic, LiCaF, CLYC, CLLB, and CLLC. In some embodiments, the scintillator 312 is formed of and includes NaI(Tl). The sensor 314 may comprise any device configured and operated to receive and quantify the fluoresced radiation pulses output by the scintillator 312. For example, the sensor 314 may comprise a photodetector formed of and including one or more devices (e.g., a photocathode, an electron detector, an amplifier, a pre-amplifier, a discriminator, an analog-to-digital signal convertor, etc.) for receiving the fluoresced radiation pulses from the scintillator 312 and converting the fluoresced radiation pulses into electrical pulses that may be registered as counts for radioactivity analysis. As another example, the radiation detector 304 may comprise a different radiation detection device (i.e., a device other than a scintillation detector), such as a semiconductor detector (e.g., a germanium detector, a CZT detector, a HgI detector, etc.), or a gas proportional counter (e.g., a xenon-proportional counter). For example, in additional embodiments, the radiation detector 304 comprises a germanium detector. The radiation detector 304 may exhibit a concentric configuration with a circumferential detection field, or may exhibit a stacked, or axial, configuration with a detection field at one axial end.

The radiation detector 304 may be configured to exhibit a surface area and volume permitting the radiation detector 304 to detect radionuclides (e.g., ²³⁵U, ²³⁸U, ²³²Th, ²²⁶Ra, ²²⁸Ra, ⁴⁰K, daughter products of such radionuclides, etc.) within different portions of the volume of material 300 at the rate the different portions of the volume of material 300 are moved past the radiation detector 304 by a conveyor assembly 322. For example, the surface area of the radiation detector 304 may be within a range of from about 4.0 in² to about 2.0 ft². In some embodiments, the radiation detector 304 is about 1.0 ft long by about 0.25 ft in diameter. The radiation detector 304 may be configured and operated to scan a portion of volume of material 300 moving part the radiation detector 304 and relatively rapidly quantify (e.g., in less than or equal to about 30 seconds) radionuclides present within the portion of the volume of material 300.

In some embodiments, the radiation detection assembly 302 comprises at least one of the radiation detector assemblies described in U.S. Pat. Nos. 8,009,787; 8,031,825; 8,260,566; and 8,274,056, and U.S. Patent Application Publication Nos. 2009/0218489 and 2014/0001365, the disclosure of each of which previously incorporated herein in its entirety by this reference.

With continued reference to FIG. 3, the detector support assembly 316 may be configured and operated to receive, support, position, and orient the radiation detection assembly 302. The detector support assembly 316 may exhibit any configuration sufficient to carry the radiation detection assembly 302, and facilitating desired positioning of the radiation detection assembly 302 relative to each of the volume of material 300 and the segregation assembly 318 during use and operation of the volume waste screening subsystem 106. By way of non-limiting example, and as shown in FIG. 3, the detector support assembly 316 may include at least one longitudinally-extending structure coupled to (e.g., directly coupled to, indirectly coupled to, etc.), at least partially carrying, and at least partially positioning the radiation detection assembly 302. The detector support assembly 316 may be attached (e.g., coupled to) to the segregation assembly 318, or may be detached from the segregation assembly 318. In addition, the detector support assembly 316 may be stationary, or may be at least partially mobile.

The segregation assembly 318 may include a segregator support assembly 320, a conveyor assembly 322, and a gate assembly 324. The segregator support assembly 320 may exhibit any configuration sufficient to carry at least a portion of the volume of material 300, the conveyor assembly 322, and the gate assembly 324 during use and operation of the volume waste screening subsystem 106. By way of non-limiting example, the segregator support assembly 320 may exhibit a plurality of longitudinally-extending structures 326 coupled to a plurality of laterally-extending structures 328 in an arrangement configured to substantially support the volume of material 300, the conveyor assembly 322, and the gate assembly 324 provided thereover. In addition, the segregator support assembly 320 may be configured and operated to determine the weight of at least a portion of the volume of material 300. For example, the segregator support assembly 320 may include weight measurement devices 330 (e.g., load cells) through which different portions of the volume of material 300 may be weighed. The weight of the different portions of the volume of material 300 may be used in analysis, such as to calculate density of the different portions of the volume of material 300. Furthermore, the segregator support assembly 320 may be stationary, or may be at least partially mobile. For example, as shown in FIG. 3, the segregator support assembly 320 may include wheel assemblies 332, connected (e.g., attached, coupled, etc.) to one or more other portions of the segregator support assembly 320, and facilitating movement of the segregator support assembly 320 in one or more directions. One or more of the wheel assemblies 332 may include a locking mechanism configured to at least partially secure the segregator support assembly 320 in a desired position during use and operation of the volume waste screening subsystem 106. In further embodiments, the segregator support assembly 320 may employ a different means of movement. For example, the segregator support assembly 320 may be connected to a track assembly facilitating movement of the segregator support assembly 320 in one or more directions.

The conveyor assembly 322 may be configured and operated to temporarily carry different portions of the volume of material 300 delivered to the volume waste screening subsystem 106, and to transport (e.g., move) the different portions the volume of material 300 at one or more predetermined rates (e.g., a rate greater than or to about 0.1 m³/s, such as greater than or equal to about 0.2 m³/s, greater than or equal to about 0.5 m³/s, greater than or equal to about 1.0 m³/s, or from about 0.2 m³/s to about 1.0 m³/s). For example, as shown in FIG. 2, the conveyor assembly 322 may include at least one conveyor belt 334, rollers 336, and at least one gearmotor 338 configured and operated to drive different portions of the volume of material 300 in one or more directions at one or more rates. The conveyor assembly 322 may be controlled by way of computer numerical control. In some embodiments, the conveyor assembly 322 comprises the conveyor assembly described in U.S. Pat. No. 8,260,566, the disclosure of which was previously incorporated herein in its entirety by this reference.

The gate assembly 324 may be configured and operated to segregate (e.g., divide, separate, etc.) the different portions of the volume of material 300 based on radioactivity analysis performed by the volume waste screening subsystem 106 and/or the main computer/electronics assembly 102 (FIG. 1) of the radioactive waste screening system 100 (FIG. 1). For example, the gate assembly 324 may comprise at least one device (e.g., a sorting device, such as a moveable gate device) positioned along the conveyor assembly 322 at a location downstream of the radiation detection assembly 302 and configured to divert portions of the volume of material 300 exhibiting radiation levels at or below a selected lower limit in a first direction, to divert additional portions of the volume of material 300 exhibiting radiation levels between the selected lower limit and a selected upper limit in a second direction, and to divert other portions of the volume of material 300 exhibiting radiation levels at or above the selected upper limit in a third direction. The gate assembly 324 may be controlled by way of computer numerical control.

With continued reference to FIG. 3, the volume waste screening subsystem 106 may, optionally, also include at least one temperature control assembly 340. The temperature control assembly 340 may be configured and operated to provide cooling and/or heating to one or more components of the radiation detection assembly 302. For example, the temperature control assembly 340 may be configured and operated to transfer (e.g., through one or more lines) at least one of cooling fluid and heating fluid to and from the radiation detection assembly 302. Various types of radiation detectors (e.g., semiconductor detectors, such as germanium detectors), which may be included in radiation detection assembly 302, may achieve enhanced performance (e.g., better resolution, more accuracy, etc.) during detection operations when sufficiently cooled. In some embodiments, the temperature control assembly 340 includes at least one cooling device (e.g., a compressor) configured and operated to cool fluid to a suitable temperature for efficient operation of the radiation detector 304. In additional embodiments, the temperature control assembly 340 delivers at least one fluid having an already sufficiently chilled temperature (e.g., liquid nitrogen) to and from the radiation detection assembly 302. If present, the temperature control assembly 340 may be controlled by way of computer numerical control. In some embodiments, the temperature control assembly 340 comprises at least one of the temperature control assemblies described in U.S. Pat. No. 8,260,566 and U.S. Patent Application Publication No. 2009/0218489, the disclosure of each of which was previously incorporated herein in its entirety by this reference. The main computer/electronics assembly 102 (FIG. 1) of the waste screening system 100 (FIG. 1) may also utilize control logic functions to automatically change operational parameters of one or more components of the volume waste screening subsystem 106, such as amplifier gain of the radiation detector 304, to account for changes in temperature (e.g., temperature increases, temperature decreases) and/or other environmental conditions.

The volume waste screening subsystem 106 may, optionally, also include at least one supplemental computer/electronics assembly 342. The supplemental computer/electronics assembly 342 may be configured and operated to control one or more other components of the volume waste screening subsystem 106 (e.g., the radiation detector 304; components of the segregation assembly 318, such as components of the segregator support assembly 320, components of the conveyor assembly 322, and components of the gate assembly 324; the temperature control assembly 340; etc.). If present, the supplemental computer/electronics assembly 342 may also include devices (e.g., multichannel analyzers, analog-to-digital converters, pulse counters, amplifiers, etc.) for receiving and analyzing data from other components of the volume waste screening subsystem 106 (e.g., the radiation detector 304, the weight measurement devices 330, the temperature control assembly 340, etc.). The supplemental computer/electronics assembly 342 may, optionally, utilize control logic similar to that previously described in relation to the main computer/electronics assembly 102 (FIG. 1) of the radioactive waste screening system 100 (FIG. 1) to automatically monitor and automatically control various components of the volume waste screening subsystem 106, and/or to automatically analyze and automatically correct measurement data received from the various components of the volume waste screening subsystem 106. In addition, the supplemental computer/electronics assembly 342 may be configured and operated to communicate with the main computer/electronics assembly 102 (FIG. 1) of the radioactive waste screening system 100 (FIG. 1). For example, the supplemental computer/electronics assembly 342 may include one or more input devices configured to receive information (e.g., operational commands) from the main computer/electronics assembly 102, and one or more output devices configured to transmit other information (e.g., measurement data) to the main computer/electronics assembly 102. The supplemental computer/electronics assembly 342 may further include storage media (e.g., hard drives, external hard drives, flash memory, RAM, ROM, DVDs, etc.) for storing information related to measurements (e.g., radiation measurements, weight measurements, etc.) and/or the status of components of the volume waste screening subsystem 106. If present, the supplemental computer/electronics assembly 342 may be operatively associated with other components of the volume waste screening subsystem 106 and the main computer/electronics assembly 102 (FIG. 1) through at least one of wired means (e.g., data cables) and wireless means (e.g., WiFi, Bluetooth, zigbee, etc.). In additional embodiments, the supplemental computer/electronics assembly 342 may be omitted, and the main computer/electronics assembly 102 may, itself, be utilized to perform one or more of the above described operations of the supplemental computer/electronics assembly 342.

It is noted that in FIG. 3, the various components of the volume waste screening subsystem 106 (e.g., the radiation detection assembly 302, the detector support assembly 316, the segregation assembly 318, the temperature control assembly 340, the supplemental computer/electronics assembly 342, etc.) are shown as being provided at particular locations relative to one another. However, the various components of the volume waste screening subsystem 106 are shown in FIG. 3 at such particular locations for simplicity and not as a physical limitation. Thus, one or more of the various components of the volume waste screening subsystem 106 may be provided at different locations relative to one another than those depicted in FIG. 3.

During operation of the volume waste screening subsystem 106, the volume of material 300 may be delivered (e.g., by way of one or more vehicles) to the conveyor assembly 322. The conveyor assembly 322 may move (e.g., substantially continuously move) different portions of the volume of material 300 past the radiation detection assembly 302 at one or more desired rates (e.g., at least one rate within a range of from about 0.2 m³/s to about 1.0 m³/s) to detect radiation in situ. The volume waste screening subsystem 106 may provide continuous radioactivity counts and may continuously estimate radionuclide activity for different portions of the volume of material 300. The estimated radionuclide activity may be the basis for classifying different portions of the volume of material 300 as non-radioactive waste (e.g., material exhibiting less than 5 picoCurie per gram (pCi/g) of activity), intermediate level radioactive waste (e.g., material exhibiting between 5 pCi/g and 30 pCi/g of activity), or high level radioactive waste (e.g., material exhibiting greater than 30 pCi/g of activity). The estimated radionuclide activity may include uncertainty data (e.g., random and systematic). If the volume waste screening subsystem 106 indicates that a portion of the volume of material 300 is intermediate level radioactive waste, the portion of test material may diverted (e.g., by way of the gate assembly 324) to a suitable containment vessel and may then be disposed of at a facility (e.g., a commercial TENORM waste disposal facility) that accepts radioactive waste exhibiting such radiation levels. If the radioactivity detection and analysis indicates that a portion volume of material 300 is high level radioactive waste, the portion of the volume of material 300 may be diverted to a different, suitable containment vessel and may be remediated or disposed of in an appropriate manner. If the radioactivity detection and analysis indicates that a portion of the volume of material 300 is non-radioactive waste, the portion of the volume of material 300 may be diverted to another different, suitable containment vessel. The portion of the volume of material 300 may still have a radiation level that may require disposal at some other facility (e.g., Envirocare) that accepts radioactive waste with such radiation levels, or the material may be “free released” for other uses (e.g., road bed aggregate, cemented waste containers, etc.). In some situations, it may be possible to alter (i.e., raise or lower) the radiation levels of the portion of the volume of material 300 to fall within the desired radiation levels. Steps used to alter the radiation levels may include remediation of the portion of the volume of material 300 or blending the portion of the volume of material 300 with another material prior to final packaging and certification. If the exhibited radiation level of the portion of the volume of material 300 is sufficiently low enough, the portion of the volume of material 300 may not require remediation, disposal, further storage, or any combination thereof. In such situations, the portion of the volume of material 300 may, for example, be returned to the waste pit. Details as to the processes used for the above radioactivity analysis of the volume of material 300 are described in further detail below.

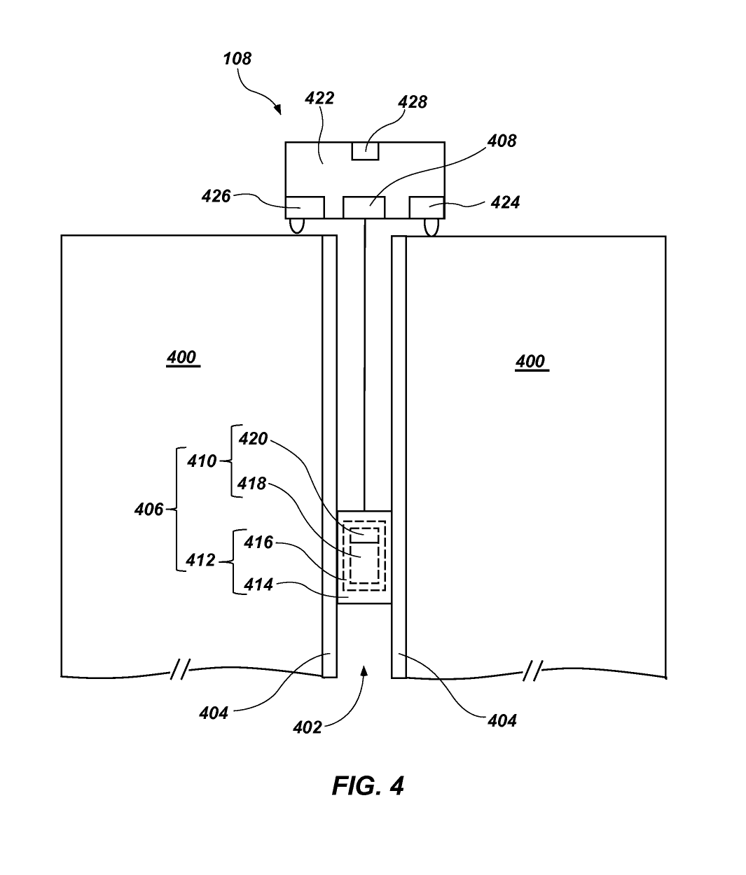

FIG. 4 is a schematic of the subsurface waste characterization subsystem 108 in accordance with embodiments of the disclosure. The subsurface waste characterization subsystem 108 may be configured and operated to characterize (e.g., profile) the radioactivity of regions of a subterranean formation 400 adjacent a borehole 402. The subterranean formation 400 may, for example, comprise an earthen formation including radioactive material (e.g., buried radioactive waste, NORM, TENORM, etc.) present therein. The subsurface waste characterization subsystem 108 may be utilized to monitor the distribution of radioactive material at established locations (e.g., waste sites) within the subterranean formation 400, and/or to quantify potential migration of radioactive material from such established locations within the subterranean formation 400.

The subsurface waste characterization subsystem 108 may include at least one cone penetrometer assembly 404, at least one radiation detection assembly 406, and detector positioning assembly 408. The cone penetrometer assembly 404 may be at least partially provided (e.g., pushed) into the subterranean formation 400, and the detection assembly 406 may be delivered to at least one selected position within the cone penetrometer assembly 404 by the detector positioning assembly 408, as described in further detail below. Optionally, the subsurface waste characterization subsystem 108 may also include at least one of a position locating device 428, a temperature control assembly 424, and a supplemental computer/electronics assembly 426, as also described in further detail below.

The cone penetrometer assembly 404 may be configured and operated to at least partially form the borehole 402 to a desired depth within the subterranean formation 400. For example, the cone penetrometer assembly 404 may comprise at least one substantially hollow and elongated structure (e.g., a hollow tube) configured to be driven (e.g., pushed) into the subterranean formation 400 to a desired depth, such as a depth greater than or equal to about 20 feet (ft), greater than or equal to about 30 ft, or greater than or equal to about 40 ft. In some embodiments, the cone penetrometer assembly 404 comprises at least one hollow tube configured to be driven into the subterranean formation 400 within a range of from about 30 ft to about 40 ft. The cone penetrometer assembly 404 may exhibit any size, shape, and material composition that does not substantially impede the characterization of the subterranean formation 400 using the radiation detection assembly 406. For example, the substantially hollow and elongated structure (e.g., hollow tube) of the cone penetrometer assembly 404 may exhibit a plurality of apertures (e.g., perforations, holes, etc.) in one or more regions thereof to provide the radiation detection assembly 406 with more direct access to portions of subterranean formation 400. In additional embodiments, the substantially hollow and elongated structure may be removed from the borehole 402 prior to testing the subterranean formation 400 with the radiation detection assembly 406.

The radiation detection assembly 406 may include a radiation detector 410, and at least one protective enclosure 412. The protective enclosure 412 may at least partially surround (e.g., envelop, encase, etc.) the radiation detector 410. In addition, the radiation detection assembly 410 may, optionally, include at least one collimator configured and positioned to focus a field of view of the radiation detector 410.

The protective enclosure 412 may include an outer housing 414 and at least one protective structure 416 disposed between the outer housing 414 and the radiation detector 410. The outer housing 414 may comprise a substantially rigid, hollow, and elongated structure configured to permit at least some radiation (e.g., gamma rays) to pass therethrough. In some embodiments, the outer housing 414 comprises a hollow tube formed of and including at least one of a metal (e.g., aluminum, magnesium, titanium, cobalt, chrome, molybdenum, bismuth, lead, steel, nickel), a metal alloy, and a ceramic. The outer housing 414 may include shielding (e.g., bismuth shielding, lead shielding, etc.) configured and positioned to protect the radiation detector 410 from at least one of ambient radiation and other radiation not desired to be measured. The protective structure 416 may be configured and positioned to protect the radiation detector 410 from at least one of physical shock, humidity, and other background effects from the subterranean formation 400. For example, the protective structure 416 may comprise at least one shock absorbing structure (e.g., an elastomer structure, a spring, etc.) sized, shaped, and positioned relative to each of the outer housing 414 and the radiation detector 410 to at least substantially isolate the radiation detector 410 from vibrational shock that may otherwise damage and/or impair the radiation detector 410 during the use and operation of the subsurface waste characterization subsystem 108.

The radiation detector 410 may comprise any radiation detector configured and operated to detect the radioactivity of a least a portion of the subterranean formation 400 proximate thereto, and generate measurement data in response thereto. The radiation detector 204 may be configured and operated for the spectral analysis of a variety of different radiation emitters (e.g., radionuclides). The radiation detector 410 may, for example, be configured and operated to detect and measure at least one NORM and/or at least one TENORM, such as at least one of ³⁵⁵U, ²³⁸U, ²³²Th, ²²⁶Ra, ²²⁸Ra, ⁴⁰K, and daughter products of such radionuclides.

As a non-limiting example, and as shown in FIG. 4, in some embodiments the radiation detector 410 comprises a scintillation detector including at least one scintillator 418 and at least one sensor 420. The scintillator 418 may be operatively associated with (e.g., optically coupled to) the sensor 420 within the protective enclosure 412. The scintillator ⁴¹⁸ may be configured and operated to receive radiation from the volume of material 300 and convert the radiation into fluoresced radiation pulses. The scintillator 418 may be formed of and include any suitable scintillator material including, but not limited to, NaI(Tl), GSO, YAlO₃ (YAP), LuYAP, LaCl₃(Ce), LaBr₃(Ce), BGO, LuAG, YAG, LuAP, SrI₂, GAGG/GYGaGG, CeBr₃, GdI₂, LuI₂, ceramic scintillators, GPS, LPS, BaBrI, LuAG ceramic, LiCaF, CLYC, CLLB, and CLLC. In some embodiments, the scintillator 418 is formed of and includes NaI(Tl). The sensor 420 may comprise any device configured and operated to receive and quantify the fluoresced radiation pulses output by the scintillator 418. For example, the sensor 420 may comprise a photodetector formed of and including one or more devices (e.g., a photocathode, an electron detector, an amplifier, a pre-amplifier, a discriminator, an analog-to-digital signal convertor, etc.) for receiving the fluoresced radiation pulses from the scintillator 418 and converting the fluoresced radiation pulses into electrical pulses that may be registered as counts for radioactivity analysis. As another example, the radiation detector 410 may comprise a different radiation detection device (i.e., a device other than a scintillation detector), such as a semiconductor detector (e.g., a germanium detector, a CZT detector, a HgI detector, etc.), or a gas proportional counter (e.g., a xenon-proportional counter). For example, in additional embodiments, the radiation detector 410 comprises a germanium detector. The radiation detector 410 may exhibit a concentric configuration with a circumferential detection field, or may exhibit a stacked, or axial, configuration with a detection field at one axial end.

The radiation detector 410 may be configured to exhibit a surface area and volume permitting the radiation detector 204 to fit within the borehole 402 in the subterranean formation 400, and to detect radionuclides (e.g., ²³⁵U, ²³⁸U, ²³²Th, ²²⁶Ra, ²²⁸Ra, ⁴⁰K, daughter products of such radionuclides, etc.) within regions of the subterranean formation 400 adjacent the borehole 402 (e.g., regions of the subterranean formation 400 up to about 3.0 ft from a surface of the borehole 402). For example, the surface area of the radiation detector 410 may be within a range of from about 0.25 ft² to about 0.75 ft², or from about 0.3 ft² to about 0.5 ft². In some embodiments, the radiation detector 204 is within a range of from about 6.0 inches to about 1.0 foot long by about 1 inch in diameter. The radiation detector 410 may be configured and operated to scan a region of the subterranean formation 400 and relatively rapidly quantify (e.g., in less than or equal to about 30 seconds) radionuclides present within the region of the subterranean formation 400.

In some embodiments, the radiation detection assembly 406 comprises at least one of the radiation detector assemblies described in U.S. Pat. Nos. 8,009,787; 8,031,825; 8,260,566; and 8,274,056, and U.S. Patent Application Publication Nos. 2009/0218489 and 2014/0001365, the disclosure of each of which was previously incorporated herein in its entirety by this reference.

The detector positioning assembly 408 may exhibit any configuration sufficient to couple to and carry the radiation detection assembly 406, and facilitating desired positioning and orientation of the radiation detection assembly 406 relative to the subterranean formation 400 during use and operation of the subsurface waste characterization subsystem 108. For example, the detector positioning assembly 408 may include at least one device (e.g., winch device, reel device, etc.) configured and operated to reversibly longitudinally (e.g., vertically) move and position the radiation detection assembly 406. Accordingly, the detector positioning assembly 408 may be used (e.g., by way of computer numerical control and/or manual control) to longitudinally position the radiation detection assembly 406 within at least one of the cone penetrometer assembly 404 and the borehole 402 during use and operation of the subsurface waste characterization subsystem 108. As shown in FIG. 4, in some embodiments, the detector positioning assembly 408 may be carried by (e.g., mounted on) a mobile unit 422 (e.g., an automobile, such as a truck).

With continued reference to FIG. 4, the subsurface waste characterization subsystem 108 may, optionally, also include a position locating device 428, such as a global positioning system (GPS) device. The position locating device 428 may be configured and operated to associate collected measurement data with particular lateral locations across subterranean formation 400, which may be utilized in conjunction with other data (e.g., other measurement data, and other location data) acquired during additional subsurface waste characterization operations (e.g., use of the subsurface waste characterization subsystem 108 at other lateral locations across the subterranean formation 400) to create a three-dimensional model (e.g., map) of the subterranean formation 400. The three-dimensional model of the subterranean formation 400 may show the distribution of radioactive material throughout longitudinal and lateral dimensions of the subterranean formation 400, as described in further detail below.

The subsurface waste characterization subsystem 108 may, optionally, also include at least one temperature control assembly 424. The temperature control assembly 424 may be configured and operated to provide cooling and/or heating to one or more components of the radiation detection assembly 406. For example, the temperature control assembly 424 may be configured and operated to transfer (e.g., through one or more lines) at least one of cooling fluid and heating fluid to and from the radiation detection assembly 406. Various types of radiation detectors (e.g., semiconductor detectors, such as germanium detectors), which may be included in radiation detection assembly 406, may achieve enhanced performance (e.g., better resolution, more accuracy, etc.) during detection operations when sufficiently cooled. In some embodiments, the temperature control assembly 424 includes at least one cooling device (e.g., a compressor) configured and operated to cool fluid to a suitable temperature for efficient operation of the radiation detector 410. In additional embodiments, the temperature control assembly 424 delivers at least one fluid having an already sufficiently chilled temperature (e.g., liquid nitrogen) to and from the radiation detection assembly 406. If present, the temperature control assembly 424 may be controlled by way of computer numerical control. In some embodiments, the temperature control assembly 424 comprises at least one of the temperature control assemblies described in U.S. Pat. No. 8,260,566 and U.S. Patent Application Publication No. 2009/0218489, the disclosure of each of which was previously incorporated herein in its entirety by this reference. The main computer/electronics assembly 102 (FIG. 1) of the waste screening system 100 (FIG. 1) may also utilize control logic functions to automatically change operational parameters of one or more components of the subsurface waste characterization subsystem 108, such as amplifier gain of the radiation detector 410, to account for changes in temperature (e.g., temperature increases, temperature decreases) and/or other environmental conditions.

The subsurface waste characterization subsystem 108 may, optionally, also include at least one supplemental computer/electronics assembly 426. The supplemental computer/electronics assembly 426 may be configured and operated to control one or more other components of the subsurface waste characterization subsystem 108 (e.g., the detector positioning assembly 408, the radiation detector 410, the temperature control assembly 424, etc.). If present, the supplemental computer/electronics assembly 426 may also include devices (e.g., multichannel analyzers, analog-to-digital converters, pulse counters, amplifiers, etc.) for receiving and analyzing data from other components of the subsurface waste characterization subsystem 108 (e.g., the radiation detector 410, the temperature control assembly 424, etc.). The supplemental computer/electronics assembly 426 may, optionally, utilize control logic similar to that previously described in relation to the main computer/electronics assembly 102 (FIG. 1) of the radioactive waste screening system 100 (FIG. 1) to automatically monitor and automatically control various components of the subsurface waste characterization subsystem 108, and/or to automatically analyze and automatically correct measurement data received from the various components of the subsurface waste characterization subsystem 108. In addition, the supplemental computer/electronics assembly 426 may be configured and operated to communicate with the main computer/electronics assembly 102 (FIG. 1) of the radioactive waste screening system 100 (FIG. 1). For example, the supplemental computer/electronics assembly 426 may include one or more input devices configured to receive information (e.g., operational commands) from the main computer/electronics assembly 102, and one or more output devices configured to transmit other information (e.g., measurement data) to the main computer/electronics assembly 102. The supplemental computer/electronics assembly 426 may further include storage media (e.g., hard drives, external hard drives, flash memory, RAM, ROM, DVDs, etc.) for storing information related to measurements (e.g., radiation measurements, etc.) and/or the status of components of the subsurface waste characterization subsystem 108. If present, the supplemental computer/electronics assembly 426 may be operatively associated with other components of the subsurface waste characterization subsystem 108 and the main computer/electronics assembly 102 (FIG. 1) through at least one of wired means (e.g., data cables) and wireless means (e.g., WiFi, Bluetooth, zigbee, etc.). In additional embodiments, the supplemental computer/electronics assembly 426 may be omitted, and the main computer/electronics assembly 102 may, itself, be utilized to perform one or more of the above described operations of the supplemental computer/electronics assembly 426.

It is noted that in FIG. 4, the various components of the subsurface waste characterization subsystem 108 (e.g., the radiation detection assembly 406, the detector positioning assembly 408, the mobile unit 422, the temperature control assembly 424, the supplemental computer/electronics assembly 426, etc.) are shown as being provided at particular locations relative to one another. However, the various components of the subsurface waste characterization subsystem 108 are shown in FIG. 4 at such particular locations for simplicity and not as a physical limitation. Thus, one or more of the various components of the subsurface waste characterization subsystem 108 may be provided at different locations relative to one another than those depicted in FIG. 4.

During operation of the subsurface waste characterization subsystem 108, at least one substantially hollow and elongated structure (e.g., at least one hollow tube) of the cone penetrometer assembly 404 may be driven or otherwise placed into the subterranean formation 400 to be tested. The radiation detector assembly 406 may be moved at to different longitudinal increments within the substantially hollow and elongated structure using the detector positioning assembly 408 to detect radiation in situ. Optionally, when radiation measurements are obtained, the substantially hollow and elongated structure may be removed from the subterranean formation 400 in order to provide more direct access to the subterranean formation 400. The subsurface waste characterization subsystem 108 may provide radioactivity counts and may estimate radionuclide activity for different regions of the subterranean formation 400. The estimated radionuclide activity may be the basis for classifying the different regions of the subterranean formation 400 as non-radioactive waste (e.g., material exhibiting less than 5 picoCurie per gram (pCi/g) of activity), intermediate level radioactive waste (e.g., material exhibiting between 5 pCi/g and 30 pCi/g of activity), or high level radioactive waste (e.g., material exhibiting greater than 30 pCi/g of activity). The estimated radionuclide activity may include uncertainty data (e.g., random and systematic). The subsurface waste characterization subsystem 108 may be used to provide a three-dimensional model of the distribution, quantities, and activities of radioactive material within the subterranean formation 400. Based on the results of the radioactivity detection (e.g., by way of the radiation detector 410) and analysis (e.g., by way of the supplemental computer/electronics assembly 426 and/or the main computer/electronics assembly 102), one or more regions of the subterranean formation 400 may be segregated (e.g., for disposal at a facility that accepts radioactive waste exhibiting such radiation levels), disposed of, and/or remediated as deemed appropriate. In some embodiments, the subsurface waste characterization subsystem 108 may be used to determine whether or not radioactive material has migrated beyond pre-established boundaries (e.g., waste pit boundaries) within the subterranean formation 400, prompting remedial action. Details as to the processes used for the above radioactivity analysis of the subterranean formation 400 are described in further detail below.

While various embodiments herein describe or illustrate the subsurface waste characterization subsystem 108 as being used to characterize the radioactivity of the subterranean formation 400, the subsurface waste characterization subsystem 108 may, alternatively, be used to characterize the radioactivity of other environments (e.g., water, air, etc.). By way of non-limiting example, in some embodiments, the radiation detection assembly 410 may be provided (e.g., within a substantially hollow and elongated structure, and/or directly) into a water environment. In addition, for each test environment (e.g., soil, water, air, etc.), a plurality of radiation detection assemblies 406 may, optionally, be utilized in spaced relationship to obtain a more widespread characterization (e.g., profile) of the test environment. The plurality of radiation detection assemblies 406 may be spaced from one another within a single substantially hollow and elongated structure, may be spaced from one another in separate substantially hollow and elongated structures, and/or may be spaced from one another by way of other placement arrangements within the test environment. The spacing between the plurality of radiation detection assemblies 406 may be substantially uniform, or may be at least partially non-uniform.

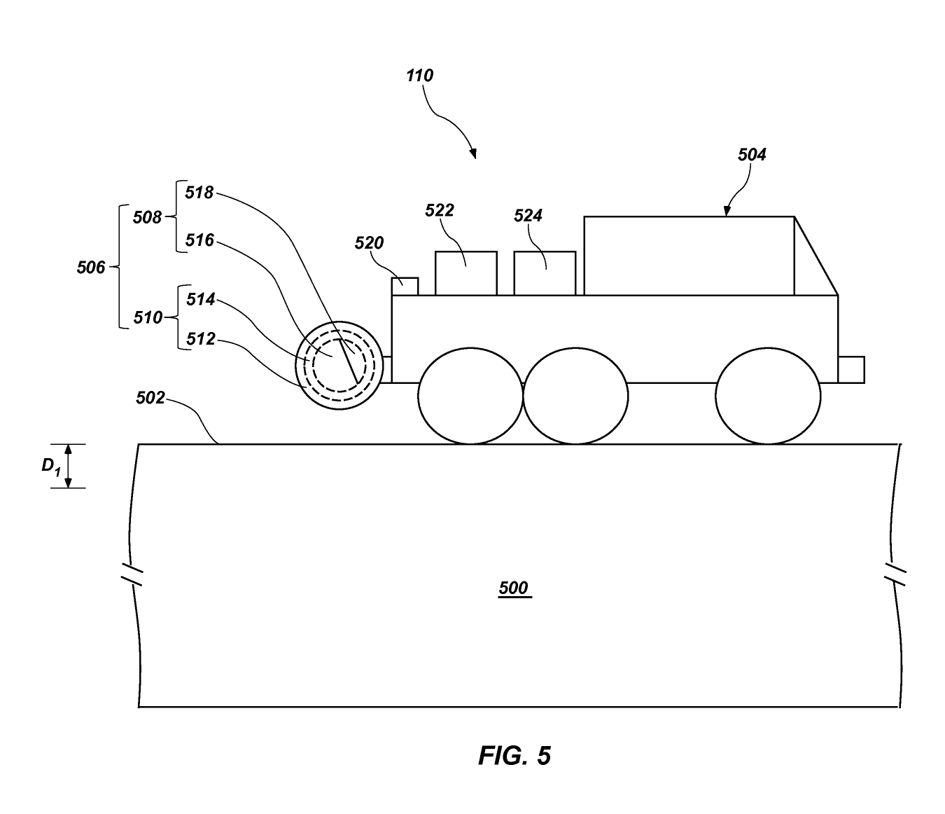

FIG. 5 is a schematic of the surface waste characterization subsystem 110 in accordance with embodiments of the disclosure. The surface waste characterization subsystem 110 may be configured and operated to characterize (e.g., profile) the radioactivity of surface regions of an earthen formation 500. The earthen formation 500 may, for example, comprise soil of a field environment at or proximate a site (e.g., a well site, a waste disposal site, a nuclear reactor site, a nuclear waste processing site, a medical facility, etc.) where radioactive contamination may be present. The radioactive contamination may, for example, be present at or proximate the site due to a spill (e.g., an accidental spill, an intentional spill, etc.) of a potentially radioactive material at or proximate the site. The surface waste characterization subsystem 110 may be utilized to determine the distribution and radioactivity of radioactive material across a surface 502 of the earthen formation 500 and to a selected depth D₁ (e.g., up to about 1.5 feet) from the surface 502 of the earthen formation 500.

The surface waste characterization subsystem 110 may include at least one mobile unit 504, and at least one radiation detection assembly 506. The radiation detection assembly 506 may be removably secured (e.g., coupled, mounted, attached, etc.) to the mobile unit 504 in at least one position and at least one orientation relative to the surface 502 of the earthen formation 500, as described in further detail below. Optionally, the surface waste characterization subsystem 110 may also include at least one of a position locating device 520, a temperature control assembly 522, and a supplemental computer/electronics assembly 524, as also described in further detail below.

The mobile unit 504 may comprise any automotive vehicle (e.g., truck, car, bus, cart, sports utility vehicle (SUV), remote controlled device, etc.) configured and operated to traverse the surface 502 of the earthen formation 500 at a desired rate (e.g., velocity, speed, etc.). The desired rate may be at least partially determined by the radiation detection properties (e.g., characteristics, capabilities, etc.) of the radiation detection assembly 506, as described in further detail below. For example, depending on the radiation detection properties of the radiation detection assembly 506, the mobile unit 504 may be configured and operated to traverse the surface 502 of the earthen formation 500 at one or more rates greater than or equal to about one (1) mile per hour (mph), such as greater than or equal to about two (2) mph, or greater than or to about three (3) mph. In some embodiments, the mobile unit 504 is configured and operated to traverse the surface 502 of the earthen formation 500 at one or more rates within a range of from about 2 mph to about 3 mph.

The radiation detection assembly 506 may include a radiation detector 508, and at least one protective enclosure 510. The protective enclosure 510 may at least partially surround (e.g., envelop, encase, etc.) the radiation detector 508. In addition, the radiation detection assembly 506 may, optionally, include at least one collimator configured and positioned to focus a field of view of the radiation detector 508.

The protective enclosure 510 may include an outer housing 512 and at least one protective structure 514 disposed between the outer housing 512 and the radiation detector 508. The outer housing 512 may comprise a substantially rigid, hollow, and elongated structure configured to permit at least some radiation (e.g., gamma rays) to pass therethrough. In some embodiments, the outer housing 512 comprises a hollow tube formed of and including at least one of a metal (e.g., aluminum, magnesium, titanium, cobalt, chrome, molybdenum, bismuth, lead, steel, nickel), a metal alloy, and a ceramic. The outer housing 414 may include shielding (e.g., bismuth shielding, lead shielding, etc.) configured and positioned to protect the radiation detector 410 from at least one of ambient radiation and other radiation that is not desired to be measured. The protective structure 514 may be configured and positioned to protect the radiation detector 508 from at least one of physical shock and humidity. For example, the protective structure 514 may comprise at least one shock absorbing structure (e.g., an elastomer structure, a spring, etc.) sized, shaped, and positioned relative to each of the outer housing 512 and the radiation detector 508 to at least substantially isolate the radiation detector 508 from vibrational shock that may otherwise damage and/or impair the radiation detector 508 during the use and operation of the surface waste characterization subsystem 110.

The radiation detector 508 may comprise any radiation detector configured and operated to detect the radioactivity of a region of the earthen formation 500 proximate thereto to a desired depth D₁ from the surface 502 of the earthen formation 500 at the one or more rates at which the mobile unit 504 traverses the surface 502 of the earthen formation 500, and to generate measurement data in response thereto. The radiation detector 508 may, for example, be configured and operable to detect the radioactivity of different surface regions of the earthen formation 500 at a rate greater than or equal to about 1 mph, such as greater than or equal to about 2 mph, or greater than or to about 3 mph In some embodiments, the radiation detector 508 is configured and operated to detect the radioactivity of different surface regions of the earthen formation 500 at a rate within a range of from about 2 mph to about 3 mph. The radiation detector 508 may be configured and operated for the spectral analysis of a variety of different radiation emitters (e.g., radionuclides). The radiation detector 508 may, for example, be configured and operated to detect, quantify, and report at least one naturally occurring radioactive material, such as at least one of ²³⁵U, ²³⁸U, ²³²Th, ²²⁶Ra, ²²⁸Ra, ⁴⁰K, and daughter products of such radionuclides.

As a non-limiting example, and as shown in FIG. 5, in some embodiments the radiation detector 508 comprises a scintillation detector including at least one scintillator 516 and at least one sensor 518. The scintillator 516 may be operatively associated with (e.g., optically coupled to) the sensor 518 within the protective enclosure 510. The scintillator 516 may be configured and operated to receive radiation from the volume of material 300 and convert the radiation into fluoresced radiation pulses. The scintillator 516 may be formed of and include any suitable scintillator material including, but not limited to, NaI(Tl), GSO, YAlO₃ (YAP), LuYAP, LaCl₃(Ce), LaBr₃(Ce), BGO, LuAG, YAG, LuAP, SrI₂, GAGG/GYGaGG, CeBr₃, GdI₂, LuI₂, ceramic scintillators, GPS, LPS, BaBrI, LuAG ceramic, LiCaF, CLYC, CLLB, and CLLC. In some embodiments, the scintillator 516 is formed of and includes NaI(Tl). The sensor 518 may comprise any device configured and operated to receive and quantify the fluoresced radiation pulses output by the scintillator 516. For example, the sensor 518 may comprise a photodetector formed of and including one or more devices (e.g., a photocathode, an electron detector, an amplifier, a pre-amplifier, a discriminator, an analog-to-digital signal convertor, etc.) for receiving the fluoresced radiation pulses from the scintillator 516 and converting the fluoresced radiation pulses into electrical pulses that may be registered as counts for radioactivity analysis. As another example, the radiation detector 508 may comprise a different radiation detection device (i.e., a device other than a scintillation detector), such as a semiconductor detector (e.g., a germanium detector, a CZT detector, a HgI detector, etc.), or a gas proportional counter (e.g., a xenon-proportional counter). For example, in additional embodiments, the radiation detector 508 comprises a germanium detector. The radiation detector 508 may exhibit a concentric configuration with a circumferential detection field, or may exhibit a stacked, or axial, configuration with a detection field at one axial end.

The radiation detector 508 may be configured to exhibit a surface area and volume permitting the radiation detector 508 to detect radionuclides (e.g., ²³⁵U, ²³⁸U, ²³²Th, ²²⁶Ra, ²²⁸Ra, ⁴⁰K, daughter products of such radionuclides, etc.) over a relatively large area of the earthen formation 500 at the rate that the radiation detector 508 is moved past the earthen formation 500 by the mobile unit 504. For example, the surface area of the radiation detector 508 may be within a range of from about 3.0 ft² to about 5.0 ft², or from about 3.5 ft² to about 4.0 ft². In some embodiments, the radiation detector 508 is about 2 ft long by about 0.5 ft in diameter. The radiation detector 508 may be configured and operated to scan a relatively large surface region of the earthen formation 500 and relatively rapidly quantify (e.g., in less than or equal to about 30 seconds) radionuclides present within the relatively large surface region of the earthen formation 500.

In some embodiments, the radiation detection assembly 506 comprises at least one of the radiation detector assemblies described in U.S. Pat. Nos. 8,009,787; 8,031,825; 8,260,566; and 8,274,056, and U.S. Patent Application Publication Nos. 2009/0218489 and 2014/0001365, the disclosure of each of which was previously incorporated herein in its entirety by this reference.

The radiation detection assembly 506 may be removably secured (e.g., directly secured, indirectly secured, etc.) to the mobile unit 504 by any means, at any position, and at any orientation sufficient to facilitate the detection and measurement of radioactive material on (e.g., on the surface 502) and/or within (e.g., to the selected depth D₁ from the surface 502) the earthen formation 500. By way of non-limiting example, and as shown in FIG. 5, the radiation detection assembly 506 may be removably mounted to the rear-end (e.g., back) of the mobile unit 504 such that the radiation detector 508 of the radiation detection assembly 506 is positioned proximate (e.g., within 2 feet of, such as within 1 foot of, or within 6 inches of) the surface 502 of the earthen formation 500. In additional embodiments, the radiation detection assembly 506 may be removably mounted to a different portion of the mobile unit 504, such as to a front-end (e.g., front) of the mobile unit 504, so long as the radiation detector 508 is positioned proximate the surface 502 of the earthen formation 500.

With continued reference to FIG. 5, the surface waste characterization subsystem 110 may, optionally, also include a position locating device 520, such as a global positioning system (GPS) device. The position locating device 520 may be configured and operated to associate collected radioactivity data with particular locations across the surface 502 of the earthen formation 500, which may be utilized to form a model (e.g., map) of the surface 502 of the earthen formation 500 showing the distribution, quantities, and activities of radioactive material across the surface 502 of the earthen formation 500.

The surface waste characterization subsystem 110 may, optionally, also include at least one temperature control assembly 522. The temperature control assembly 522 may be configured and operated to provide cooling and/or heating to one or more components of the radiation detection assembly 506. For example, the temperature control assembly 522 may be configured and operated to transfer (e.g., through one or more lines) at least one of cooling fluid and heating fluid to and from the radiation detection assembly 506. Various types of radiation detectors (e.g., semiconductor detectors, such as germanium detectors), which may be included in radiation detection assembly 506, may achieve enhanced performance (e.g., better resolution, more accuracy, etc.) during detection operations when sufficiently cooled. In some embodiments, the temperature control assembly 522 includes at least one cooling device (e.g., a compressor) configured and operated to cool fluid to a suitable temperature for efficient operation of the radiation detector 508. In additional embodiments, the temperature control assembly 522 delivers at least one fluid having an already sufficiently chilled temperature (e.g., liquid nitrogen) to and from the radiation detection assembly 506. If present, the temperature control assembly 522 may be controlled by way of computer numerical control. In some embodiments, the temperature control assembly 522 comprises at least one of the temperature control assemblies described in U.S. Pat. No. 8,260,566 and U.S. Patent Application Publication No. 2009/0218489, the disclosure of each of which was previously incorporated herein in its entirety by this reference. The main computer/electronics assembly 102 (FIG. 1) of the waste screening system 100 (FIG. 1) may also utilize control logic functions to automatically change operational parameters of one or more components of the surface waste characterization subsystem 110, such as amplifier gain of the radiation detector 508, to account for changes in temperature (e.g., temperature increases, temperature decreases) and/or other environmental conditions.

The surface waste characterization subsystem 110 may, optionally, also include at least one supplemental computer/electronics assembly 524. The supplemental computer/electronics assembly 524 may be configured and operated to control one or more other components of the surface waste characterization subsystem 110 (e.g., the mobile unit 504, the radiation detector 508, the position locating device 520, the temperature control assembly 522, etc.). If present, the supplemental computer/electronics assembly 524 may also include devices (e.g., multichannel analyzers, analog-to-digital converters, pulse counters, amplifiers, etc.) for receiving and analyzing data from other components of the surface waste characterization subsystem 110 (e.g., the mobile unit 504, the radiation detector 508, the position locating device 520, the temperature control assembly 522, etc.). The supplemental computer/electronics assembly 524 may, optionally, utilize control logic similar to that previously described in relation to the main computer/electronics assembly 102 (FIG. 1) of the radioactive waste screening system 100 (FIG. 1) to automatically monitor and automatically control various components of the surface waste characterization subsystem 110, and/or to automatically analyze and automatically correct measurement data received from the various components of the surface waste characterization subsystem 110. In addition, the supplemental computer/electronics assembly 524 may be configured and operated to communicate with the main computer/electronics assembly 102 (FIG. 1) of the radioactive waste screening system 100 (FIG. 1). For example, the supplemental computer/electronics assembly 524 may include one or more input devices configured to receive information (e.g., operational commands) from the main computer/electronics assembly 102, and one or more output devices configured to transmit other information (e.g., radiation measurement data) to the main computer/electronics assembly 102. The supplemental computer/electronics assembly 524 may further include storage media (e.g., hard drives, external hard drives, flash memory, RAM, ROM, DVDs, etc.) for storing information related to measurements (e.g., rate measurements, location coordinates, radiation measurements, etc.) and/or the status of components of the surface waste characterization subsystem 110. If present, the supplemental computer/electronics assembly 524 may be operatively associated with other components of the surface waste characterization subsystem 110 and the main computer/electronics assembly 102 (FIG. 1) through at least one of wired means (e.g., data cables) and wireless means (e.g., WiFi, Bluetooth, zigbee, etc.). In additional embodiments, the supplemental computer/electronics assembly 524 may be omitted, and the main computer/electronics assembly 102 may, itself, be utilized to perform one or more of the above described operations of the supplemental computer/electronics assembly 524.

It is noted that in FIG. 5, the various components of the surface waste characterization subsystem 110 (e.g., the radiation detection assembly 506, the position locating device 520, the temperature control assembly 522, the supplemental computer/electronics assembly 524, etc.) are shown as being provided at particular locations relative to one another. However, the various components of the subsurface waste characterization subsystem 108 are shown in FIG. 5 at such particular locations for simplicity and not as a physical limitation. Thus, one or more of the various components of the surface waste characterization subsystem 110 may be provided at different locations relative to one another than those depicted in FIG. 5.

During operation of the surface waste characterization subsystem 110, the mobile unit 504 may traverse the surface 502 of the earthen formation 500 to be tested. As the mobile unit 504 moves over the surface 502 of the earthen formation 500 the radiation detection assembly 506 secured thereto detects radiation in situ. The surface waste characterization subsystem 110 may provide radioactivity counts and may estimate radionuclide activity for different regions across the surface 502 of the earthen formation 500. The estimated radionuclide activity may be the basis for classifying the different surface regions of the earthen formation 500 as non-radioactive waste (e.g., material exhibiting less than 5 pCi/g of activity), intermediate level radioactive waste (e.g., material exhibiting between 5 pCi/g and 30 pCi/g of activity), or high level radioactive waste (e.g., material exhibiting greater than 30 pCi/g of activity). The estimated radionuclide activity may include uncertainty data (e.g., random and systematic). The surface waste characterization subsystem 110 may be used to form a map of the distribution, quantities, and activities of radioactive material on the surface 502 of the earthen formation 500 and to a selected depth D₁ from the surface 502 of the earthen formation 500. Based on the results of the radioactivity detection (e.g., by way of the radiation detector 508) and analysis (e.g., by way of the supplemental computer/electronics assembly 524 and/or the main computer/electronics assembly 102), one or more regions of the earthen formation 500 may be segregated (e.g., for disposal at a facility that accepts radioactive waste exhibiting such radiation levels), disposed of, and/or remediated as deemed appropriate. In some embodiments, the surface waste characterization subsystem 110 may be used to determine whether or not high level radioactive waste has been distributed around site (e.g., a well site, a waste disposal site, a nuclear reactor site, a nuclear waste processing site, a medical facility, etc.) as a result of a spill. Details as to the processes used for the above radioactivity analysis of the earthen formation 500 are described in further detail below.

While various embodiments herein describe or illustrate the surface waste characterization subsystem 110 as being used to characterize the radioactivity of the earthen formation 500, the surface waste characterization subsystem ¹¹⁰ may, alternatively, be used to characterize the radioactivity other environments (e.g., water, air, etc.). By way of non-limiting example, in some embodiments, the radiation detection assembly 506 may be moved across a water environment by a mobile unit 504 configured to traverse the water environment. In addition, for each test environment (e.g., soil, water, air, etc.), a plurality of radiation detection assemblies 506 may, optionally, be utilized in spaced relationship to obtain a more widespread characterization (e.g., profile) of the test environment. The plurality of radiation detection assemblies 506 may, for example, be spaced from one another on a single mobile unit 504, and/or may be spaced from one another on separate mobile units 504. The spacing between the plurality of plurality of radiation detection assemblies 506 may be substantially uniform, or may be at least partially non-uniform.

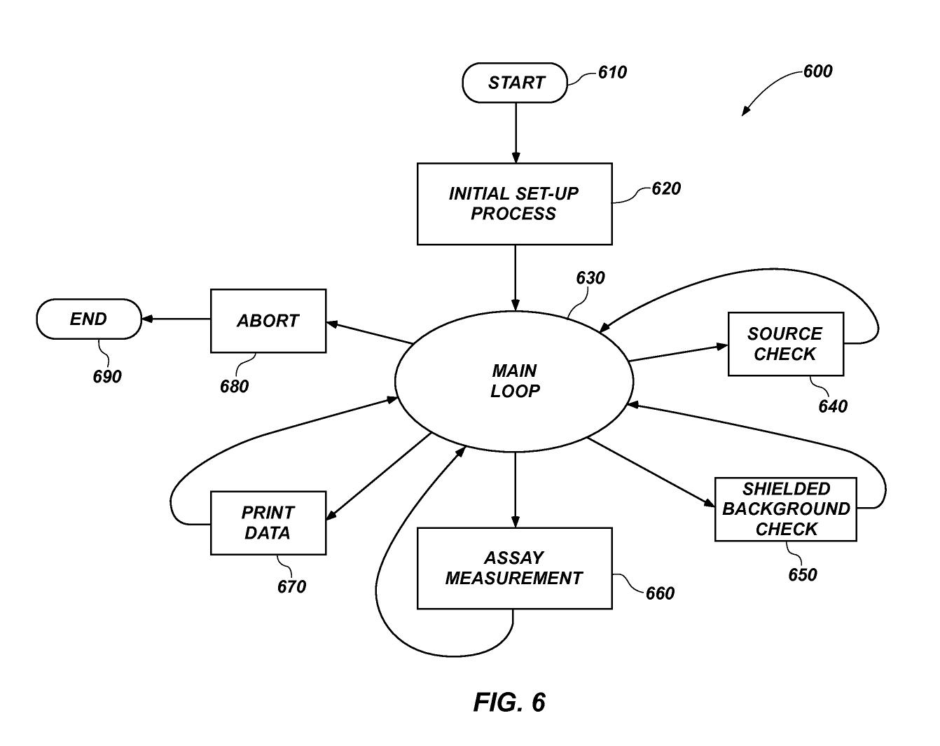

FIG. 6 is a hierarchical view of processes 600 for operating a radioactive waste screening system (e.g., the radioactive waste screening system 100 shown in FIG. 1), including the various subsystems thereof (e.g., the packaged waste screening subsystem 104, the volume waste screening subsystem 106, the subsurface waste characterization subsystem 108, and the surface waste characterization subsystem 110 shown in FIGS. 2-5), according to embodiments of the disclosure. The processes 600 may be initiated by radioactive waste screening system software being launched. For example, a radioactive waste screening system software icon may be located on the desktop of a computer (e.g., a computer of the main computer/electronics assembly 102 shown in FIG. 1). An operator may press the radioactive waste screening system software icon. The processes 600 for operating a radioactive waste screening system begin at operation 610, which initiates an initial set-up process 620. From the initial set-up process 620, a main loop 630 is entered. From the main loop 630, one or more functions may be performed. Performance of such functions may be initiated manually by an operator, automatically according to a minimum time interval between occurrences of certain events, automatically according to certain events being triggered (i.e., interrupted) during execution of the main loop 630, or any combination thereof. Many automated functions (e.g., operability verification, background checks, mass attenuation correction, etc.) are not visible to the operator during their performance.

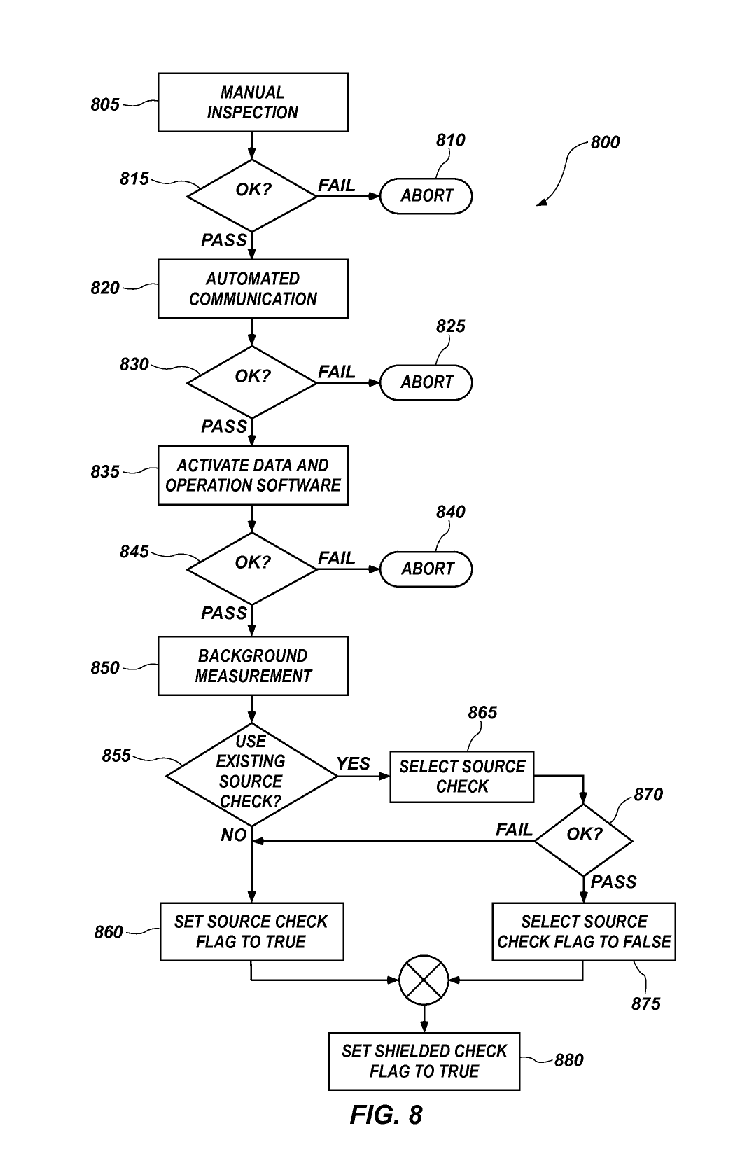

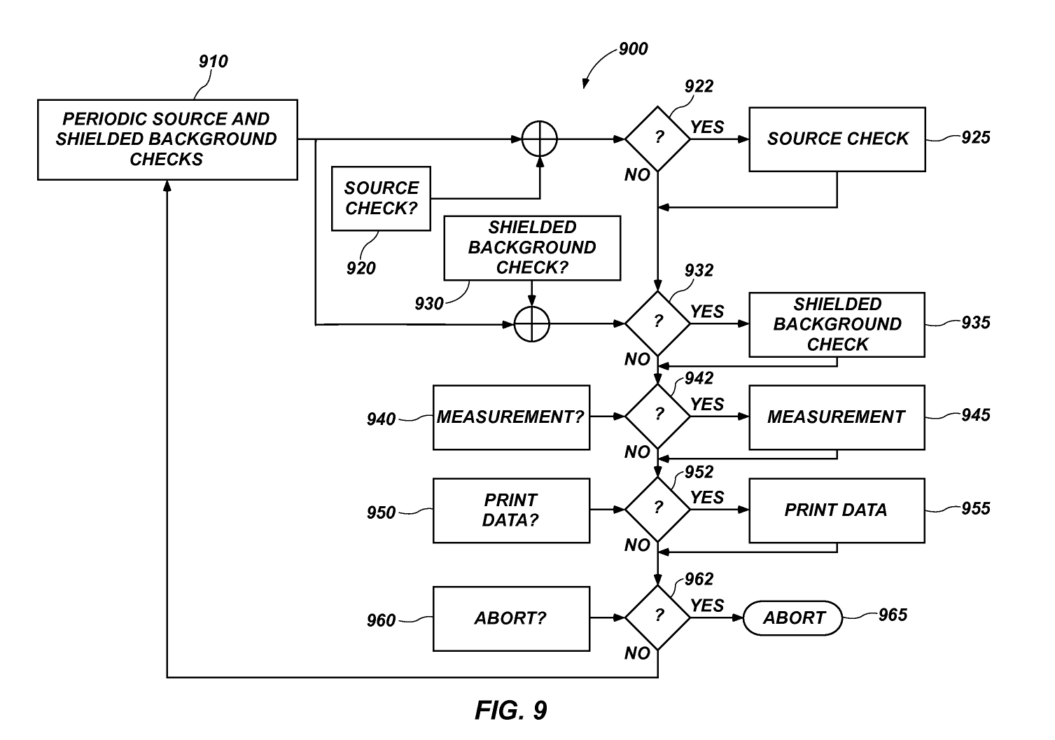

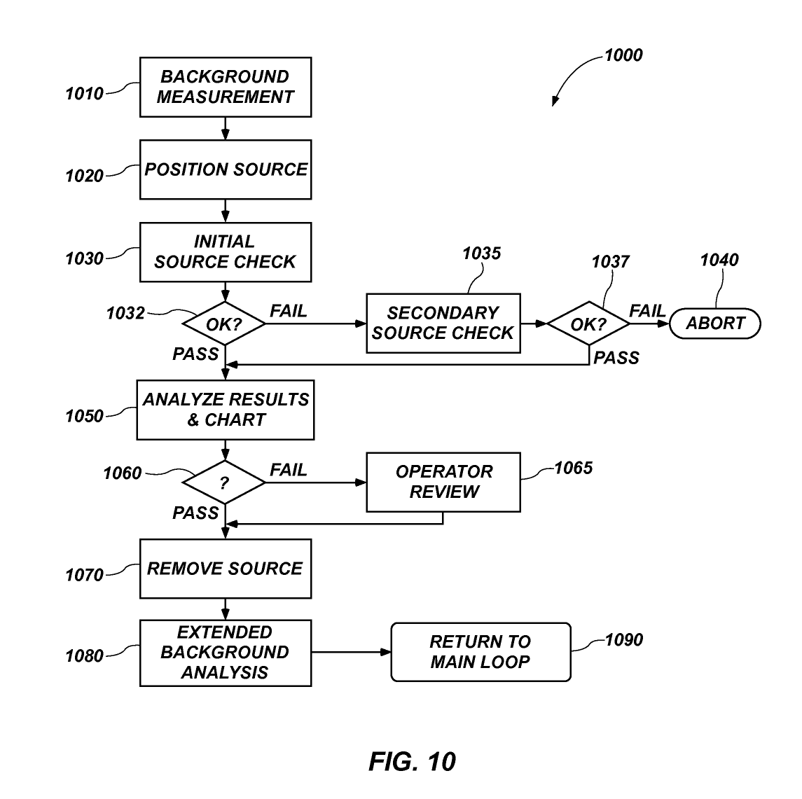

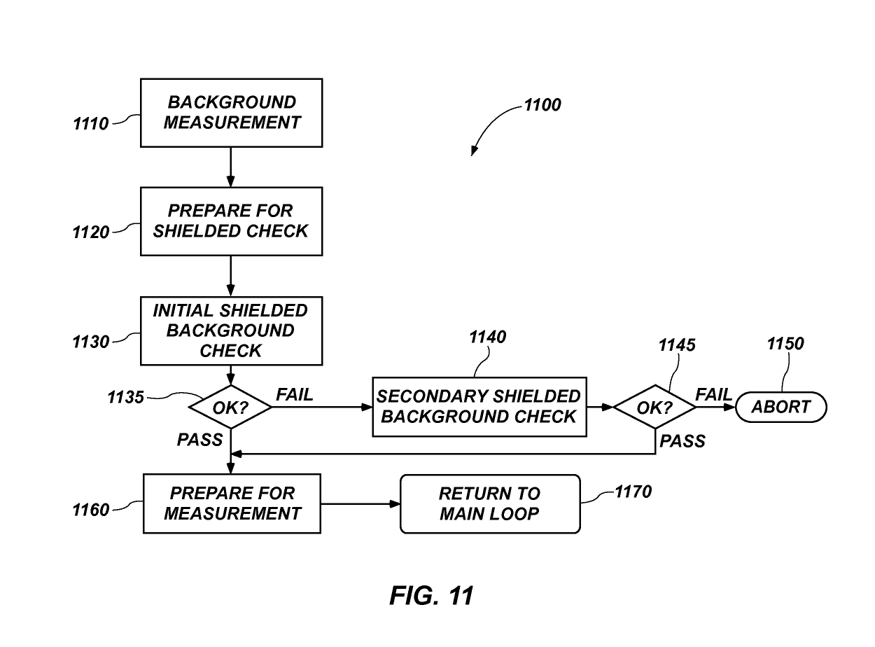

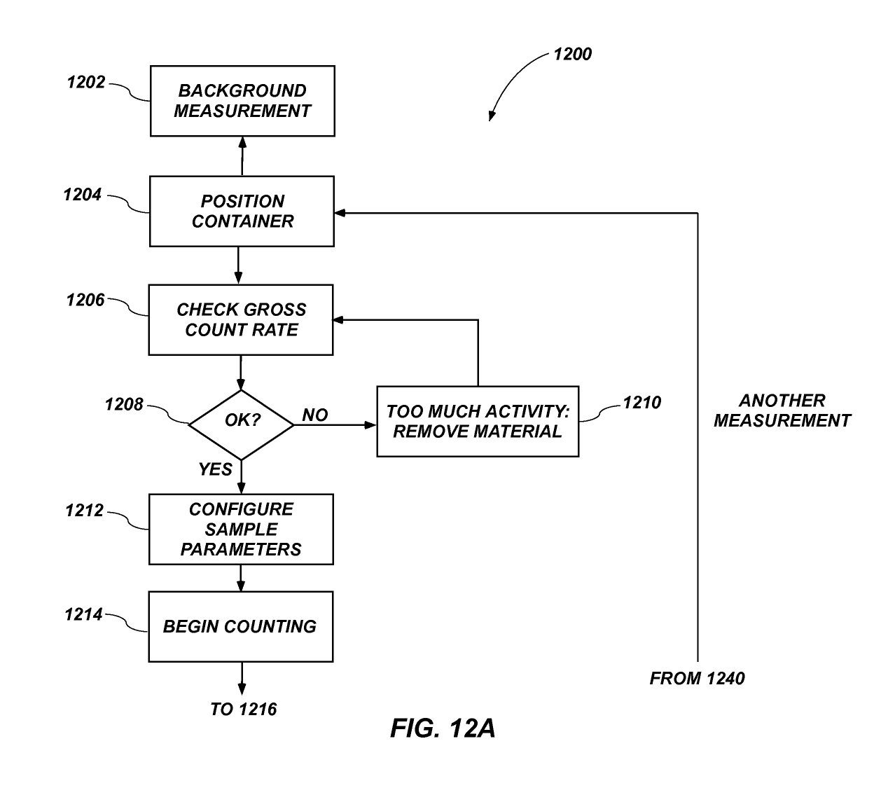

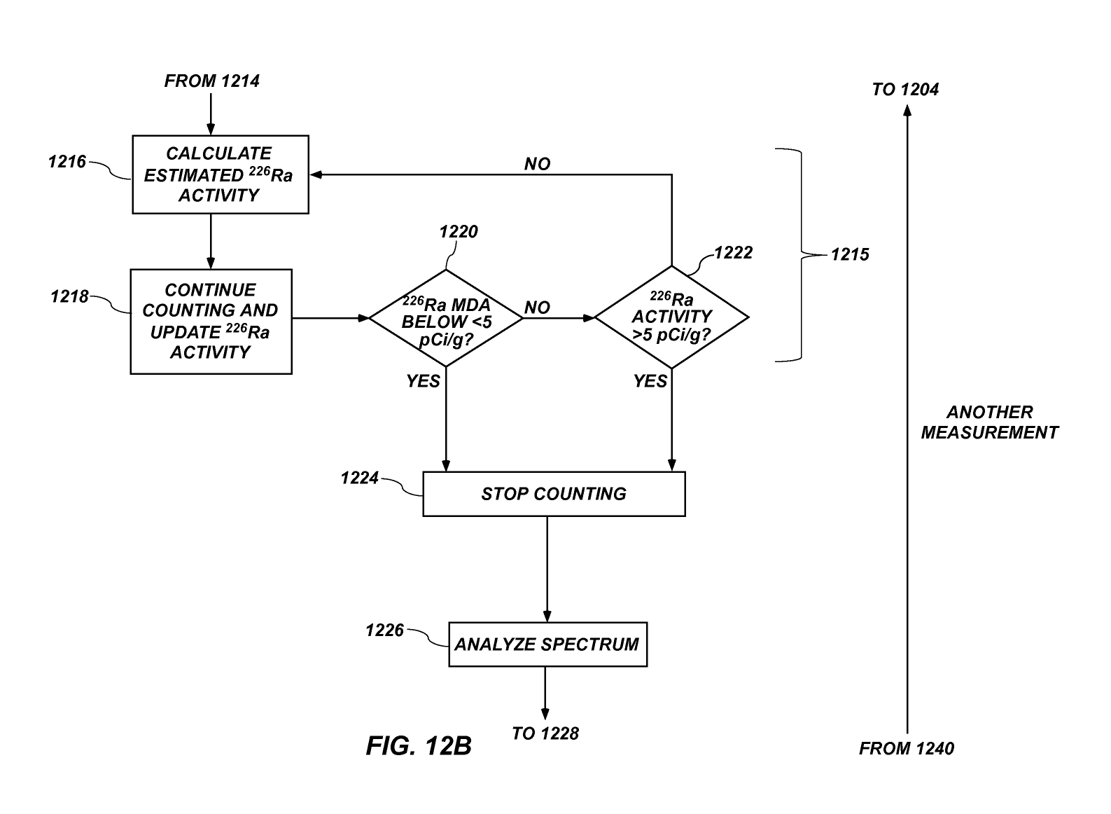

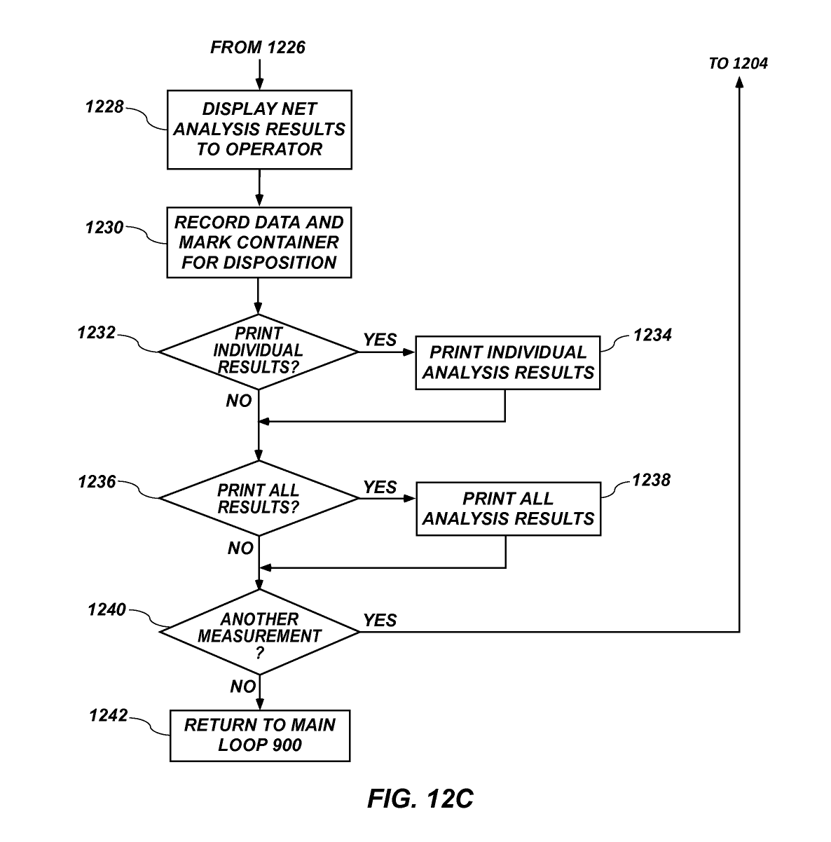

Examples of functions may include a source check function 640, shielded background check function 650, a measurement function 660, and a print data function 670. Each function may be called and executed, after which execution the main loop 630 may continue to execute. An abort function 680 may be called, which function terminates the main loop 630 and ends the program at operation 690. Other functions may likewise have features for termination of the program if certain situations occur or problems are detected. More or fewer functions may also exist in addition to, or in place of, certain functions shown herein. Further details regarding several of these functions are described below. For example, an example of an initial set-up process 620 is described with reference to FIG. 8. An example of a main loop 630 is described with reference to FIG. 9. An example of a source check function 640 is described with reference to FIG. 10. An example of a shielded background check function 650 is described with reference to FIG. 11. An example of a measurement function 660 for each of the different subsystems of the radioactive waste screening system 100 (FIG. 1) is described with reference to FIGS. 12A-15C. The various functions shown in FIG. 6 may be utilized to independently operate each of the subsystems (e.g., each of the packaged waste screening subsystem 104, the volume waste screening subsystem 106, the subsurface waste characterization subsystem 108, and the surface waste characterization subsystem 110) of the radioactive waste screening system 100 depicted in FIG. 1, with modifications to the details (e.g., parameters) of some of the functions depending on the particular subsystem being operated, as described in further detail below.

The radioactive waste screening system software may include a user interface for interaction with the operator. For example, the user interface may be a menu-driven graphical user interface (GUI) for ease of use and control by an operator. The user interface may perform functions automatically, through a virtual push-button interface on the computer screen, or through a combination thereof. The user interface may include pop-up windows that present options regarding system configuration or operating parameters the operator can choose from to customize radiation measurement. The user interface may also include pop-up windows that communicate advisory information and directions to the operator.

The processes 600, in addition to functions related to the processes described below, are to be viewed as examples of processes and functions that may be provided by a radioactive waste screening system. Other functions may be provided, in addition to, or in the place of the processes and functions described herein. Before moving on to describing individual functions that may be performed, it may be useful to first describe a background measurement function, which may be a common sub-function to many of the individual functions described herein.

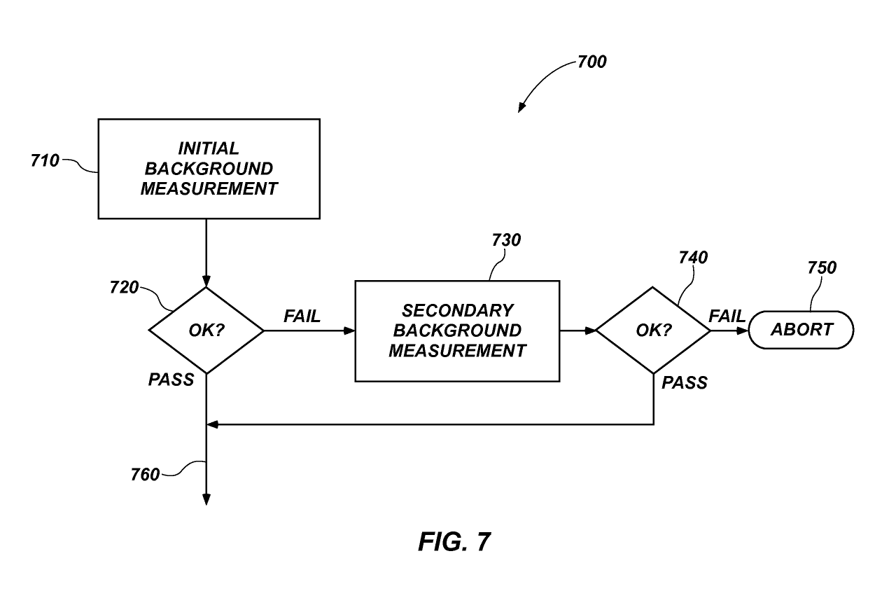

FIG. 7 is a flowchart representing a background measurement 700 function for the subsystems (e.g., the packaged waste screening subsystem 104, the volume waste screening subsystem 106, the subsurface waste characterization subsystem 108, and the surface waste characterization subsystem 110 shown in FIGS. 2-5) of the radioactive waste screening system 100 (FIG. 1), according to embodiments of the disclosure. The background measurement 700 function may determine the background for each gamma ray line used. The gamma ray data may be used to subtract background effects from measurement results during actual measurements for each gamma ray line. Background measurement 700 may be performed at various times in various functions during the different modes of analysis and operation. For example, background measurements may be performed during an initial start-up process (FIG. 8), during a source check function (FIG. 10), during a shielded background check function (FIG. 11), and/or during a measurement function (FIGS. 12A-12C, 13A-13C, 14A-14C, and/or 15A-15C). As such, a detailed example of a background measurement is not repeated for each of the above functions, but given with reference to the various operations, which may occur as shown in FIG. 7.

At operation 710, an initial background measurement is performed. The initial background measurement at operation 710 may include a gross background count of the area surrounding a particular subsystem of the radioactive waste screening system 100 (FIG. 1), which may be result in background detected by a radiation detector (e.g., a radiation detector 204, 304, 410, 508) of the particular subsystem. Such an initial background measurement may ensure that substantial changes have not occurred in the area surrounding the particular subsystem of the radioactive waste screening system 100 over a relatively short period of time. The initial background measurement at operation 710 may improve safety for human operators of the particular subsystem of the radioactive waste screening system 100, as well as improve accuracy of the radiation measurements. Initial background measurements from operation 710 may be a gross gamma radiation measurement of the background and may not necessarily monitor specific energy lines. However, initial background measurements from operation 710 may also monitor count rate on one or more specific energy lines from a range of radionuclides (e.g., ²³⁵U, ²³⁸U, ²³²Th, ²²⁶Ra, ²²⁸Ra, ⁴⁰K, daughter products of such radionuclides, etc.) to create a control chart to track the contamination of the background over time. A control chart may include historical data, which may assist an operator in assessing changes in subsystem performance over time. Upper and lower contamination bounds may be included in the control chart and may be utilized to automatically inform the operator whether the particular subsystem is operating within acceptable parameters.

As described herein, source checks and shielded background checks may also generate similar control charts. The control charts may be stored in one or more files (e.g., ASCII text file), which may be used to graphically construct the history of the radiation detector (e.g., the radiation detector 204, 304, 410, 508) of a subsystem of the radioactive waste screening system 100 with respect to background spectra, source check spectra, and shielded background spectra. The source control chart files have different content compared to the background and shielded background control chart files. The background control chart may include count rate data from a relatively small sampling of radionuclides, including ²³⁵U, ²³⁸U, ²³²Th, ²²⁶Ra, ²²⁸Ra, ⁴⁰K, and daughter products of such radionuclides.

At operation 720, if the initial background measurement from operation 710 is acceptable (i.e., changes in the background radiation is within an acceptable limit), the background measurement 700 passes and moves on to whatever operation is next. Line 760 is left open-ended as a further operation may be highly variable depending on the overall function that background measurement 600 is a part of.

If the initial background measurement from operation 710 fails at operation 720 (i.e., changes in the background radiation is not within an acceptable limit), the initial background measurement from operation 710 fails and moves onto a secondary background measurement at operation 730. Secondary background measurement at operation 730 may be substantially similar in purpose and function as initial background measurement of operation 710. However, secondary background measurement of operation 730 is generally performed for a longer duration (e.g., greater than or equal to about two times the duration of the initial background measurement of operation 710, such as greater than or equal to about three times the duration of the initial background measurement of operation 710) in order to obtain a more accurate reading of the background counts to ensure that the failure at operation 730 was appropriate. In some embodiments, the duration of the secondary background measurement of operation 730 is about 100 seconds. If after the secondary background measurement of operation 730 the changes in the background radiation are still determined unacceptable at operation 740, the operation of the particular subsystem of the radioactive waste screening system 100 (FIG. 1) is aborted at operation 750 until appropriate measures are taken to fix the cause of the unacceptable background radiation. If the measurements from the longer secondary background measurement of operation 730 yields more acceptable results than the failure of the initial background measurement of operation 710, then at operation 740 the background may be considered acceptable and the background measurement 700 passes and moves on to whatever operation is next, as indicated by the line 760.

FIG. 8 is a flowchart representing an initial set-up process 800 for each of the subsystems (e.g., the packaged waste screening subsystem 104, the volume waste screening subsystem 106, the subsurface waste characterization subsystem 108, and the surface waste characterization subsystem 110 shown in FIGS. 2-5) of the radioactive waste screening system 100 (FIG. 1), according to embodiments of the disclosure. The initial set-up process 800 may be repeated whenever it is desired to startup and run at least one subsystem of the radioactive waste screening system 100.

At operation 805, the various components of the particular subsystem to be started up and operated are manually inspected. For example, with reference to FIG. 2, if the packaged waste screening subsystem 104 is to be started up and operated, an operator (e.g., technician) may manually check that the radiation detection assembly 202, the support assembly 212, the detector positioning assembly 222, the temperature control assembly 234, the weighing assembly 236, and supplemental computer/electronics assembly 238 are each in operational condition. As another example, with reference to FIG. 3, if the volume waste screening subsystem 106 is to be started up and operated, an operator may manually check that the radiation detection assembly 302, the detector support assembly 316, the segregation assembly 318 (e.g., including the conveyor assembly 322, the gate assembly 324, the weight measurement devices 330, etc.), the temperature control assembly 340, and supplemental computer/electronics assembly 342 are each in operational condition. As an additional example, with reference to FIG. 4, if the subsurface waste characterization subsystem 108 is to be started up and operated, an operator may manually check that the cone penetrometer assembly 404, the radiation detection assembly 406, the detector positioning assembly 408, the temperature control assembly 424, and supplemental computer/electronics assembly 426 are each in operational condition. As a further example, with reference to FIG. 5, if the surface waste characterization subsystem 110 is to be started up and operated, an operator may manually check that the mobile unit 504, the radiation detection assembly 506, the position locating device 520, the temperature control assembly 522, and supplemental computer/electronics assembly 524 are each in operational condition.

With returned reference to FIG. 8, if one or more components of the particular subsystem of the radioactive waste screening system 100 to be started up fail the manual inspection at operation 815, the operation of the particular subsystem is aborted at operation 810 (i.e., stop operation) until appropriate measures are taken to remedy the problem.

If the components of the particular subsystem of the radioactive waste screening system 100 to be started up pass the manual inspection at operation 815, then the initial set-up process 800 moves on to operation 820. At operation 820, an automated subsystem check is performed, during which the radioactive waste screening system software attempts to communicate with the components of the particular subsystem to be started up.

If the particular subsystem of the radioactive waste screening system 100 to be started up fails the automated subsystem check at operation 830, the operator may be advised of a subsystem failure and operation of the particular subsystem is aborted at operation 825 (i.e., stop operation) until appropriate measures are taken to remedy the problem.

If the particular subsystem of the radioactive waste screening system 100 to be started up passes the automated subsystem check at operation 830, then the initial set-up process 800 moves on to operation 835. At operation 835, the radioactive waste screening system software reads the startup data files used to operate and/or acquire data from the components of the particular subsystem to be started up.

If the radioactive waste screening system software fails to read the startup data files at operation 845, the operator may be advised of a subsystem startup failure and operation of the particular subsystem is aborted at operation 840 (i.e., stop operation) until appropriate measures are taken to remedy the problem.

If the radioactive waste screening system software successfully reads the startup data files at operation 845, then the initial set-up process 800 moves on to a background measurement of the environment at operation 850. The background measurement of operation 850 may be a simple characterization of the environment associated with the particular subsystem to ensure that the surrounding area is not in a highly contaminated state such that risk to human safety would be undesirably high. Further details of the background measurement of operation 850 may be substantially similar to the background measurement 700 function previously described in relation to FIG. 7.

At operation 855, the radioactive waste screening system software may give the operator an option to use existing calibration information already on record for the particular subsystem of the radioactive waste screening system 100. For example, a source check may be required to be performed by the subsystem at a minimum time interval to ensure that a recent source is on record. At operation 855, the operator may determine not to use an existing source check. The operator may decide not to use an existing source check if the operator is aware that an acceptable recent source check has been performed. The operator may also decide that a new source check is desirable even if not required to according to operating procedure. In such a situation, operation 860 is performed, the significance of which is described below.

If, however, the operator is aware of a source check that has been recently performed, the operator may determine that another source check is not necessary. In that situation, the operator may decide to use an existing source check at operation 855. At operation 865, the operator selects a source check file including source check information that has been stored from a previously performed source check. At operation 870, a determination is made whether the selected source check file is within the minimum time interval required by the particular subsystem, and whether the file is operable. If a failure exists, then the particular subsystem returns to operation 860. If a failure does not exist, then operation 875 is performed.

At operation 860, a source check flag is set to “true.” The source check flag being set to true may indicate that the source check function should be performed at the beginning of the main loop (FIG. 9, operations 922-925). At operation 875, the source check flag is set to “false.” The source check flag being set to false may indicate that the existing source check is acceptable and that the source check function should not be performed at the beginning of the main loop (FIG. 9). At operation 880, the shielded background check flag may be set to “true.” The shielded background check flag being set to true may indicate that the shielded background check function should be performed at the beginning of the main loop (FIG. 9, operations 932-935). If the initial set-up process is completed, the radioactive waste screening system software may move onto the main loop (FIG. 9).

FIG. 9 is a flowchart representing the main loop 900 function for the subsystems (e.g., the packaged waste screening subsystem 104, the volume waste screening subsystem 106, the subsurface waste characterization subsystem 108, and the surface waste characterization subsystem 110 shown in FIGS. 2-5) of the radioactive waste screening system 100 (FIG. 1), according to embodiments of the disclosure. At operation 910, the code loop determines if a periodic source check or a periodic shielded background check is required. As described by operations 920-925 and 930-935, source checks and shielded background checks may be performed manually by an operator, however, it may be desirable for the radioactive waste screening system 100 to perform a source check or a shielded background check for the particular subsystem thereof to be utilized at a minimum frequency in order to ensure that the background or the internal contamination have not changed significantly, which change could compromise the accuracy of the measurements. The radioactive waste screening system 100 may include a running clock to determine the amount of time that has elapsed since the previous source check or shielded background check. For example, if a source check has not been performed (either manually, or being required to do so) for 12 hours, it may be desirable for the main loop 900 to require a source check. Likewise, if a shielded background check has not been performed for 24 hours, it may be desirable for the main loop 900 to require a shielded background check. Of course, the amounts of time described herein are used as examples, and may be variable and depend upon preference or other circumstances. If a periodic source check or shielded background check for a particular subsystem of the radioactive waste screening system 100 is required by operation 910, the appropriate flag is set to true. When a flag is set to true, the respective decisions at operations 922, 932 may determine that a source check at operation 925 or a shielded background check at operation 935 is to be performed.

The main loop 900 further includes operations that may be manually triggered by an operator. These manually-triggered operations are represented by Source Check? 920, Shielded Background Check? 930, Measurement? 940, Print Data? 950, and ABORT? 960. If an operator selects one of these operations, the appropriate flag is set, which triggers a corresponding decision (e.g., 922, 932, 942, 952, 962) and calls a corresponding function (e.g., 925, 935, 945, 955). The processes for source check operation 925, shielded background check operation 935, and measurement operation 945 are described more fully below with reference to FIGS. 10, 11, and 12A-15C (i.e., 12A-12C, 13A-13C, 14A-14C, and 15A-15C), respectively. The print data operation 955 obtains stored data for the particular subsystem of the radioactive waste screening system 100 (FIG. 1) to be displayed and/or printed, and an ABORT operation 965 terminates the operation of the particular subsystem.

While the particular subsystem of the radioactive waste screening system 100 is idle (i.e., there are no measurements or other modes in process), the main loop 900 repeats indefinitely until a function is selected by an operator, a function is selected automatically from time triggers within the system, or a function is selected automatically through other triggers or interrupts within the radioactive waste screening system 100.

FIG. 10 is a flowchart representing a source check 1000 function for the subsystems (e.g., the packaged waste screening subsystem 104, the volume waste screening subsystem 106, the subsurface waste characterization subsystem 108, and the surface waste characterization subsystem 110 shown in FIGS. 2-5) of the radioactive waste screening system 100 (FIG. 1) according to embodiments of the disclosure. The source check 1000 serves to perform an energy calibration for the radiation detector (e.g., the radiation detectors 204, 304, 410, 508 previously described in relation to FIGS. 2-5) of a subsystem of the radioactive waste screening system 100 with a known radioactive source, or to check the performance of certain hardware components of the particular subsystem. Source check 1000 may be performed as required by the subsystem as a periodic source check (e.g., every 12 hours), or when selected manually by an operator. For example, a source check 1000 should be performed when a particular subsystem of the radioactive waste screening system 100 is suspected of needing calibration. At operation 1010, a background measurement may be performed. The background measurement at operation 1010 may be substantially similar to the background measurement 700 function previously described in relation to FIG. 7.

At operation 1020, a known radioactive source (e.g., ²²⁶Ra) may be positioned within the field of view of a radiation detector (e.g., a radiation detector 204, 304, 410, 508 previously described in relation to FIGS. 2-5) of the subsystem. The known radioactive source may be isolated from background activity that may otherwise be detected by the radiation detector. For example, the radiation detector may be shielded (e.g., by way of a collimator) from the background so as to focus the field of view of the radiation detector substantially only on the known radioactive source.

At operation 1030, an initial source check may be performed on the known radioactive source. The subsystem detects the radiation emitted by the known radioactive source for a given time (e.g., about 2 minutes). The initial source check at operation 1030 creates a spectrum and monitors the characteristic peaks generated by the known radioactive source, and performs an energy calibration based, at least in part, on those peaks. Such an energy calibration may ensure that the radiation detector remains within a desired tolerance level for the detected peaks of the known radioactive source compared with the characteristic peaks that are known to be generated by the known radioactive source. The initial source check at operation 1030 may compare one or more energy peak levels of the generated spectrum with the corresponding specific characteristic gamma ray lines expected to be generated. The initial source check 1030 ensures that the compared energy peaks in the generated spectrum are properly positioned relative to each other in the spectrum and at the right energy levels. If there is a discrepancy between the generated spectrum and the characteristic spectrum for the known radioactive source, an automated adjustment is made on the energy gain per channel of the multichannel analyzer used in creating the spectrum. In other words, the peaks in the generated energy spectrum are forced to match the characteristic peaks for the spectrum of the known radioactive source.

If the initial source check from operation 1030 is determined to fail at operation 1032, a secondary source check at operation 1035 may be performed. The secondary source check at operation 1035 may perform similar functions in energy calibration and detector testing as initial source check at operation 1030. The secondary source check 1035 may take measurements of the known radioactive source for a longer duration (e.g., greater than or equal to about 2 times longer, such as about 4 minutes) in order to reduce the uncertainties in the measurements. If the secondary source check from operation 1035 fails at operation 1037, then the subsystem may abort 1040 and terminate until the problem is remedied. Because such a failure would likely be caused by a hardware failure, one or more hardware components of the particular subsystem may be required to be replaced.

If either the initial source check at operation 1030 or the secondary source check at operation 1035 passes, the data resulting from the source check may be stored with historical data of prior source checks in a control chart and compared against the historical data at operation 1050. For example, the shape of the energy peaks in the spectrum generated by the known radioactive source may be compared with historical energy peak shapes from prior source checks at operation 1050. If the energy peaks are determined to misshaped (e.g., wider than normal) the comparison may indicate that the radiation detector of the subsystem is declining in performance (e.g., resolution decreasing). As another example, the activity detected for the known radioactive source may be compared against the activity historically detected for the known radioactive source from prior source checks at operation 1050. If the activity detected differs from the activity historically detected the comparison may indicate radiation detector failure.

At operation 1060, the operator is given the opportunity to review the source check data. If the operator decides to review the source check data at operation 1060, the operator may review the source check data at operation 1065 prior to continuing on operation 1070. Otherwise, if the operator decides not to review the source check data at operation 1060, operation 1070 is performed.

At operation 1070, the known radioactive source is removed, and any means (e.g., collimator) employed to focus the field of view of the radiation detector of the particular subsystem substantially only on the known radioactive source may be modified and/or removed to facilitate an extended background analysis at operation 1080.

At operation 1080, the extended background analysis is performed. The extended background analysis at operation 1080 is distinguished from the background measurement described in reference to FIG. 7. In particular, the extended background analysis 1080 is generally for a longer duration than the background measurement described in reference to FIG. 7. The extended background analysis at operation 1080 is also performed for a different purpose than evaluating criticality of the environment or substantial changes of the environment surrounding a subsystem of the radioactive waste screening system 100. For example, the extended background analysis at operation 1080 may collect counts by the radiation detector from the background for a period of time sufficient to obtain suitable measurements of the background radiation (e.g., about 10 minutes). In other words, the extended background analysis at operation 1080 may be a more fine measurement of the background than the background measurement of FIG. 7. The results of the extended background analysis at operation 1080 may, therefore, be more reliable (i.e., less uncertainty in the measurement statistics) and the resulting data may be stored for later use. For example, during measurement and analysis, the resulting data from the extended background analysis at operation 1080 may be subtracted from the gross individual gamma ray data of the measurement to obtain net measurement data. At operation 1090, the source check 1000 function returns to the main loop 900 (FIG. 9) function.

While an extended background measurement at operation 1080 is described herein as being separate from a the background measurement 700 function previously described in relation to FIG. 7, the two functions may be combined. Additionally, the extended background measurement at operation 1060 is described as being performed each time a source check 1000 function is performed. However, the extended background measurement of operation 1060 may be performed or called as a separate function, or in combination with other functions that are described herein.

In addition to the energy calibration provided during the source check function 1000, the various subsystems (e.g., the packaged waste screening subsystem 104, the volume waste screening subsystem 106, the subsurface waste characterization subsystem 108, and the surface waste characterization subsystem 110 shown in FIGS. 2-5) of the radioactive waste screening system 100 (FIG. 1) may employ real time energy calibrations. During the real time energy calibrations, a radiation detector of the particular subsystem in operation may measure the radiation emitted by at least two natural background constituents (e.g., potassium-40, thallium-208, etc.) of a material and/or a material formation being analyzed for a given period of operational (e.g., live) time, such as for about 5 minutes of operational time. The measurements may take place concurrently with the measurements being made during the measurement function (e.g., the measurement functions 1200-1500 shown in FIGS. 12A-15C, and described in further detail below) for the particular subsystem in use. A spectrum is generated and the characteristic peaks created by the natural background constituent are monitored. The radioactive waste screening system software compares at least two energy peak levels of the generated spectrum with the corresponding specific characteristic gamma ray lines expected to be generated, and ensures that the compared energy peaks in the generated spectrum are properly positioned relative to one another other in the spectrum and at the right energy levels. If there is a discrepancy between the generated spectrum and the characteristic spectrum for the natural background constituents, an automated adjustment may be made to the energy gain per channel of the multichannel analyzer used in creating the spectrum such that the peaks in the generated energy spectrum match the characteristic peaks for the spectrum of natural background constituents.

FIG. 11 is a flowchart representing a shielded background check 1100 for the subsystems (e.g., the packaged waste screening subsystem 104, the volume waste screening subsystem 106, the subsurface waste characterization subsystem 108, and the surface waste characterization subsystem 110 shown in FIGS. 2-5) of the radioactive waste screening system 100 (FIG. 1), according to embodiments of the disclosure. During the shielded background check 1100 the radiation detector (e.g., the radiation detector 204, 304, 410, 508 previously described in relation to FIGS. 2-5) of a particular subsystem is shielded from the background in order to perform a check on potential internal contamination of the radiation detector. Internal contamination may be a problem as such contamination may cause the radiation detector to experience artificially high readings. The shielded background check 1100 may be performed as required by a particular subsystem of the radioactive waste screening system 100 as a periodic shielded background check (e.g., every 24 hours), or when selected manually by an operator. For example, a shielded background check 1100 should be done when at least one component of the subsystem is suspected of experiencing contamination.

At operation 1110, a background measurement may be performed. The background measurement 1110 may be substantially similar to the background measurement 700 function previously described in relation to FIG. 7.

At operation 1120, the radiation detector of the particular subsystem may be prepared for shielded check. The radiation detector's field of view may be completely shielded (e.g., blocked) from external radiation sources (e.g., background radiation) in order to ensure that radiation measurements detected by the radiation detector are a result of contamination within the radiation detector itself, or the detector chamber. As a non-limiting example, a radiation free (e.g., blank) source may be positioned within the field of view of a radiation detector while a remaining portion of the radiation detector is shielded (e.g., by way of a collimator) from external radiation sources.

At operation 1130, an initial shielded background check is performed. The initial shielded background check at operation 1130 may include collecting measurement data for an initial period of time (e.g., about 60 seconds). During the initial background check at operation 1130, the radioactive waste screening system 100 may create a control chart storing the present data with historical data of prior shielded background checks for the subsystem. If the activity detected during the initial shielded background check at operation 1130 significantly differs from the historical data from prior shielded background checks, the difference may indicate that internal contamination within the radiation detector of the subsystem has increased over time. As a result, a failure may be determined at operation 1135.

If the initial shielded background check at operation 1130 is determined to fail at operation 1135, then a secondary shielded background check at operation 1140 may be performed. The secondary shielded background check at operation 1140 may perform similar functions to determine internal contamination of the radiation detector as the initial shielded background check at operation 1130. The secondary shielded background check at operation 1140 may collect measurements for a longer duration (e.g., 180 seconds) in order to reduce the uncertainties in the measurements. If the secondary shielded background check from operation 1140 fails at operation 1145, then the subsystem may abort at operation 1150 and terminate until the problem is remedied. Since such a failure would likely be caused by internal contamination of the radiation detector of subsystem, the radiation detector may be required to be cleaned, or in some cases replaced.

If either the initial shielded background check at operation 1130 or the secondary shielded background check at operation 1140 passes, the radiation detector may be prepared to preform measurements at operation 1160. For example, if employed to prepare the radiation detector for the shielded check at operation 1120, a radiation free source may be removed from the field of view of the radiation detector. Thereafter, at operation 1170, the shielded background check 1100 function returns to the main loop 900 (FIG. 9). With a proper shielded background check 1100, and a proper source check 1000 (FIG. 10), the subsystem of the radioactive waste screening system 100 (FIG. 1) may be ready to perform measurements at operation 1160.

FIGS. 12A-12C are a series of flowcharts representing a measurement function 1200 for the packaged waste screening subsystem 104 (FIG. 2) of the radioactive waste screening system 100 (FIG. 1), according to embodiments of the disclosure. The measurement function 1200 may perform measurements using at least one radiation detector (e.g., the radiation detector 204 shown in FIG. 2) of the packaged waste screening subsystem 104 to detect, measure, and characterize radioactivity.

Referring to FIG. 12A, at operation 1202, a background measurement may be performed. The background measurement at operation 1202 may be substantially similar to the background measurement 700 function previously described in relation to FIG. 7.

At operation 1204, a containment vessel (e.g., the containment vessel 200 shown in FIG. 2) holding a test material therein is positioned relative to the radiation detector of the packaged waste screening subsystem 104 for assay measurement.

At operation 1206, an initial gross count rate is checked. The gross count rate at operation 1206 may measure gross gamma activity to ensure that the material in the containment vessel is not undesirably hot from a radioactive standpoint. Being undesirably hot from a radioactive standpoint may cause one of many problems including being unsafe, providing inaccurate measurements, and ultimately exceeding an upper threshold for shipping and disposal. If the gross count rate at operation 1206 for the material is above a predetermined threshold (e.g., 500,000 counts per second (cps)) and determined to be undesirably hot, a failure is determined at operation 1208 and at least a portion of the material in the containment vessel may be removed at operation 1210 and the gross count rate check at operation 1206 is repeated. In some cases, less radioactive samples may be mixed with a hot sample to lower the overall activity of the material being measured.

If the gross count rate check at operation 1206 is determined to be acceptable at operation 1208, further analysis may be performed. At operation 1212, sample parameters may be configured. Sample parameters may include information regarding the specific material being measured, which may be retrieved automatically by the radioactive waste screening system 100, input by the operator, or a combination thereof. Such information may be used in the analysis of the radioactive content of the sample. Other information may simply be used for organizational and bookkeeping functions of the waste screening system. Exemplary sample parameters may include a containment vessel ID, waste type (e.g., graphite, cloth rags, dirt, etc.), height of the material within the containment vessel, and weight of the filled containment vessel. The weight and height of the sample may be used to calculate the density of the sample, which may be further used in calculating mass attenuation of the radiation of the sample.

At operation 1214, the containment vessel may begin to be counted. At least one set of measurements may be taken, at least partially depending on the field of view of the radiation detector and the spacing (e.g., distance) from the radiation detector required for desired resolution of the radiation detector.

Referring next to FIG. 12B, after operation 1214, the measurement function 1200 begins a continuous ²²⁶Ra activity monitoring loop 1215 including operations 1216-1222 to determine the ²²⁶Ra activity of the material within the containment vessel. At operation 1216, the measurement data may be analyzed to calculate an estimated ²²⁶Ra activity of the material. The analysis may employ a peak search engine, which may be available from ORTEC, that produces a report including a peak for ²²⁶Ra. The counts for the ²²⁶Ra peak may be extracted from the measurements to estimate ²²⁶Ra activity.

At operation 1218, counting is continued and the additional measurement data is analyzed to monitor and/or update the estimated ²²⁶Ra activity of the material within the containment vessel. The updated ²²⁶Ra activity from operation 1218 is then checked at operation 1220 to determine if the material exhibits a MDA of ²²⁶Ra activity below 5 pCi/g. If the answer to the check at operation 1220 is yes, the continuous ²²⁶Ra activity monitoring loop 1215 is terminated, and counting stops at operation 1224. Conversely, if the answer to the check at operation 1220 is no, a secondary check is performed at operation 1222 to determine if the material exhibits an ²²⁶Ra activity above 5 pCi/g with less than 50 percent uncertainty. If the answer to the secondary check at operation 1222 is yes, the continuous ²²⁶Ra activity monitoring loop 1215 is terminated, and counting stops at operation 1224. Conversely, if the answer to the secondary check at operation 1222 is no, the continuous ²²⁶Ra activity monitoring loop 1215 continues by looping back to operation 1218 and again calculating the estimated ²²⁶Ra activity based on the further measurement data.

After counting is stopped at 1224, all the measurement data (i.e., spectrum) may be analyzed at operation 1226. The analysis may employ a peak search engine, which may be available from ORTEC, that produces a report including peaks for a predetermined set of radionuclides. The counts for each of the peaks may be extracted from the measurements to estimate the overall activity for each radionuclide. The overall activity may be compensated for expected mass attenuation of the radiation within the material.

For example, compensation for mass attenuation may be performed by automated density correction methods. Such density correction methods may correct for variable density and thickness in the sample being measured in order to compensate the overall activity for mass attenuation. An initial density correction method adjusts the measured activity based, at least in part, on thickness and density of the sample, and the expected mass attenuation for radiation for the characteristics of the material in the sample. For example, the adjusted activity may be determined by:

$$Act = ( \frac{NCR}{Eff * BR * 3.7 e7} ) * ( \frac{μρ t}{1 - {e}^{- μρ t}} ) \qquad ( 1 )$$

where,
Act=Activity in millicuries;
NCR=Net corrected count rate (counts/second);
Eff=Interpolated detector efficiency;
BR=Branching ratio of the particular gamma ray line;
μ=Interpolated mass attenuation coefficient;
ρ=Density (gr/cm³) from weight and volume estimation; and
t=Thickness (cm) of material.

A secondary density correction method may be performed after the initial density correction method. The secondary density correction method may correct for errors in the apparent mass attenuation coefficients used on the initial density correction shown as equation (1). The secondary density correction method may be performed by plotting the initial adjusted activity (Act) from equation (1) as a function of the inverse energy at which the activity was calculated, and performing a weighted least squares regression analysis to determine activity at infinite energy (i.e., assuming there are no mass attenuation effects) and the associated uncertainty at this energy. The basis of this secondary density correction method is that if the mass attenuation coefficients used in the initial calculation in equation (1) were correct, the slope of a line plotted through the data would be approximately zero as each gamma ray line for a particular isotope (e.g., ²⁶⁶Ra) would provide substantially the same activity. A line resulting from the weighted least squares regression analysis with a negative slope indicates that the original mass attenuation coefficient (μ) used in equation (1) was too small. A line resulting from the weighted least squares regression analysis with a positive slope indicates that the original mass attenuation coefficient (μ) used in equation (1) was too large.

Each data point used in the analysis has a computed activity and associated uncertainty due to counting statistics. These numbers are corrected for efficiency and an initial mass attenuation correction using equation 1. In general, the uncertainty of each data point is unique lending itself to a weighted linear regression analysis for compensating for mass attenuation. For example, let

$${w}_{i} = \frac{1}{{σ}_{i}^{2}} ,$$

where wᵢ is defined as a weighting function and a, represents the count rate standard deviation associated with each nuclide. The weighting function may give more importance (i.e., weight) to measurement data that has relatively smaller counting errors. The slope and y-intercept of a regression line that minimizes the weighted sum of the errors squared are given by equations (2) and (3):

$$\begin{matrix}m = \frac{{\sum }_{i = 1}^{n} {w}_{i} {\sum }_{i = 1}^{n} {w}_{i} {x}_{i} {y}_{i} - {\sum }_{i = 1}^{n} {w}_{i} {x}_{i} {\sum }_{i = 1}^{n} {w}_{i} {y}_{i}}{{\sum }_{i = 1}^{n} {w}_{i} {\sum }_{i = 1}^{n} {w}_{i} {x}_{i}^{2} - {( {\sum }_{i = 1}^{n} {w}_{i} {x}_{i} )}^{2}} & ( 2 ) \\ b = {\sum }_{i = 1}^{n} {w}_{i} {y}_{i} - m {\sum }_{i = 1}^{n} {w}_{i} {x}_{i} & ( 3 )\end{matrix}$$

where,
m=Slope from the weighted regression analysis;
xᵢ=Inverse energy (1/E) in keV⁻¹ for measurement data;
yᵢ=Activity in mCi (from equation (1));
n=Number of data points in the analysis; and
b=Y-intercept from the weighted regression analysis.

In addition, the variance (σ²) of the weighted regression analysis, the variance of the slope (σₘ²) of the weighted regression line, the variance of the y-intercept (σ_{b}²) of the weighted regression line, and the covariance (Cov(m,b)) of the slope and intercept are given by equations (4) through (7), respectively:

$$\begin{matrix}{σ}^{2} = \frac{( {S}_{yy} - m * {S}_{xx} )}{n - 2} & ( 4 ) \\ {σ}_{m}^{2} = \frac{{σ}^{2}}{{S}_{xx}} & ( 5 ) \\ {σ}_{b}^{2} = {σ}^{2} [ \frac{1}{{\sum }_{i = 1}^{n} {w}_{i}} + \frac{{\overline{X}}^{2}}{{S}_{xx}} ] & ( 6 ) \\ Cov ( m , b ) = \frac{- {\sum }_{i = 1}^{n} {w}_{i} {x}_{i}}{{\sum }_{i = 1}^{n} {w}_{i} {\sum }_{i = 1}^{n} {w}_{i} {x}_{i}^{2} - {( {\sum }_{i = 1}^{n} {w}_{i} {x}_{i} )}^{2}} \\ where , & ( 7 ) \\ {S}_{xx} = {\sum }_{i = 1}^{n} {{w}_{i} ( {x}_{i} - \overline{X} )}^{2} & ( 8 ) \\ {S}_{xy} = {\sum }_{i = 1}^{n} {w}_{i} ( {x}_{i} - \overline{X} ) ( {y}_{i} - \overline{Y} ) & ( 9 ) \\ {S}_{yy} = {\sum }_{i = 1}^{n} {{w}_{i} ( {y}_{i} - \overline{Y} )}^{2} & ( 10 ) \\ \overline{X} = \frac{{\sum }_{i = 1}^{n} {w}_{i} {x}_{i}}{{\sum }_{i = 1}^{n} {w}_{i}} & ( 11 ) \\ \overline{Y} = \frac{{\sum }_{i = 1}^{n} {w}_{i} {y}_{i}}{{\sum }_{i = 1}^{n} {w}_{i}} & ( 12 )\end{matrix}$$

The foregoing weighted regression analysis may be performed on all measured ²²⁶Ra data. A preliminary estimate of activity may be calculated for all selected gamma ray emissions of ²²⁶Ra, and then apparent activity and uncertainty may be adjusted for errors in mass attenuation. The calculated ²²⁶Ra activity is the y-intercept (b) of the weighted regression analysis as depicted in equation (3), and the uncertainty at this activity is the square root of the variance of the y-intercept depicted in equation (6). The determination utilizes at least three gamma ray lines with non-zero intensity (c/s) values.

The mass attenuation corrections derived for ²²⁶Ra described above may be applied to other radionuclides to compute corrected activities thereof, along associated uncertainties. For example, the corrected activity for either ²⁴¹Am or ²³⁹Pu may be described as shown in equation 13:

$${A}_{E} = b + m ( \frac{1}{E} ) \qquad ( 13 )$$

where,
A_{E}=Activity at energy E from the regression analysis
b=Y-intercept from the weighted regression analysis
m=Slope from the weighted regression analysis.

### E=Energy in keV.

Manipulating equation (13) and defining a parameter C yields:

$$\frac{{A}_{E}}{b} = \frac{m}{E * b} + 1 = C + 1 \qquad ( 14 )$$

where, C+1 is the desired attenuation coefficient for a gamma ray of energy E. The error in the attenuation coefficient may be calculated as shown in equation (15) if small errors in energy (E) are ignored:

$${σ}_{c}^{2} = [ ( \frac{{σ}_{m}^{2}}{m} ) + ( \frac{{σ}_{b}^{2}}{b} ) - ( \frac{2}{b * m} ) cov ( b , m ) ] * {C}^{2} \qquad ( 15 )$$

The corrected activity of an unrelated radionuclide with a measured activity of Aₘₑₐₛ at energy Eₘₑₐₛ may then calculated according to equation (16) with an associated uncertainty as shown in equation (15) with C calculated at Eₘₑₐₛ:

$${A}_{c} = {A}_{meas} ( \frac{b}{{A}_{E}} ) = {A}_{meas} [ \frac{b}{( b + \frac{m}{{E}_{meas}} )} ] \qquad ( 16 )$$

In addition, in conjunction with the forgoing mass attenuation corrections, weighted regression analysis and modeling may be utilized to correct for non-equilibrium decay chains associated with particular radionuclides (e.g., ²³⁵U, ²³⁸U, ²³²Th, ²²⁶Ra, ²²⁸Ra, ⁴⁰K, etc.) when calculating the activities and associated uncertainties of the particular radionuclides. For example, weighted regression analysis and modeling may be used to estimate a start time of the radioactive decay of daughter products of the particular radionuclides, which may then be utilized to correct calculated activities and associated uncertainties for the particular radionuclides to equilibrium concentrations. Accordingly, the weighted regression analysis may facilitate the assay of radiation-contaminated materials shortly after their removal from a site, providing significant benefit over conventional radiation characterization methods and systems, which generally require at least a 30 day wait period from the time a material is removed from a site to allow equilibrium concentrations to be reached.

Referring next to FIG. 12C, at operation 1228, a report on the net results of the analysis may be displayed to a monitor. The net results may include the compensation for mass attenuation and variations in thickness and density as described in operation 1226, and may be determined taking the peak counts measured for the material held within the containment vessel, and subtracting the background spectrum (FIG. 10, operation 1080). The net results may be obtained for each gamma ray line in the measurement spectrum and the background spectrum. In other words, the portion of the measurement spectrum attributed to background contamination detected by the radiation detector is effectively negated. The displayed report may include a summary of calculated activities, including uncertainties, for each radionuclide that was evaluated (e.g., ²³⁵U, ²³⁸U, ²³²Th, ²²⁶Ra, ²²⁸Ra, ⁴⁰K, etc.). The displayed report may also indicate whether the containment vessel 200 (FIG. 2) should be disposed as non-radioactive waste (e.g., for a total calculated activity of less than 5 pCi/g), intermediate level radioactive waste (e.g., for a total calculated activity of from 5 pCi/g to 30 pCi/g), or high level radioactive waste (e.g., for a total calculated activity greater than 30 pCi/g). Thereafter, the data obtained (e.g., the spectral data, the volume data, the weight data, etc.) may be recorded to a daily log, and the operator may appropriately mark the containment vessel as non-radioactive waste, intermediate level radioactive waste, or high level radioactive waste at operation 1230.

At operation 1232, the operator may make a decision whether or not print the net results of the analysis performed on the material within the containment vessel. If printing the net results for a single containment vessel 200 is desired, the net results may be printed at operation 1234. After printing the net results for a single containment vessel 200, or if printing the net results for a single containment vessel 200 is not desired, the operator may make a decision whether or not print a summary encompassing the net analysis results for all the containment vessels tested over a selected period (e.g., a day of operation) at operation 1236. If printing such a summary is desired, the operator may do so at operation 1238.

At operation 1240, the operator may decide whether or not to perform another measurement. If another measurement is desired, the containment vessel is removed, and the measurement function 1200 returns to operation 1204 to position a new containment vessel relative to the radiation detector of the packaged waste screening subsystem 104 for assay measurement. If another measurement is not desired, the measurement function 1200 may return to the main loop 900 (FIG. 9) at operation 1242.

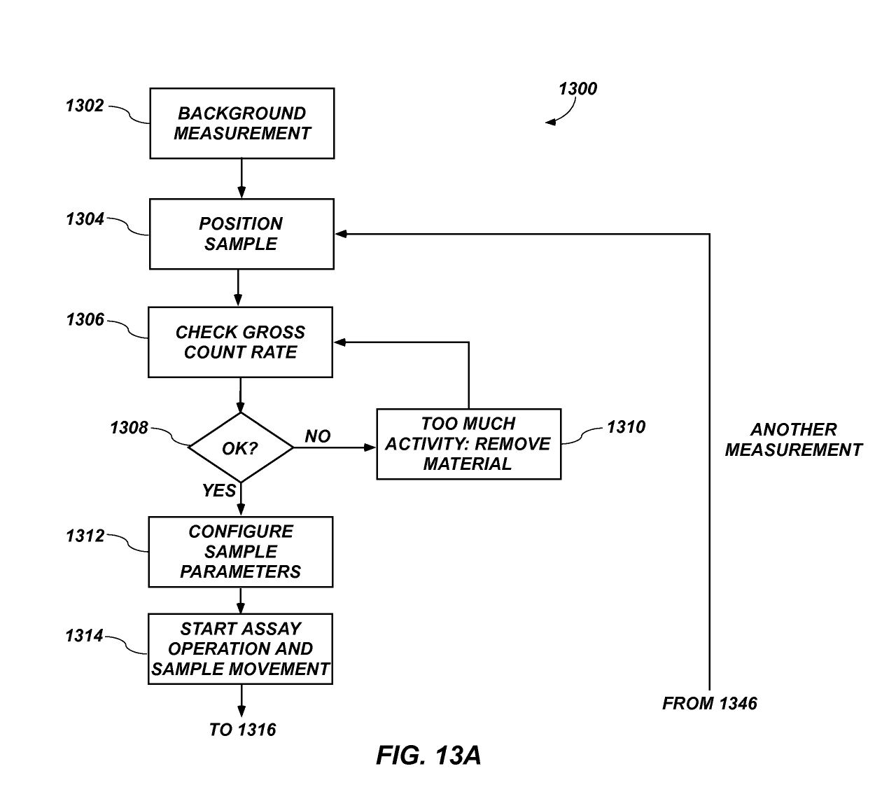

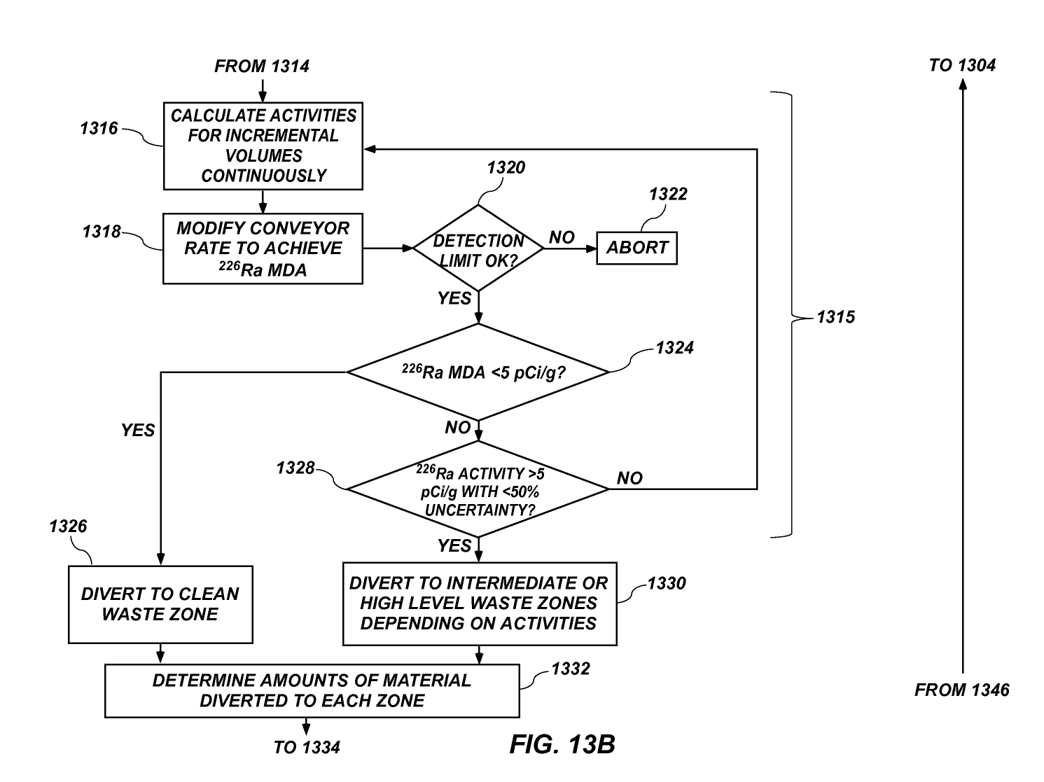

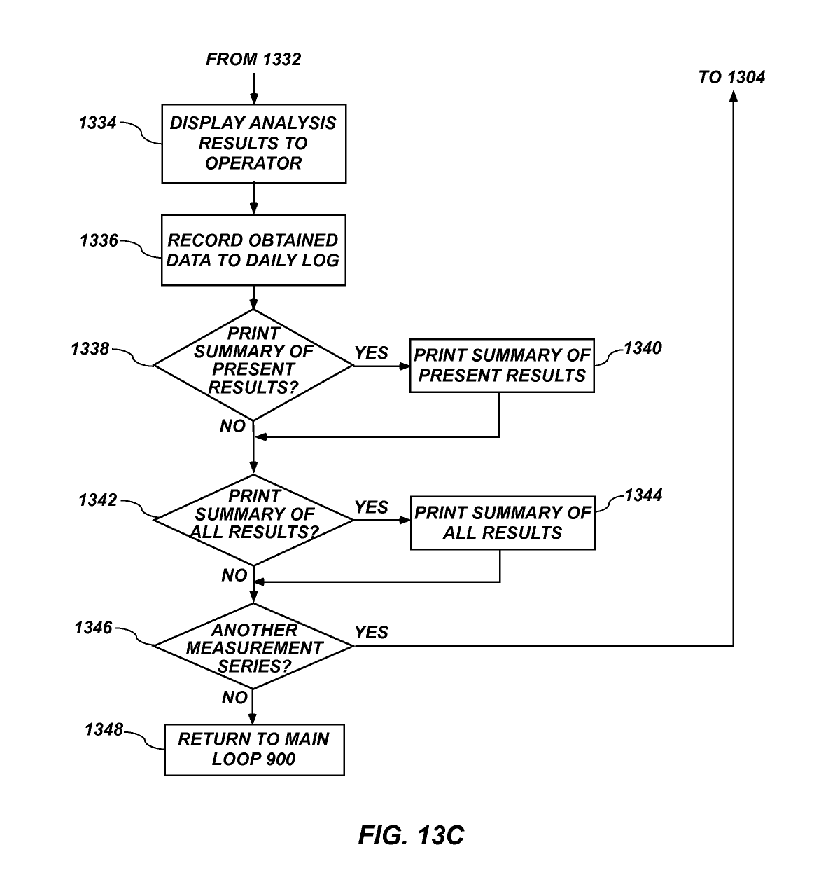

FIGS. 13A-13C are a series of flowcharts representing a measurement function 1300 for the volume waste screening subsystem 106 (FIG. 3) of the radioactive waste screening system 100 (FIG. 1), according to embodiments of the disclosure. The measurement function 1300 may perform measurements using at least one radiation detector (e.g., the radiation detector 304 shown in FIG. 3) of the volume waste screening subsystem 106 to detect, measure, and characterize radioactivity.

Referring to FIG. 13A, at operation 1302, a background measurement may be performed. The background measurement at operation 1302 may be substantially similar to the background measurement 700 function previously described in relation to FIG. 7.

At operation 1304, a volume of material (e.g., the volume of material 300 shown in FIG. 3) to be tested is provided (e.g., delivered) to a segregation assembly (e.g., the segregation assembly 318 shown in FIG. 3) of the volume waste screening subsystem 106 for assay measurement.

At operation 1306, an initial gross count rate is checked. The gross count rate at operation 1206 may measure gross gamma activity to ensure that the volume of material is not undesirably hot from a radioactive standpoint. If the gross count rate at operation 1306 for the volume of material is above a predetermined threshold (e.g., 500,000 counts per second (cps)) and determined to be undesirably hot, a failure is determined at operation 1308 and at least a portion of the volume of material may be removed at operation 1310 and the gross count rate check at operation 1306 is repeated. In some cases, less radioactive materials may be mixed with a hot volume of material to lower the overall activity of the volume of material being measured.

If the gross count rate check at operation 1306 is determined to be acceptable at operation 1308, further analysis may be performed. At operation 1312, sample parameters may be configured. Sample parameters may include information regarding the specific volume of material being measured, which may be retrieved automatically by the radioactive waste screening system 100, input by the operator, or a combination thereof. Such information may be used in the analysis of the radioactive content of the volume of material. Other information may simply be used for organizational and bookkeeping functions of the waste screening system. Exemplary sample parameters may include a waste delivery vehicle ID, material type (e.g., soil, dirt, etc.), the volume of the material on the conveyor assembly (e.g., the conveyor assembly 322 shown in FIG. 3), and the weight of the volume of material on the conveyor assembly. The dimensions and weight of the volume of the material may be used to calculate the density of the volume of the material, which may be further used in calculating mass attenuation of the radiation of the one or more portions of the volume of material.

At operation 1314, the conveyor assembly begins to move (e.g., convey) different portions (e.g., different incremental volumes) of the volume of material past the radiation detector, and the different portions of the volume of material begin to be counted. The conveyor assembly may move the different portions of the volume of material past the radiation detector at an initial rate within a range of from about 0.2 m³/s to about 1.0 m³/s.

Referring next to FIG. 13B, after operation 1314, the measurement function 1300 begins a continuous activity monitoring loop 1315 including operations 1316-1328 to continuously determine radionuclide activities for different moving portions (e.g., about 2 cubic foot volumes) of the volume of material. At operation 1316, the measurement data for a particular portion of the volume of material may be analyzed to calculate estimated activities for ²²⁶Ra and other radionuclides (e.g., ²³⁵U, ²³⁸U, ²³²Th, ²²⁸Ra, ⁴⁰K, daughter products of such radionuclides, etc.). The analysis may employ a peak search engine, which may be available from ORTEC, that produces a report including peaks for ²²⁶Ra and the other radionuclides. The counts for the peaks may be extracted from the measurements to estimate the activities of the radionuclides.

At operation 1318, the initial rate at which a particular portion of the volume of material is conveyed (e.g., by way of the conveyor assembly) past the radiation detector may be adjusted, based on the estimated ²²⁶Ra activity calculated at operation 1316, to a rate facilitating a ²²⁶Ra activity detection threshold below 5 pCi/g.

At operation 1320, a check is performed to determine if the adjusted material movement rate from operation 1318 facilitates a ²²⁶Ra activity detection threshold below 5 pCi/g. If the answer to the check at operation 1320 is yes, the continuous activity monitoring loop 1315 moves on to operation 1324. Conversely, if the answer to the check at operation 1320 is no, the continuous activity monitoring loop 1315 is terminated, and the operation of the volume waste screening subsystem 106 (FIG. 3) is aborted at operation 1322 until appropriate measures are taken to fix the cause of the unacceptable ²²⁶Ra activity detection threshold.

At operation 1324, the ²²⁶Ra activity for a particular portion of the volume of material traveling at the adjusted movement rate is checked to determine if the particular portion of the volume of material exhibits an MDA of ²²⁶Ra activity below 5 pCi/g. If the answer to the check at operation 1324 is yes, the particular portion of the volume of material may be diverted (e.g., by way of the gate assembly 324 shown in FIG. 3) to a non-radioactive waste zone at operation 1326. The non-radioactive waste zone may include one or more containers to hold the portions of the volume of material diverted thereto. Conversely, if the answer to the check at operation 1324 is no, a secondary check is performed at operation 1328 to determine if the particular portion of the volume of material exhibits an ²²⁶Ra activity above 5 pCi/g with less than 50 percent uncertainty. If the answer to the secondary check at operation 1328 is no, the continuous activity monitoring loop 1315 continues by looping back to operation 1316 and again calculating estimated radionuclide activities based on further measurement data. Conversely, if the answer to the secondary check at operation 1328 is yes, the specific activities for ²²⁶Ra and other radionuclides (e.g., ²³⁵U, ²³⁸U, ²³²Th, ²²⁸Ra, ⁴⁰K, daughter products of such radionuclides, etc.) for the particular portion of the volume of material are calculated. Preliminary activity estimates may be calculated for all selected gamma ray emissions of ²²⁶Ra and other radionuclides, and then apparent activities and uncertainties may be adjusted for errors in mass attenuation and for non-equilibrium decay chains in accordance with the weighted regression analysis previously described herein in relation to operation 1226 (FIG. 12B) of the measurement function 1200 (FIG. 12A). Based on the activities at calculated at operation 1328, the particular portion of the volume of material may be diverted (e.g., by way of the gate assembly 324 shown in FIG. 3) to an intermediate level radioactive waste zone (e.g., for a total calculated activity of from 5 pCi/g to 30 pCi/g) or a high level radioactive waste zone (e.g., for a total calculated activity greater than 30 pCi/g) at operation 1330. The intermediate level radioactive waste zone and the high level radioactive waste zone may each include one or more containers to hold the portions of the volume of material diverted thereto.

Operations 1316-1330 described above may continue until all portions (e.g., incremental volumes) of the volume of material have been analyzed and properly segregated into at least one of the non-radioactive waste zone, the intermediate level radioactive waste zone, and the high level radioactive waste zone. Thereafter, the measurement function 1300 may continue on to operation 1332.

At operation 1332, the total amount of the volume of material diverted to each of the non-radioactive waste zone, the intermediate level radioactive waste zone, and the high level radioactive waste zone may be determined. For example, the weight of the material (e.g., contained, held, etc.) in each of the different zones may be measured (e.g., through the use of one or more load cells) and/or calculated at operation 1330.

Referring next to FIG. 13C, at operation 1334, a report on the net analysis results and corresponding segregation of the volume of material may be displayed to a monitor. The displayed report may include a summary of calculated activities, including uncertainties, for each radionuclide that was evaluated (e.g., ²³⁵U, ²³⁸U, ²³²Th, ²²⁸Ra, ⁴⁰K, etc.). The displayed report may also indicate amount (e.g., weight and/or volume) of the volume of material present in each of the non-radioactive waste zone, the intermediate level radioactive waste zone, and the high level radioactive waste zone. Thereafter, the data obtained (e.g., the spectral data, the volume data, the weight data, etc.) may be recorded to a daily log at operation 1336.

At operation 1338, the operator may make a decision whether or not print a summary encompassing the data obtained for the test material. If printing the summary is desired, the summary may be printed at operation 1340. After printing the summary at operation 1340, or if printing the summary is not desired, the operator may make a decision whether or not print a summary encompassing the data obtained all volumes of material(s) characterized and segregated by the volume waste screening subsystem 106 over a selected period of time (e.g., a day of operation) at operation 1342. If printing such an overall summary is desired, the operator may do so at operation 1344.

At operation 1346, the operator may decide whether or not to perform another measurement series. If another measurement series is desired, and the measurement function 1300 returns to operation 1304 and an additional volume of material is provided (e.g., delivered) to the segregation assembly of the volume waste screening subsystem 106 for assay measurement. If another measurement series is not desired, the measurement function 1300 may return to the main loop 900 (FIG. 9) at operation 1348.

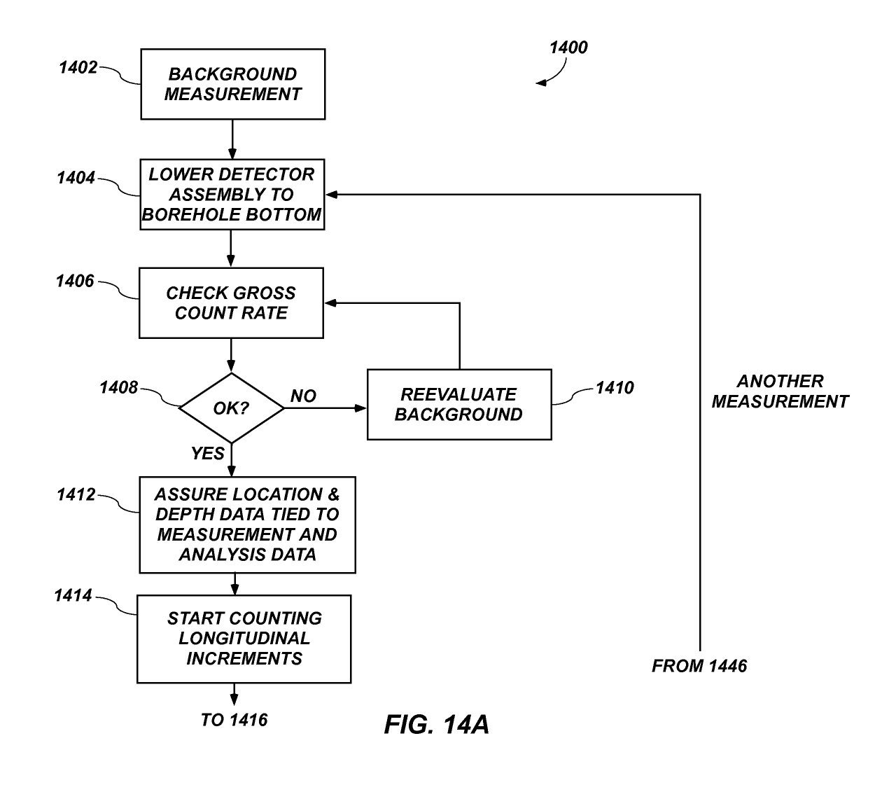

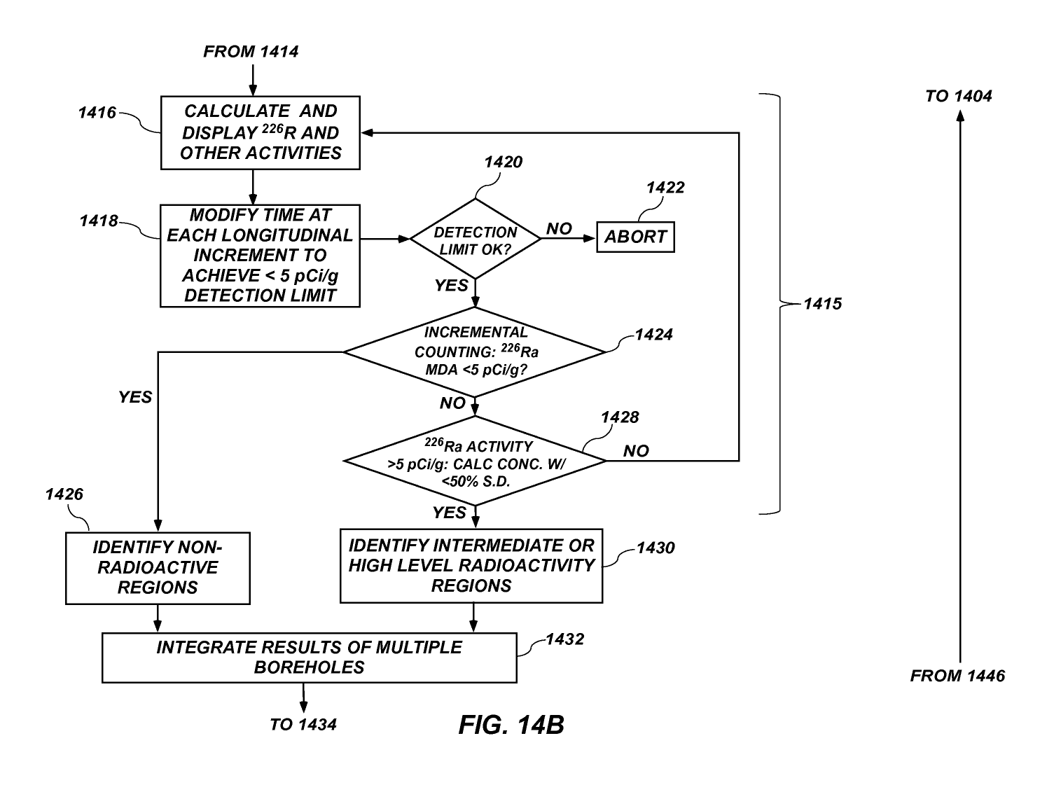

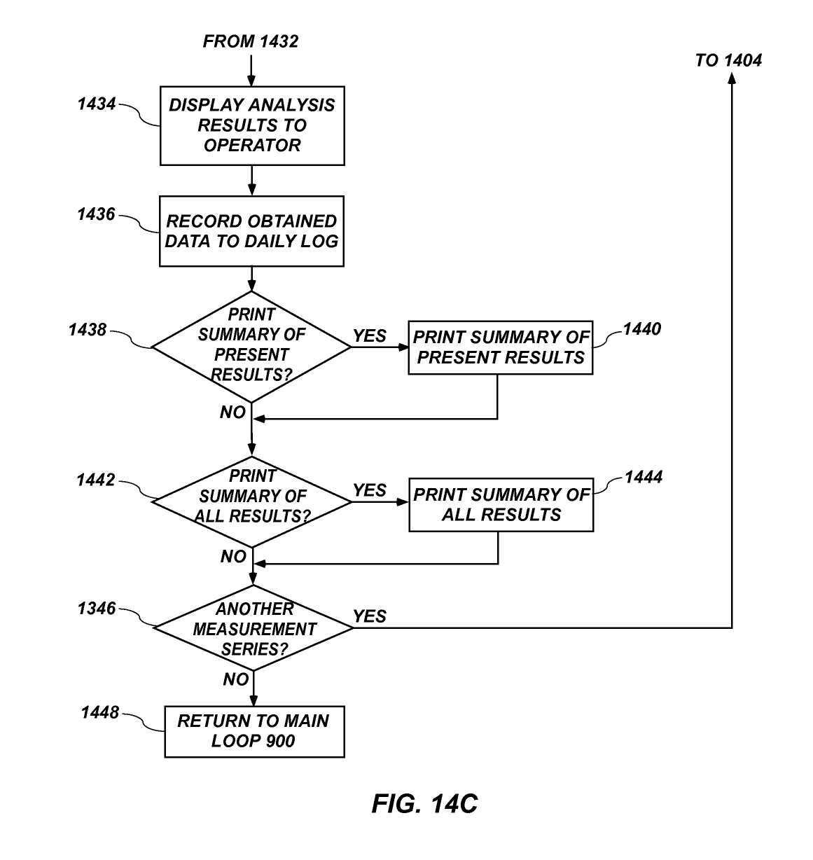

FIGS. 14A-14C are a series of flowcharts representing a measurement function 1400 for the subsurface waste characterization subsystem 108 (FIG. 4) of the radioactive waste screening system 100 (FIG. 1), according to embodiments of the disclosure. The measurement function 1400 may perform measurements using at least one radiation detector 410 (e.g., the radiation detector 410 shown in FIG. 4) of the subsurface waste characterization subsystem 108 to detect, measure, and characterize radioactivity.

Referring to FIG. 14A, at operation 1402, a background measurement may be performed. The background measurement at operation 1402 may be substantially similar to the background measurement 700 function previously described in relation to FIG. 7.

At operation 1404, a radiation detection assembly (e.g., the radiation detection assembly 406 shown in FIG. 4) is lowered (e.g., by way of the detector positioning assembly 408 shown in FIG. 4) to or proximate the bottom of a borehole (e.g, the borehole 402 shown in FIG. 4) within a subterranean formation (e.g, the subterranean formation 400 shown in FIG. 4).

At operation 1406, an initial gross count rate is checked. The gross count rate at operation 1406 may measure gross gamma activity to ensure that the subterranean formation is not undesirably hot from a radioactive standpoint. If the gross count rate at operation 1406 for the subterranean formation is above a predetermined threshold, a failure is determined at operation 1408, and the background may be evaluated to ensure it is not above defined parameters at operation 1410. The gross count rate check at operation 1408 may then be repeated.

If the gross count rate check at operation 1406 is determined to be acceptable at operation 1408, further analysis may be performed. At operation 1412, information regarding the lateral location (e.g., as determined by the position locating device 428 shown in FIG. 4) and the longitudinal location (e.g., depth) of the radiation detector may be linked to (e.g., associated with) measurement data and analysis data to be obtained. Furthermore, a running report including the location (e.g., the lateral location, and the longitudinal location) of the radiation detector along with the measurements and analysis of the subterranean formation associated therewith may be initiated and displayed to a monitor of the radioactive waste screening system 100 at operation 1412.

At operation 1414, regions of the subterranean formation radially proximate the radiation detector within the borehole begin to be counted in predetermined longitudinal increments (e.g., about 1 foot longitudinal increments) starting at the bottom the borehole. The radiation detector may be held (e.g., by way of the detector positioning assembly 408) at a particular longitudinal increment for selected period of time within a range of from about 30 seconds to about 10 minutes, such as about 1 minute.

Referring next to FIG. 14B, after operation 1414, the measurement function 1400 begins a continuous activity monitoring loop 1415 including operations 1416-1428 to continuously determine radionuclide activities for different longitudinal increments of the subterranean formation. At operation 1416, the measurement data for a particular longitudinal increment of the subterranean formation may be analyzed to calculate estimated activities for ²²⁶Ra and other radionuclides (e.g., ²³⁵U, ²³⁸U, ²³²Th, ²²⁸Ra, ⁴⁰K, daughter products of such radionuclides, etc.) at the particular longitudinal increment. The analysis may employ a peak search engine, which may be available from ORTEC, that produces a report including peaks for ²²⁶Ra and the other radionuclides. The counts for the peaks may be extracted from the measurements to estimate the activities of the radionuclides. The estimated radionuclide activities for the region of the subterranean formation at the particular longitudinal increment may also be displayed to a monitor of the radioactive waste screening system 100 at operation 1416.

At operation 1418, the period of time at which the radiation detector 410 is be held a particular longitudinal increment before being moved (e.g., pulled, retrieved, etc.) upward and held at an adjacent longitudinal increment may be adjusted, based on the estimated ²²⁶Ra activity calculated at operation 1416, to a period of time facilitating a ²²⁶Ra activity detection threshold below 5 pCi/g.

At operation 1420, a check is performed to determine if the adjusted time period from operation 1418 facilitates a ²²⁶Ra detection threshold below 5 pCi/g. If the answer to the check at operation 1420 is yes, the continuous activity monitoring loop 1415 moves on to operation 1424. Conversely, if the answer to the check at operation 1420 is no, the continuous activity monitoring loop 1415 is terminated, and the operation of the subsurface waste characterization subsystem 108 (FIG. 4) is aborted at operation 1422 until appropriate measures are taken to fix the cause of the unacceptable ²²⁶Ra activity detection threshold.

At operation 1424, the ²²⁶Ra activity for a particular longitudinal increment of the subterranean formation is checked to determine if the particular longitudinal increment of the subterranean formation exhibits an MDA of ²⁶⁶Ra activity below 5 pCi/g. If the answer to the check at operation 1424 is yes, the region (e.g., about 10 square foot (ft²) region) of the subterranean formation associated with the particular longitudinal increment may be identified as a non-radioactive region at operation 1426. Conversely, if the answer to the check at operation 1424 is no, a secondary check is performed at operation 1428 to determine if the particular longitudinal increment of the subterranean formation exhibits an ²²⁶Ra activity above 5 pCi/g with less than 50 percent uncertainty. If the answer to the secondary check at operation 1428 is no, the continuous activity monitoring loop 1415 continues by looping back to operation 1416 and again calculating estimated radionuclide activities based on further measurement data. Conversely, if the answer to the secondary check at operation 1428 is yes, the specific activities for ²²⁶Ra and other radionuclides (e.g., ²³⁵U, ²³⁸U, ²³²Th, ²²⁸Ra, ⁴⁰K, daughter products of such radionuclides, etc.) for the region of the subterranean formation associated with the particular longitudinal increment are calculated. Preliminary activity estimates may be calculated for all selected gamma ray emissions of ²²⁶Ra and other radionuclides, and then apparent activities and uncertainties may be adjusted for errors in mass attenuation and for non-equilibrium decay chains in accordance with the weighted regression analysis previously described herein in relation to operation 1226 (FIG. 12B) of the measurement function 1200 (FIG. 12A). Based on the activities at calculated at operation 1428, the region of the subterranean formation associated with the particular longitudinal increment may be identified as either an intermediate level radioactivity region (e.g., for a total calculated activity of from 5 pCi/g to 30 pCi/g) or a high level radioactivity region (e.g., for a total calculated activity greater than 30 pCi/g) at operation 1430.

Operations 1416-1430 described above may continue until all longitudinal increments of the subterranean formation associated with the borehole have been analyzed, and the regions of the subterranean formation associated with the longitudinal increments have each independently been properly identified as a non-radioactive region, an intermediate level radioactivity region, or a high level radioactivity region. Thereafter, the measurement function 1400 may continue on to operation 1432.

At operation 1432, the locational data and the analysis data obtained for multiple boreholes across and within of the subterranean formation may be integrated (e.g., combined) to form a three-dimensional model (e.g., map) of the subterranean formation showing the distribution and activities of radioactive material throughout associated longitudinal and lateral dimensions of the subterranean formation.

Referring next to FIG. 14C, at operation 1434, a report on the net analysis results for the tested regions of the subterranean formation (e.g., the portions of the subterranean formation adjacent to the borehole) may be displayed to a monitor. The displayed report may include a summary of calculated activities, including uncertainties, for each radionuclide that was evaluated (e.g., ²³⁵U, ²³⁸U, ²³²Th, ²²⁸Ra, ⁴⁰K, etc.). The displayed report may also indicate distribution non-radioactive regions, intermediate level radioactivity regions, and high level radioactivity regions throughout the volume of the subterranean formation adjacent the borehole. In addition, the displayed report may indicate the distribution of non-radioactive regions, intermediate level radioactivity regions, and high level radioactivity regions throughout the dimensions of subterranean formation modeled in operation 1432. Thereafter, the data obtained (e.g., the spectral data, positional data, etc.) may be recorded to a daily log at operation 1436.

At operation 1438, the operator may make a decision whether or not print a summary encompassing the data obtained for the tested regions of the subterranean formation. If printing the summary is desired, the summary may be printed at operation 1440. After printing the summary at operation 1440, or if printing the summary is not desired, the operator may make a decision whether or not to print a summary encompassing the data obtained at all locations and regions of the subterranean formation characterized by the subsurface waste characterization subsystem 108 over a selected period of time (e.g., a day of operation) at operation 1442. If printing such an overall summary is desired, the operator may do so at operation 1444.

At operation 1446, the operator may decide whether or not to perform another measurement series. If another measurement series is desired, and the measurement function 1400 returns to operation 1404 and the radiation detection assembly is delivered to and lowered into an additional borehole within the subterranean formation for subsurface measurement. If another measurement series is not desired, the measurement function 1400 may return to the main loop 900 (FIG. 9) at operation 1448.

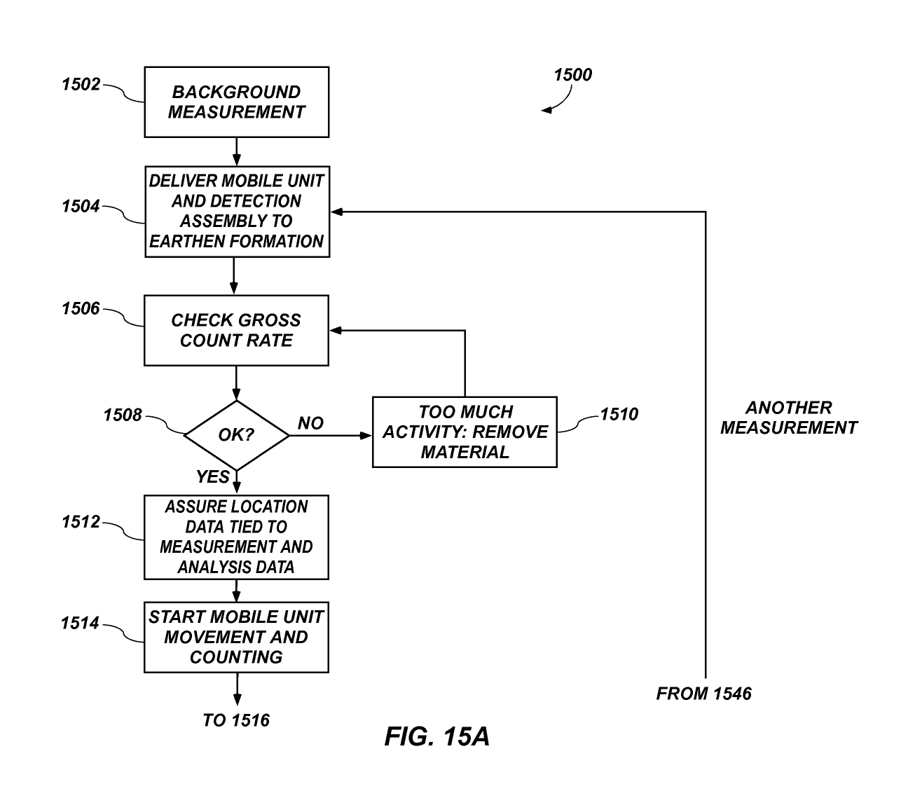

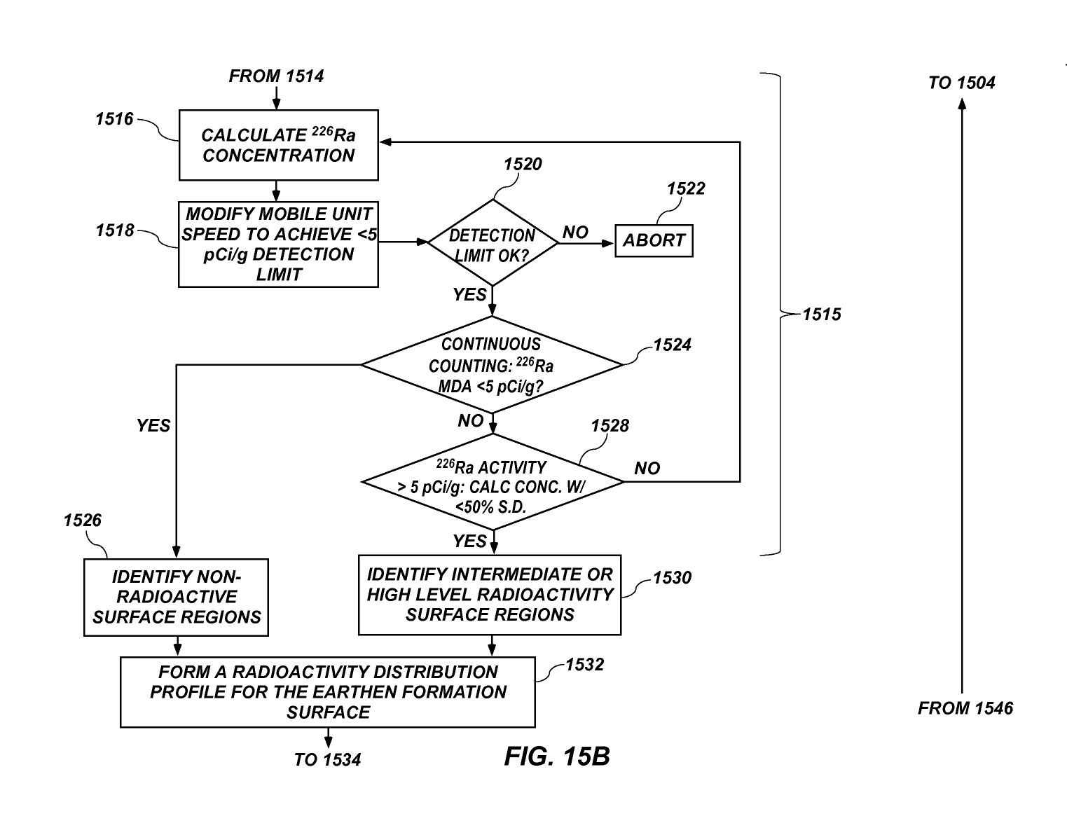

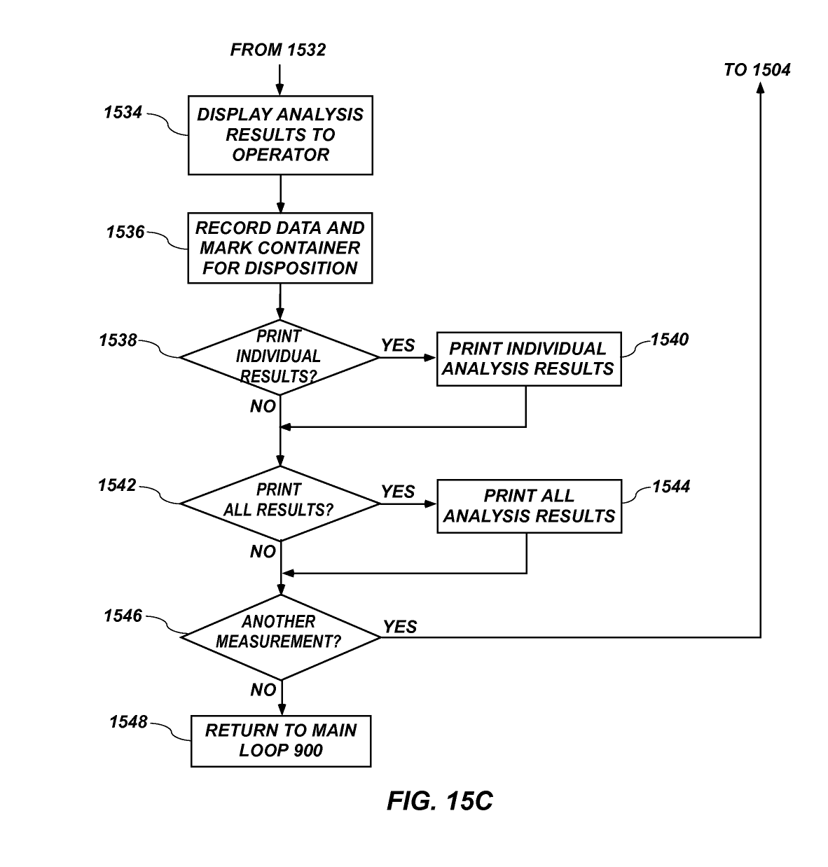

FIGS. 15A-15C are a series of flowcharts representing a measurement function 1500 for the surface waste characterization subsystem 110 (FIG. 5) of the radioactive waste screening system 100 (FIG. 1), according to embodiments of the disclosure. The measurement function 1500 may perform measurements using at least one radiation detector (e.g., the radiation detector 508 shown in FIG. 5) of the surface waste characterization subsystem 110 to detect, measure, and characterize radioactivity.

Referring to FIG. 15A, at operation 1502, a background measurement may be performed. The background measurement at operation 1502 may be substantially similar to the background measurement 700 function previously described in relation to FIG. 7.

At operation 1504, a mobile unit (e.g., the mobile unit 504 shown in FIG. 5) including a radiation detection assembly (e.g., the radiation detection assembly 506 shown in FIG. 5) is provided to a location on or over an earthen formation (e.g, the earthen formation 500 shown in FIG. 5) to be characterized. The radiation detection assembly may be provided proximate the surface (e.g, the surface 502 shown in FIG. 5) of the earthen formation.

At operation 1506, an initial gross count rate is checked. The gross count rate at operation 1506 may measure gross gamma activity to ensure that the earthen formation is not undesirably hot from a radioactive standpoint. If the gross count rate at operation 1506 for the earthen formation is above a predetermined threshold, a failure is determined at operation 1508, and the background may be evaluated to ensure it is not above defined parameters at operation 1510. The gross count rate check at operation 1508 may then be repeated.

If the gross count rate check at operation 1506 is determined to be acceptable at operation 1508, further analysis may be performed. At operation 1512, information regarding the location (e.g., as determined by the position locating device 520 shown in FIG. 5) of the radiation detector may be linked to (e.g., associated with) measurement data and analysis data to be obtained. Furthermore, a running report including the location of the radiation detector along with the measurements and analysis for the earthen formation associated therewith may be initiated and displayed to a monitor of the radioactive waste screening system 100 at operation 1512.

At operation 1514, the mobile unit begins to move (e.g., traverse) across the surface of the earthen formation, and regions of the earthen formation proximate the radiation detector begin to be continuously counted in predetermined lateral increments (e.g., about 3 foot lateral increments) and to a predetermined longitudinal depth (e.g., less than or equal to about 1 foot). The mobile unit may move across the surface of the earthen formation at an initial rate of up to about 3.0 mph.

Referring next to FIG. 15B, after operation 1514, the measurement function 1500 begins a continuous activity monitoring loop 1515 including operations 1516-1528 to continuously determine radionuclide activities for different lateral increments of the earthen formation. At operation 1516, the measurement data for a particular lateral increment of the earthen formation may be analyzed to calculate estimated activities for ²²⁶Ra and other radionuclides (e.g., ²³⁵U, ²³⁸U, ²³²Th, ²²⁸Ra, ⁴⁰K, daughter products of such radionuclides, etc.). The analysis may employ a peak search engine, which may be available from ORTEC, that produces a report including peaks for ²²⁶Ra and the other radionuclides. The counts for the peaks may be extracted from the measurements to estimate the activities of the radionuclides. The estimated radionuclide activities for the earthen formation at the particular lateral increment may also be displayed to a monitor of the radioactive waste screening system 100 at operation 1516.

At operation 1318, the initial rate at which the mobile unit moves across the surface of the earthen formation may be adjusted, based on the estimated ²²⁶Ra activity calculated at operation 1516, to a rate facilitating a ²²⁶Ra activity detection threshold below 5 pCi/g.

At operation 1520, if the adjusted mobile unit movement rate from operation 1518 facilitates a ²²⁶Ra detection threshold below 5 pCi/g. If the answer to the check at operation 1520 is yes, the continuous activity monitoring loop 1515 moves on to operation 1524. Conversely, if the answer to the check at operation 1520 is no, the continuous activity monitoring loop 1515 is terminated, and the operation of the surface waste characterization subsystem 110 (FIG. 5) is aborted at operation 1522 until appropriate measures are taken to fix the cause of the unacceptable ²²⁶Ra activity detection threshold.

At operation 1524, the ²²⁶Ra activity for a particular lateral increment of the earthen formation (i.e., obtained as the mobile unit transverses the surface of the earthen formation at the adjusted movement rate) is checked to determine if the particular lateral increment of the earthen formation exhibits an MDA of ²²⁶Ra activity below 5 pCi/g. If the answer to the check at operation 1524 is yes, the surface region (e.g., about 10 square foot (ft²) region) of the earthen formation associated with the particular lateral increment may be identified as a non-radioactive region at operation 1526. Conversely, if the answer to the check at operation 1524 is no, a secondary check is performed at operation 1528 to determine if the particular lateral increment of the earthen formation exhibits an ²²⁶Ra activity above 5 pCi/g with less than 50 percent uncertainty. If the answer to the secondary check at operation 1528 is no, the continuous activity monitoring loop 1515 continues by looping back to operation 1516 and again calculating estimated radionuclide activities based on further measurement data. Conversely, if the answer to the secondary check at operation 1528 is yes, the specific activities for ²²⁶Ra and other radionuclides (e.g., ²³⁵U, ²³⁸U, ²³²Th, ²²⁸Ra, ⁴⁰K, daughter products of such radionuclides, etc.) for the surface region of the earthen formation associated with the particular lateral increment are calculated. Preliminary activity estimates may be calculated for all selected gamma ray emissions of ²²⁶Ra and other radionuclides, and then apparent activities and uncertainties may be adjusted for errors in mass attenuation and for non-equilibrium decay chains in accordance with the weighted regression analysis previously described herein in relation to operation 1226 (FIG. 12B) of the measurement function 1200 (FIG. 12A). Based on the activities at calculated at operation 1528, the surface region of the earthen formation associated with the particular lateral increment may be identified as either an intermediate level radioactivity region (e.g., for a total calculated activity of from 5 pCi/g to 30 pCi/g) or a high level radioactivity region (e.g., for a total calculated activity greater than 30 pCi/g) at operation 1530.

Operations 1516-1530 described above may continue until all desired lateral increments of the earthen formation have been analyzed and the surface regions of the earthen formation associated with the lateral increments have each independently been properly identified as a non-radioactive region, an intermediate level radioactivity region, or a high level radioactivity region. Thereafter, the measurement function 1400 may continue on to operation 1532.

At operation 1532, the locational data and the analysis data obtained across the earth formation may be used to form a model (e.g., map) of the earth formation showing the distribution, quantities, and activities of radioactive material across the surface of the earth formation.

Referring next to FIG. 15C, at operation 1534, a report on the net analysis results for the tested regions of the earthen formation may be displayed to a monitor. The displayed report may include a summary of calculated activities, including uncertainties, for each radionuclide that was evaluated (e.g., ²³⁵U, ²³⁸U, ²³²Th, ²²⁸Ra, ⁴⁰K, etc.). The displayed report may also indicate distribution non-radioactive regions, intermediate level radioactivity regions, and high level radioactivity regions across the tested dimensions of the earthen formation. Thereafter, the data obtained (e.g., the spectral data, positional data, etc.) may be recorded to a daily log at operation 1536.

At operation 1538, the operator may make a decision whether or not print a summary encompassing the data obtained for the tested regions of the earthen formation. If printing the summary is desired, the summary may be printed at operation 1540. After printing the summary at operation 1540, or if printing the summary is not desired, the operator may make a decision whether or not print a summary encompassing the data obtained at all locations and regions of the earthen formation characterized by the surface waste characterization subsystem 110 over a selected period of time (e.g., a day of operation) at operation 1542. If printing such an overall summary is desired, the operator may do so at operation 1544.

At operation 1546, the operator may decide whether or not to perform another measurement series. If another measurement series is desired, and the measurement function 1500 returns to operation 1504 and the mobile unit is delivered to another location on or over the earthen formation for surface measurement. If another measurement series is not desired, the measurement function 1500 may return to the main loop 900 (FIG. 9) at operation 1548.

The systems, methods, and apparatuses according to embodiments of the disclosure advantageously facilitate the efficient, onsite detection, measurement, characterization, and segregation of radioactive materials, such as NORM and TENORM. The systems and processes of the disclosure may be utilized at any stage of a waste production and disposal process, such as from the initial production and/or removal of material at a site (e.g., a drill site, a well site, a fracking site, a nuclear weapon site, a nuclear power plant site, a medical site, etc.) through the characterization of material that has already been disposed of at a waste site. The radioactive waste screening system 100 of the disclosure, including the subsystems thereof (e.g., the packaged waste screening subsystem 104, the volume waste screening subsystem 106, the subsurface waste characterization subsystem 108, and the surface waste characterization subsystem 110), provides a fast and flexible means of evaluating the radioactivity of a variety of materials and material formations as compared to conventional systems. The radioactive waste screening system 100 also provides a simple and effective way of identifying and separating non-radioactive materials, intermediate level radioactive materials, and high level radioactive materials, reducing costs and risks associated with the transport and disposal of wastes generated at a variety of sites.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the disclosure as defined by the following appended claims and their legal equivalents.

What is claimed is:

1. A radioactive waste screening system, comprising:
at least one subsystem selected from the group consisting of:
a packaged waste screening subsystem configured to measure the radioactivity of a packaged material;
a volume waste screening subsystem configured to measure the radioactivity of portions of a volume of material conveyed therethrough;
a subsurface waste characterization subsystem configured to measure the radioactivity of regions of a subterranean formation adjacent at least one borehole; and
a surface waste characterization subsystem configured to measure the radioactivity of surface regions of an earthen formation;
at least one computer assembly operatively associated with and configured to receive measurement data from the at least one subsystem; and
control logic in communication with the at least one computer assembly, the control logic configured to verify the operability of the at least one subsystem, to control the at least one subsystem, and to assess the radioactivity of at least one of the packaged material, the portions of the volume of material, the regions of the subterranean formation, and the surface regions of the earthen formation at least partially based on the measurement data received by the at least one computer assembly.

2. The radioactive waste screening system of claim 1, wherein at least one subsystem comprises each of the packaged waste screening subsystem, the volume waste screening subsystem, the subsurface waste characterization subsystem, and the surface waste characterization subsystem.

3. The radioactive waste screening system of claim 1, wherein the packaged waste screening subsystem comprises:
a radiation detection assembly comprising a radiation detector and a protective enclosure at least partially surrounding the radiation detector;
a detector positioning assembly configured to hold the radiation detection assembly, and to move and position the radiation detection assembly relative to the packaged material; and
a support assembly configured to support at least the detector positioning assembly and the radiation detection assembly.

4. The radioactive waste screening system of claim 3, wherein the detector positioning assembly is configured to move the radiation detection assembly laterally, longitudinally, and radially.

5. The radioactive waste screening system of claim 3, wherein the packaged waste screening subsystem further comprises at least one of:
a weighing assembly configured and positioned to measure the weight of the packaged material;
a temperature control assembly configured and positioned to modify the temperature of at least the radiation detector; and
a gearmotor configured and positioned to provide automated movement to at least one of the support assembly and the detector positioning assembly.

6. The radioactive waste screening system of claim 1, wherein the volume waste screening subsystem comprises:
a radiation detection assembly comprising a radiation detector and a protective enclosure at least partially surrounding the radiation detector, and
a segregation assembly comprising:
a conveyor assembly configured and positioned to convey the portions of the volume of material past the radiation detection assembly;
a gate assembly configured and positioned to receive the portions of the volume of material from the conveyor assembly and to segregate the portions of the volume of material; and
a support assembly configured to support at least the conveyor assembly and the gate assembly.

7. The radioactive waste screening system of claim 6, wherein the support assembly comprises weight measurement devices configured to measure the weight of the portions of the volume of material.

8. The radioactive waste screening system of claim 6, further comprising a temperature control assembly configured and positioned to modify the temperature of at least the radiation detector.

9. The radioactive waste screening system of claim 1, wherein the subsurface waste characterization subsystem comprises:
a cone penetrometer assembly configured and positioned to form the at least one borehole in the subterranean formation;
a radiation detection assembly comprising a radiation detector and a protective enclosure at least partially surrounding the radiation detector; and
a detector positioning assembly configured to move and position the radiation detection assembly within the at least one borehole.

10. The radioactive waste screening system of claim 9, wherein the subsurface waste characterization subsystem further comprises at least one of:
a position locating device configured to at least partially determine the location of the radiation detection assembly; and
a temperature control assembly configured and positioned to modify the temperature of at least the radiation detector.

11. The radioactive waste screening system of claim 1, wherein the surface waste characterization subsystem comprises:
a radiation detection assembly comprising a radiation detector and a protective enclosure at least partially surrounding the radiation detector, and
a mobile unit configured to support the radiation detection assembly and to position the radiation detection assembly proximate a surface of the earthen formation.

12. The radioactive waste screening system of claim 11, wherein the surface waste characterization subsystem comprises at least one of:
a position locating device configured to at least partially determine the location of the mobile unit; and
a temperature control assembly configured and positioned to modify the temperature of at least the radiation detector.

13. The radioactive waste screening system of claim 1, wherein the control logic is configured to operate the at least one subsystem in a plurality of modes of operation.

14. The radioactive waste screening system of claim 13, wherein the plurality of modes of operation comprise:
a source check mode configured to perform an energy calibration for a radiation detector of each of the packaged waste screening subsystem, the volume waste screening subsystem, the subsurface waste characterization subsystem, and the surface waste characterization subsystem with at least one known radioactive source;
a shielded background check mode configured to detect internal contamination of the radiation detector; and
a measurement mode configured at least to quantify the radioactivity of the packaged material, the portions of the volume of material, the regions of the subterranean formation, and the surface regions of the earthen formation.

15. The radioactive waste screening system of claim 1, wherein the control logic is configured to perform real time energy calibrations for at least one radiation detector of the at least one subsystem.

16. The radioactive waste screening system of claim 1, wherein the control logic is configured to calculate the activity of at least one of ²³⁵U, ²³⁸U, ²³²Th, ²²⁶Ra, ²²⁸Ra, ⁴⁰K, and daughter products of such radionuclides for the at least one of the packaged material, the portions of the volume of material, the regions of the subterranean formation, and the surface regions of the earthen formation.

17. The radioactive waste screening system of claim 16, wherein the control logic is further configured to adjust the measurement data to automatically correct for mass attenuation and non-equilibrium decay chains in the at least one of the packaged material, the portion of the volume of material, the regions of the subterranean formation, and the surface regions of the earthen formation through weighted least square regression analysis of the measurement data.

18. A method of assessing a potentially radioactive material, comprising:
characterizing the radioactivity of at least one material using a radioactive waste screening system comprising:
at least one subsystem selected from the group consisting of:
a packaged waste screening subsystem configured to measure the radioactivity of a packaged material;
a volume waste screening subsystem configured to measure the radioactivity of portions of a volume of material conveyed therethrough;
a subsurface waste characterization subsystem configured to measure the radioactivity of regions of a subterranean formation adjacent at least one borehole; and
a surface waste characterization subsystem configured to measure the radioactivity of surface regions of an earthen formation;
at least one computer assembly operatively associated with and configured to receive measurement data from the at least one subsystem; and
control logic in communication with the at least one computer assembly, the control logic configured to verify the operability of the at least one subsystem, to control the at least one subsystem, and to assess the radioactivity of at least one of the packaged material, the portions of the volume of material, the regions of the subterranean formation, and the surface regions of the earthen formation at least partially based on the measurement data received by the at least one computer assembly.

19. The method of claim 18, wherein characterizing the radioactivity of at least one material using a radioactive waste screening system comprises:
delivering a vessel containing the at least one material to the packaged waste screening subsystem;
positioning a radiation detection assembly of the packaged waste screening subsystem proximate the vessel;
measuring counts for at least one radionuclide using a radiation detector of the radiation detection assembly;
calculating an activity for the at least one radionuclide using the control logic; and
identifying the at least one material within the vessel as non-radioactive waste, intermediate level radioactive waste, or high level radioactive waste at least partially based on the calculated activity for the at least one radionuclide.

20. The method of claim 18, wherein characterizing the radioactivity of at least one material using a radioactive waste screening system comprises:
delivering a volume of the at least one material to the volume waste screening subsystem;
conveying portions of the volume of the at least one material past a radiation detection assembly of the volume waste screening subsystem;
continuously measuring counts for at least one radionuclide using a radiation detector of the radiation detection assembly;
continuously calculating an activity for the at least one radionuclide using the control logic; and
independently segregating each of the portions of the volume of the at least one material into a non-radioactive waste zone, an intermediate level radioactive waste zone, or a high level radioactive waste zone based on the continuously calculated activity for the at least one radionuclide.

21. The method of claim 18, wherein characterizing the radioactivity of at least one material using a radioactive waste screening system comprises:
forming a borehole extending into a subterranean formation using a cone penetrometer assembly of the subsurface waste characterization subsystem;
delivering a radiation detection assembly into the borehole using a detector positioning assembly of the subsurface waste characterization subsystem;
measuring counts for at least one radionuclide at different longitudinal increments within the borehole using a radiation detector of the radiation detection assembly;
calculating an activity for the at least one radionuclide using the control logic; and
independently identifying different regions of the subterranean formation adjacent the borehole as non-radioactive regions, intermediate level radioactivity regions, or high level radioactivity regions based on the calculated activity for the at least one radionuclide.

22. The method of claim 18, wherein characterizing the radioactivity of at least one material using a radioactive waste screening system comprises:
delivering a mobile unit of the surface waste characterization subsystem to an earthen formation, a radiation detection assembly mounted to the mobile unit and positioned proximate a surface of the earthen formation;
moving the mobile unit across the surface of the earthen formation;
continuously measuring counts for at least one radionuclide at different lateral locations across the surface of the earthen formation using a radiation detector of the radiation detection assembly;
continuously calculating an activity for the at least one radionuclide using the control logic; and
independently identifying different regions across the surface of the earthen formation as non-radioactive regions, intermediate level radioactivity regions, or high level radioactivity regions based on the continuously calculated activity for the at least one radionuclide.

23. The method of claim 18, wherein characterizing the radioactivity of at least one material comprises calculating the activity of at least one radionuclide selected from the group consisting of ²³⁵U, ²³⁸U, ²³²Th, ²²⁶Ra, ²²⁸Ra, ⁴⁰K, and daughter products of such radionuclides.

24. The method of claim 23, wherein calculating the activity of at least one radionuclide comprises automatically compensating for mass attenuation and non-equilibrium decay chains through weighted least squares regression analysis.

25. The method of claim 23, further comprising performing real time radiation detector energy calibrations during operation of at least one of the at least one subsystem.

26. A method of determining the radioactivity of a material, comprising:
measuring counts for at least one radionuclide using at least one radiation detector of a radioactive waste screening system comprising at least one of a packaged waste screening subsystem, a volume waste screening subsystem, a subsurface waste characterization subsystem, and a surface waste characterization subsystem; and
calculating the activity of the at least one radionuclide using control logic of the radioactive waste screening system, the control logic automatically compensating for mass attenuation and non-equilibrium decay chains through weighted least squares regression analysis and modeling of physical geometry and radioactive decay parameters.
